(19) United States
(12) Patent Application Publication
(10) Pub. No.: US 2010/0328575 A1
(43) Pub. Date: Dec. 30, 2010

(54) BACKLIGHT UNIT AND LIQUID CRYSTAL DISPLAY DEVICE

(75) Inventors: Shogo Shinkai, Miyagi (JP); Eiji Ohta, Miyagi (JP); Yasuyuki Kudo, Miyagi (JP); Tatsuya Harima, Miyagi (JP); Saori Hayashi, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/817,855

(22) Filed: Jun. 17, 2010

(30) Foreign Application Priority Data
Jun. 26, 2009 (JP) P2009-153019
Jul. 3, 2009 (JP) P2009-159358
Mar. 4, 2010 (JP) P2010-048406

(51) Int. Cl. G02F 1/1335; F21V 11/00; G02F 1/13357

(52) U.S. Cl. 349/62; 362/355; 362/97.1

(57) ABSTRACT

A diffusion plate includes a base body including a plurality of convex portions formed on a principal surface of the base body. An angle of inclination of the convex portions at a base of the convex portions ranges from 38° to 42°. Also, a ratio R/Cp between a curvature R of a summit of the convex portions and a pitch Cp between adjacent convex portions is 0.0014<R/Cp<0.43.

### CROSS REFERENCES TO RELATED APPLICATION

The present application claims priority to Japanese Priority Patent Application No. 2009-153019, filed on Jun. 26, 2009; Japanese Priority Patent Application No. 2009-159358, filed on Jul. 3, 2009; and Japanese Priority Patent Application No. 2010-048406 filed on Mar. 4, 2010, the entire content of which is hereby incorporated by reference.

### BACKGROUND

The present disclosure relates to a backlight unit and a liquid crystal display device having the same, and more particularly, to a backlight unit capable of suppressing luminance unevenness. In addition, the present disclosure relates to a diffusion plate containing a diffusion agent, a backlight unit having the same, and a liquid crystal display device.

Since a liquid crystal display device is not an emissive display device, a backlight unit is provided in the back surface thereof. While the backlight unit can be classified into an edge-light type and a direct-light type, the direct-light type backlight units are widely used in a large-sized liquid crystal television sets or the like which demand high luminance.

In the direct-light type backlight unit of the related art, a sheet stack structure obtained by stacking a plurality of optical sheets is arranged between a light source and a liquid crystal panel. As an example of the configuration of the sheet stack structure, as shown in FIGS. 1A to 1C, three following configurations are commonly employed.

Configuration 1 (FIG. 1A):

(light source side) shaped diffusion plate 101—diffusion sheet 102—prism sheet 103—diffusion sheet 102 (liquid crystal panel side)

Configuration 2 (FIG. 1B):

(light source side) shaped diffusion plate 101—diffusion sheet 102—prism sheet 103—reflective polarization sheet 104 (liquid crystal panel side)

Configuration 3 (FIG. 1C):

(light source side) diffusion plate 105—diffusion sheet 102—prism sheet 103—diffusion sheet 104 (liquid crystal panel side)

Configuration 2 is employed in a model demanding higher luminance in comparison with Configuration 1. In Configuration 3, luminance unevenness is generated when a distance of the light source increases or the distance between the light source and the diffusion plate decreases. Therefore, Configuration 3 is employed in models which do not have such demands.

However, recently, as the costs of the backlight units have fallen, it is necessary to reduce the number of the optical sheets employed in the backlight unit. While various configurations are being investigated to reduce the number of the optical sheets, the following backlight unit configuration, in which a diffusion sheet between a shaped diffusion plate and a prism sheet is removed, is considered as one of the applicable configurations (e.g., refer to Japanese Unexamined Patent Application Publication No. 2007-25619).

Configuration 1 (FIG. 2A): (light source side) shaped diffusion plate 101—prism sheet 103—diffusion sheet 102 (liquid crystal panel side)

Configuration 2 (FIG. 2B): (light source side) shaped diffusion plate 101—prism sheet 103—reflective polarization sheet 104 (liquid crystal panel side)

However, as described above, if the diffusion sheet is simply removed as described in the configuration of the related art, four problems may occur as described below.

(1) Problem 1 (Front Luminance Unevenness)

As shown in FIG. 3A, the luminance distribution L1 of the front face of the backlight unit shows that the luminance is weakened at the position on the light source 111. Therefore, when the backlight is viewed from the front face, the luminance unevenness is generated in a dark line shape on the light source 111. This is because the light emitted from the shaped diffusion plate 101 and normally incident to a back surface of the prism sheet 103 is returned at the prism 103a to the light source 111 side. On the contrary, when the diffusion sheet 102 is provided between the shaped diffusion plate 101 and the prism sheet 103 as shown in FIG. 3B, the light emitted from the shaped diffusion plate 101 is diffused to the diffusion sheet 102 and incident to the prism sheet 103. For this reason, a proportion of the light normally incident to the back surface of the prism sheet 103 is reduced.

(2) Problem 2 (Oblique Luminance Unevenness)

As shown in FIG. 3A, a luminance distribution L2 in an oblique direction with respect to the front surface of the backlight unit increases near the light source 111. While the light beam propagating in an oblique direction is diffracted by the prism 103a, the number of the transmitting light beams is large, and thus, a portion near the light source 111 looks brighter when the backlight unit is viewed in an oblique direction, thereby generating luminance unevenness. On the contrary, as shown in FIG. 3B, when the diffusion sheet 102 is provided between the shaped diffusion plate 101 and the prism sheet 103, the light emitted from the shaped diffusion plate 101 is diffused to the diffusion sheet 102 and incident to the prism sheet 103. For this reason, a proportion of the light obliquely incident to the back surface of the prism sheet 103 is reduced.

In other words, it is envisaged that the problems 1 and 2 are generated due to the same reasons. In case of Problem 1, the light normally incident from the light source to the back surface of the prism sheet is stronger than the light normally incident from those other than the light source to the back surface of the prism sheet, and the prism sheet 103 returns the light normally incident to the back surface to the light source. Therefore, the light looks darker near the light source 111. In case of Problem 2, the light obliquely incident to the back surface of the prism sheet from the light source 111 is weaker than the light obliquely incident to the back surface of the prism sheet along the side of the light source, and the prism sheet 103 transmits the obliquely incident light to the back surface. Therefore, the light looks brighter near the light source 111. As shown in FIGS. 3A and 3B, when the diffusion sheet 102 is provided between the shaped diffusion plate 101 and the prism sheet 103, the normally incident light and obliquely incident light are equalized by the diffusion sheet 102. As a result, Problems 1 and 2 can be addressed.

(3) Problem 3 (Stud Pin Visibility)

Since the diffusion degree decreases by removing the diffusion sheet between the shaped diffusion plate and the prism sheet, a plurality of stud pins supporting the optical sheet (e.g., the shaped diffusion plate) are observed, and display evenness is degraded.

(4) Problem 4 (Luminance Unevenness Caused by Dimension Error in Backlight Unit)

Occurrence of luminance unevenness in the backlight unit is influenced by each of the dimension values such as a distance P between the centers of the light sources, a distance H between the center of the light source and the back surface of the shaped diffusion plate (or the diffusion plate), and a distance L between the center of the light source and the surface of the reflection sheet. The shape of the shaped diffusion plate or the content amount of the diffusion agent is designed based on these dimension values such that the luminance unevenness is not generated. However, since the diffusion degree decreases as the diffusion sheet is removed between the shaped diffusion plate and the prism sheet, a sensitivity of the luminance unevenness increases due to the difference of these dimension values. For example, if the distance P or H deviates by only 1 mm due to the deflection of the light source or the diffusion sheet, the luminance unevenness is generated, and the backlight unit provides irregular quality.

It is envisaged that Problems 3 and 4 are generated due to the following same reason: as the diffusion sheet is removed between the shaped diffusion plate and the prism sheet, the diffusion degree decreases.

Therefore, it is desirable to provide a backlight unit capable of suppressing the front luminance unevenness and the oblique luminance unevenness and also suppressing observation of the stud pins, and a liquid crystal display device having the same.

It is desirable to provide a backlight unit capable of suppressing the front luminance unevenness and the oblique luminance unevenness, suppressing the observation of the stud pins, and also suppressing the luminance unevenness caused by dimension errors of the backlight unit, and a liquid crystal display device having the same.

As described above, if the diffusion sheet is simply removed from the existing configuration, luminance unevenness is generated by insufficient diffusion. In this regard, if a diffusion agent is added to the entire shaped diffusion plate (including both the lens unit and the base body) in order to correct such luminance unevenness, the luminance may be degraded.

### SUMMARY

The present embodiments provide a diffusion plate capable of correcting luminance unevenness and suppressing degradation of the luminance, and a backlight unit having the same, and a liquid crystal display device having the same.

In an embodiment, a diffusion plate includes a base body including a plurality of convex portions formed on a principal surface of the base body. An angle of inclination of the convex portions at a base of the convex portions ranges from 38° to 42°. Also, a ratio R/Cp between a curvature R of a summit of the convex portions and a pitch Cp between adjacent convex portions is 0.0014<R/Cp<0.43.

In another embodiment, a backlight unit includes a light source, and a diffusion plate through which light passes from the light source, the diffusion plate including a base body and including a plurality of convex portions formed on a principal surface of the base body. An angle of inclination of the convex portions at a base of the convex portions ranges from 38° to 42°. Also, a ratio R/Cp between a curvature R of a summit of the convex portions and a pitch Cp between adjacent convex portions is 0.0014<R/Cp<0.43.

In another embodiment, a liquid crystal display device includes a backlight unit. The backlight includes a light source and a diffusion plate through which light passes from the light source, and a liquid crystal panel for displaying an image by modulating light emitted from the backlight unit. The diffusion plate includes a base body and a plurality of convex portions formed on a principal surface of the base body. An angle of inclination of the convex portions at a base of the convex portions ranges from 38° to 42°, and a ratio R/Cp between a curvature R of a summit of the convex portions and a pitch Cp between adjacent convex portions is 0.0014<R/Cp<0.43.

In another embodiment, a diffusion plate is provided having a laminated structure and including a lens layer including a plurality of lens portions, and a diffusion layer including a diffusion agent dispersed therein. A percentage R_{D} of a thickness of the diffusion layer with respect to a thickness of the entire diffusion plate is at least 60%.

In another embodiment a backlight unit includes a light source, and a diffusion plate through which light passes from the light source. The diffusion plate has a laminated structure and includes a lens layer including a plurality of lens portions, and a diffusion layer including a diffusion agent dispersed therein. A percentage R_{D} of a thickness of the diffusion layer with respect to a thickness of the entire diffusion plate is at least 60%.

In another embodiment, a liquid crystal display device includes a backlight unit. The backlight unit includes a light source, and a diffusion plate through which light passes from the light source, and a liquid crystal panel for displaying an image by modulating light emitted from the backlight unit. The diffusion plate has a laminated structure and includes a lens layer including a plurality of lens portions, and a diffusion layer including a diffusion agent dispersed therein. A percentage R_{D} of a thickness of the diffusion layer with respect to a thickness of the entire diffusion plate is at least 60%.

According to the present embodiments, it is possible to suppress the front luminance unevenness and the oblique luminance unevenness, and also prevent the stud pins from being observed. Furthermore, it is possible to prevent luminance unevenness caused by dimension error of the backlight unit.

Additional features and advantages are described herein, and will be apparent from the following Detailed Description and the figures.

### BRIEF DESCRIPTION OF THE FIGURES

FIGS. 1A to 1C are schematic diagrams illustrating a configuration of a sheet stack structure provided in a backlight unit of the related art.

FIGS. 2A and 2B are schematic diagrams illustrating a configuration of a sheet stack structure provided in the backlight unit by removing a diffusion sheet between a shaped diffusion plate and a prism sheet.

FIGS. 3A and 3B are schematic diagrams illustrating front luminance unevenness and oblique luminance unevenness.

FIG. 4 is a schematic diagram illustrating a configuration example of a liquid crystal display device according to a first embodiment.

FIG. 5A is a schematic diagram illustrating a first configuration example of a sheet stack structure provided in a liquid crystal display device according to a first embodiment.

FIG. 5B is a schematic diagram illustrating a second configuration example of a sheet stack structure provided in a liquid crystal display device according to a first embodiment.

FIG. 6 is a graph illustrating a configuration example of a shaped diffusion plate.

FIG. 7A is a perspective diagram illustrating a configuration example of a prism sheet.

FIG. 7B is a cross-sectional diagram illustrating a configuration example of a prism sheet.

FIG. 8A is a schematic diagram illustrating a first configuration example of a sheet stack structure provided in a backlight unit according to a second embodiment.

FIG. 8B is a schematic diagram illustrating a second configuration example of a sheet stack structure provided in a backlight unit according to a second embodiment.

FIG. 9A is a perspective diagram illustrating a configuration example of a shaped diffusion plate.

FIG. 9B is a cross-sectional diagram illustrating a configuration example of a shaped diffusion plate.

FIG. 10A is a schematic diagram illustrating a first configuration example of a sheet stack structure provided in a backlight unit according to a third embodiment.

FIG. 10B is a schematic diagram illustrating a second configuration example of a sheet stack structure provided in a backlight unit according to a third embodiment.

FIG. 11A is a graph illustrating a prism shape of the prism sheet according to Experiment 1.

FIG. 11B is a graph illustrating a luminance distribution as a result of simulation in Experiment 1.

FIG. 12A is a graph illustrating a prism shape of a prism sheet of Experiment 2.

FIG. 12B is a graph illustrating a luminance distribution as a result of simulation of Experiment 2.

FIG. 13A is a graph illustrating a prism shape of a prism sheet of Experiment 3.

FIG. 13B is a graph illustrating a luminance distribution as a result of simulation of Experiment 3.

FIG. 14A is a graph illustrating a variation of front luminance as a result of simulation in Experiments 4-1 and 4-2.

FIG. 14B is a graph illustrating a variation of front luminance as a result of simulation in Experiments 5-1 and 5-2.

FIG. 14C is a graph illustrating a variation of front luminance as a result of simulation in Experiments 6-1 and 6-2.

FIG. 15 is a graph illustrating a strength field-of-view distribution as a result of simulation of Experiment 7.

FIG. 16A is a graph illustrating a shape of the prism sheet according to Experiments 8-1 and 8-2.

FIG. 16B is a graph illustrating an unevenness percentage as a result of simulation in Experiments 8-1 and 8-2.

FIG. 17 is a schematic diagram illustrating a simulation method in Experiments 9-1 to 9-3.

FIGS. 18A to 18C are graphs illustrating an angular strength distribution of the emitted light as a result of simulation in Experiments 9-1 to 9-3.

FIG. 19 is a graph illustrating a luminance distribution as a result of simulation in Experiment 10.

FIG. 20 is a graph illustrating a shape of a convex portion of a shaped diffusion plate in Experiments 11-1 to 15-3.

FIG. 21A is a graph illustrating a luminance distribution as a result of simulation in Experiment 11-1 by setting a basic angle to 38°, a summit curvature R=0.1 μm, and R/Cp=0.0014.

FIG. 21B is a graph illustrating a luminance distribution as a result of simulation in Experiment 11-2 by setting a basic angle to 38°, a summit curvature R=10 μm, and R/Cp=0.14.

FIG. 21C is a graph illustrating a luminance distribution as a result of simulation in Experiment 11-3 by setting a basic angle to 38°, a summit curvature R=30 μm, and R/Cp=0.43.

FIG. 22A is a graph illustrating a luminance distribution as a result of simulation in Experiment 12-1 by setting a basic angle to 39°, a summit curvature R=0.1 μm, and R/Cp=0.0014.

FIG. 22B is a graph illustrating a luminance distribution as a result of simulation in Experiment 12-2 by setting a basic angle to 39°, a summit curvature R=10 μm, and R/Cp=0.14.

FIG. 22C is a graph illustrating a luminance distribution as a result of simulation in Experiment 12-3 by setting a basic angle to 39°, a summit curvature R=20 μm, and R/Cp=0.28.

FIG. 22D is a graph illustrating a luminance distribution as a result of simulation in Experiment 12-4 by setting a basic angle to 39°, a summit curvature R=30 μm, and R/Cp=0.43.

FIG. 23A is a graph illustrating a luminance distribution as a result of simulation in Experiment 13-1 by setting a basic angle to 40°, a summit curvature R=0.1 μm, and R/Cp=0.0014.

FIG. 23B is a graph illustrating a luminance distribution as a result of simulation in Experiment 13-2 by setting a basic angle to 40°, a summit curvature R=10 μm, and R/Cp=0.14.

FIG. 23C is a graph illustrating a luminance distribution as a result of simulation in Experiment 13-3 by setting a basic angle to 40°, a summit curvature R=20 μm, and R/Cp=0.28.

FIG. 23D is a graph illustrating a luminance distribution as a result of simulation in Experiment 13-4 by setting a basic angle to 40°, a summit curvature R=30 μm, and R/Cp=0.43.

FIG. 24A is a graph illustrating a luminance distribution as a result of simulation in Experiment 14-1 by setting a basic angle to 41°, a summit curvature R=0.1 μm, and R/Cp=0.0014.

FIG. 24B is a graph illustrating a luminance distribution as a result of simulation in Experiment 14-2 by setting a basic angle to 41°, a summit curvature R=10 μm, and R/Cp=0.14.

FIG. 24C is a graph illustrating a luminance distribution as a result of simulation in Experiment 14-3 by setting a basic angle to 41°, a summit curvature R=20 μm, and R/Cp=0.28.

FIG. 24D is a graph illustrating a luminance distribution as a result of simulation in Experiment 14-4 by setting a basic angle to 41°, a summit curvature R=30 μm, and R/Cp=0.43.

FIG. 25A is a graph illustrating a luminance distribution as a result of simulation in Experiment 15-1 by setting a basic angle to 42°, a summit curvature R=0.1 μm, and R/Cp=0.0014.

FIG. 25B is a graph illustrating a luminance distribution as a result of simulation in Experiment 15-2 by setting a basic angle to 42°, a summit curvature R=10 μm, and R/Cp=0.14.

FIG. 25C is a graph illustrating a luminance distribution as a result of simulation in Experiment 15-3 by setting a basic angle to 42°, a summit curvature R=20 μm, and R/Cp=0.28.

FIG. 25D is a graph illustrating a luminance distribution as a result of simulation in Experiment 15-4 by setting a basic angle to 42°, a summit curvature R=30 μm, and R/Cp=0.43.

FIG. 26 is a graph illustrating a calculation result for a total light transmittance and a concentration.

FIG. 27 is a graph illustrating an unevenness percentage as a result of simulation in Experiments 16-1 to 16-3 and 17-1 to 17-8.

FIG. 28A is a graph illustrating an unevenness percentage as a result of simulation in Experiments 18-1, 18-2, and 19-1 to 19-6.

FIG. 28B is a graph illustrating a variation of the unevenness percentage as a result of simulation in Experiments 18-1, 18-2, 19-1 to 19-6 when a difference from a design value H is ranged from −2 mm to +4 mm.

FIG. 29 is a graph illustrating a luminance distribution as a result of simulation in Experiment 20.

FIG. 30 is a graph illustrating a variation of the front luminance as a result of simulation in Experiments 21-1 and 21-2.

FIG. 31A is a perspective diagram illustrating a configuration example of the shaped diffusion plate having a stack structure including a lens layer and a diffusion layer.

FIG. 31B is a cross-sectional diagram illustrating a configuration example of the shaped diffusion plate having a stack structure including a lens layer and a diffusion layer.

FIG. 32A is a graph illustrating a cross-sectional shape of the lens portion of the shaped diffusion plate in Experiments 21, and 22-1 to 22-3.

FIG. 32B is a graph illustrating an unevenness percentage as a result of simulation in Experiments 21, and 22-1 to 22-3.

FIG. 33 is a graph illustrating an unevenness percentage as a result of simulation in Experiments 23, and 24-1 to 24-6.

FIG. 34 is a cross-sectional diagram illustrating a configuration example of the shaped diffusion plate having a stack structure obtained by stacking two or more diffusion layers.

FIG. 35 is a graph illustrating a shape of a convex portion of the shaped diffusion plate in Experiments 20-1 to 20-3.

FIG. 36A is a graph illustrating a luminance distribution as a result of simulation in Experiment 20-1 in which a basic angle is set to 40°, a summit curvature R is set to 20 μm, a curvature is not provided in a valley, and a ratio R/Cp between the summit curvature R and a pitch Cp of the convex portion is set to 0.26.

FIG. 36B is a graph illustrating a luminance distribution as a result of simulation in Experiment 20-2 in which a basic angle is set to 40°, a summit curvature R is set to 20 μm, a curvature is not provided in the summit, and a ratio R/Cp between the valley curvature R and a pitch Cp of the convex portion is set to 0.26.

FIG. 36C is a graph illustrating a luminance distribution as a result of simulation in Experiment 20-3 in which a basic angle is set to 40°, a summit curvature R1 is set to 10 μm, a valley curvature R2 is set to 10 μm, and a ratio R/Cp between the curvature R and a pitch Cp of the convex portion is set to 0.26 (where, R=R1+R2).

FIG. 37A is a schematic diagram illustrating a first configuration example of a sheet stack structure provided in a liquid crystal display device according to a fourth embodiment.

FIG. 37B is a schematic diagram illustrating a second configuration example of a sheet stack structure provided in a liquid crystal display device according to the fourth embodiment.

FIG. 38A is a perspective diagram illustrating a configuration example of the shaped diffusion plate according to the fourth embodiment.

FIG. 38B is a cross-sectional diagram illustrating a configuration example of the shaped diffusion plate according to the fourth embodiment.

FIG. 39 is a cross-sectional diagram illustrating a configuration example of the shaped diffusion plate according to a fifth embodiment.

FIG. 40A is a graph illustrating a cross section of the lens portion of the shaped diffusion plate in Experiments 27, and 28-1 to 28-4.

FIG. 40B is a graph illustrating an increase rate of the luminance as a result of simulation in Experiments 27, and 28-1 to 28-4.

FIG. 41 is a graph illustrating a distribution of the front luminance in Experiments 29 and 30-1.

FIG. 42 is a graph illustrating an unevenness percentage as a result of simulation in Experiments 29, and 20-1 and 20-4.

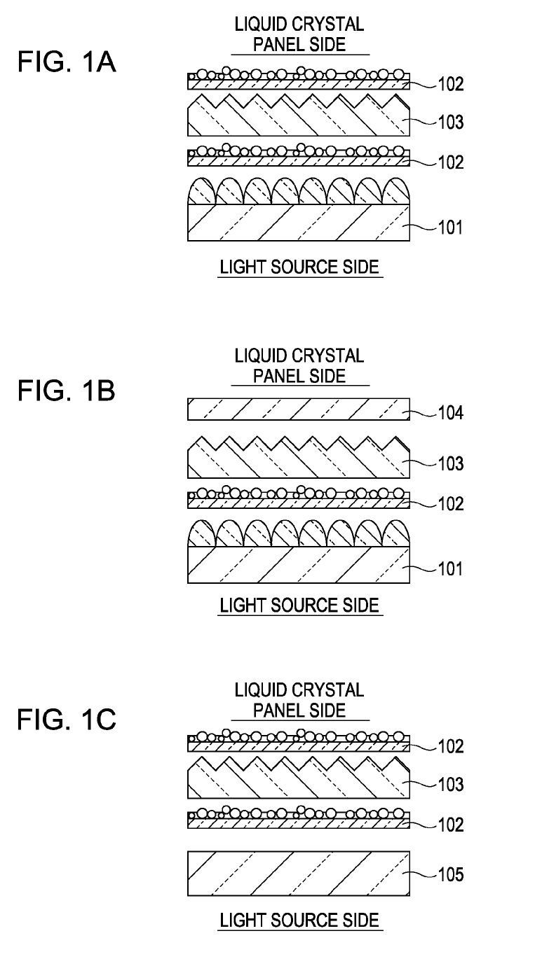

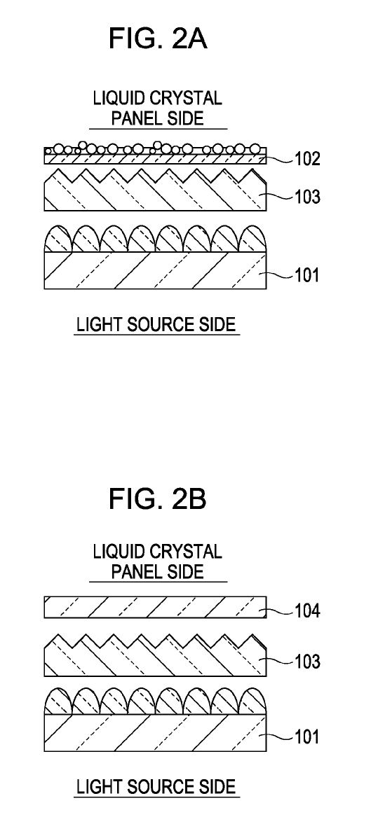

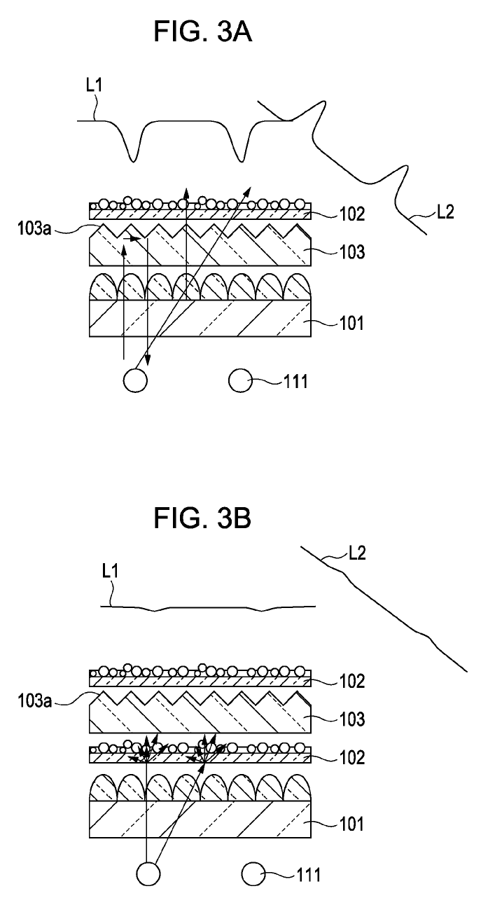

### DETAILED DESCRIPTION

Embodiments will be described with reference to the accompanying drawings in the following sequence.

1. FIRST EMBODIMENT: relating to an example of correcting luminance unevenness using a prism sheet

2. SECOND EMBODIMENT: relating to an example of correcting luminance unevenness using a diffusion plate

3. THIRD EMBODIMENT: relating to an example of correcting luminance unevenness using arrangement of a prism sheet and a diffusion plate)

4. FOURTH EMBODIMENT: relating to an example of a shaped diffusion layer having a single-layered structure, a backlight unit having the same, and a liquid crystal display device having the same)

5. FIFTH EMBODIMENT: relating to an example of a shaped diffusion layer having a multilayer structure)

### 1. First Embodiment

Configuration of Liquid Crystal Display Device

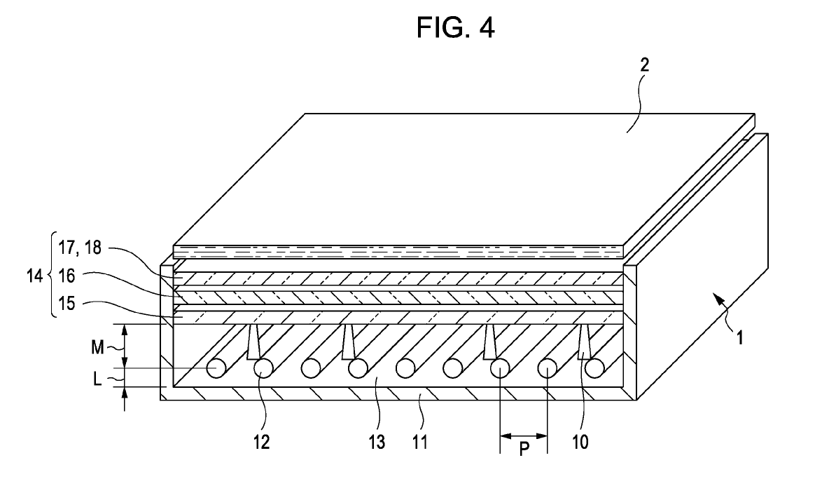

FIG. 4 is a schematic diagram illustrating a configuration example of a liquid crystal display device according to a first embodiment. As shown in FIG. 4, the liquid crystal display device includes a backlight unit 1 for emitting light and a liquid crystal panel 2 for displaying an image by temporally and spatially modulating the light emitted from the backlight unit 1.

Hereinafter, the backlight unit 1 and the liquid crystal panel 2 provided in the liquid crystal display device will be sequentially described.

Liquid Crystal Panel

For example, as the liquid crystal panel 2, various display modes such as a twisted nematic (TN) mode, a super twisted nematic (STN) mode, a vertical aligned (VA) mode, an in-plane switching (IPS) mode, an optically compensated birefringence (OCB) mode, a ferroelectric liquid crystal (FLC) mode, a polymer dispersed liquid crystal (PDLC) mode, a phase change guest host (PCGH) mode may be used.

Backlight Unit

For example, a direct light type backlight unit may be used as the backlight unit 1. The backlight unit 1 includes, for example, a casing 11, a plurality of light sources 12, a reflection sheet 13, a sheet stack structure 14, and a plurality of stud pins 10. The reflection sheet 13 is disposed in the back surface of the light source 12. A plurality of stud pins 10 are disposed in the inner surface the casing 11, and the sheet stack structure 14 is supported by a plurality of the stud pins 10. The sheet stack structure 14 is interposed between the light source 12 and the liquid crystal panel 2.

Hereinafter, the light source 12, the reflection sheet 13, and the sheet stack structure 14 provided in the backlight unit 1 will be sequentially described.

Light Source

As the light source 5, for example, a linear shape light source may be used. The linear shape light source may include, for example, a fluorescent lamp such as a CCFL (Cold Cathode Fluorescent Lamp), a HCFL (Hot Cathode Fluorescent Lamp). The light source 5 may be formed in a columnar shape and disposed in parallel at an equally-spaced interval or unequally-spaced interval. In addition, it is assumed that a light source including point-like light sources such as an LED (Light Emitting Diode) arranged in a linear shape is also included in the linear shape light source.

Reflection Sheet

The reflection sheet 13 is provided to improve use efficiency of the light by reflecting or diffusing a part of the light emitted from the light source 12. While any material capable of diffusing or reflecting light may be used in the reflection sheet 13 without limitation, for example, a diffused reflection-based (white) reflection sheet or a specular reflection-based reflection sheet may be used. The diffused reflection-based reflection sheet 13 includes, for example, a white polyester film, an interface multiple reflection sheet (such as an ultra-white polyester film). A specular reflection-based reflection sheet 13 may includes, for example, a metal thin film such as an aluminum (Al) thin film, a silver thin film. In addition, as the reflection sheet 13, any material capable of diffusing or reflecting light may be used without limitation. In addition, other various materials such as polyethylene terephthalate (PET) or polycarbonate may be used.

Sheet Stack Structure

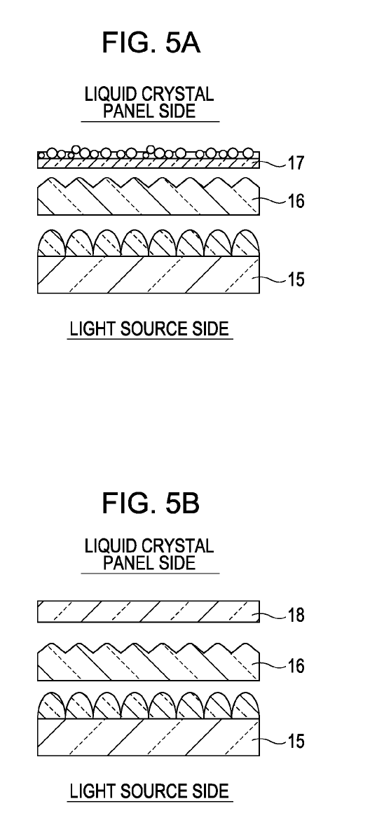

FIG. 5A is a schematic diagram illustrating a first configuration example of the sheet stack structure. As shown in FIG. 5A, the sheet stack structure 14 of the first configuration example includes a shaped diffusion plate 15, a prism sheet 16, and a diffusion sheet 17. The sheet stack structure 14 has an incident surface to which the light emitted from the light source 12 is incident and an emitting surface from which the light incident from the incident surface is emitted. The shaped diffusion plate 15, the prism sheet 16, and the diffusion sheet 17 are stacked in this order from the incident surface to the emitting surface of the sheet stack structure 14.

FIG. 5B is a schematic diagram illustrating a second configuration example of the sheet stack structure. As shown in FIG. 5B, the sheet stack structure 14 of the second configuration example includes a diffusion plate 15, a prism sheet 16, and a reflective polarization sheet 18. The shaped diffusion plate 15, the prism sheet 16, and the reflective polarization sheet 18 are stacked in this order from the incident surface to the emitting surface of the sheet stack structure 14.

Shaped Diffusion Plate

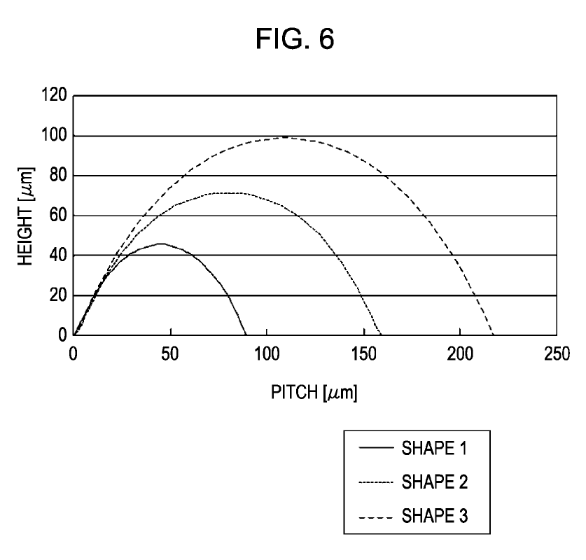

The shaped diffusion plate 15 has, for example, both principal surfaces. On one principal surface facing the liquid crystal panel 2, a plurality of convex portions extending in a single direction are arranged in a direction perpendicular to the extending direction. A plurality of convex portion as an optical diffuser has the function of diffusing the light from each light source 12 or the returned light from the prism sheet 16 side by virtue of the shape of the convex portion. The convex portion has, for example, a lenticular shape. Here, the “lenticular” shape means that the cross-sectional shape perpendicular to the ridge line of the convex portion has a part of an arc shape, a nearly arc shape, an elliptical arc shape, or a nearly elliptical arc shape (e.g., refer to FIG. 6). The shaped diffusion plate 15 has, for example, a relatively thick plate shape, and includes transparent resin as a main component. The material of the shaped diffusion plate 15 includes, for example, light-transmitting thermoplastic resin such as polyethylene terephthalate (PET), acryl, polycarbonate, polystyrene, polypropylene (PP), poly(methyl methacrylate) (PMMA) resin, a copolymer (MS) of methyl methacrylate and styrene. The shaped diffusion plate 15 may have, for example, an optical diffusion layer containing a diffusion agent inside. In a case where the shaped diffusion plate 15 contains the diffusion agent, if the content amount of the diffusion agent is too large, the effect of the shape of the light emitting surface is removed. Therefore, it is preferable to appropriately adjust the content amount of the diffusion agent. While the diffusion agent may include, for example, an organic filler or an inorganic filler, the cavitary particle may be used as the diffusion agent. The shaped diffusion plate 15 may have a randomly-embossing shape by several tens or several hundreds micrometers on the other principal surface facing the light source side from the viewpoint of damage protection.

Diffusion Sheet

The diffusion sheet 17 has the function of improving the field of view by diffusing the light transmitted through the prism sheet 16. The diffusion sheet 17 also has the function of diffusing the light from each light source 12 or the returned light from the prism sheet side. The diffusion sheet 17 has, for example, a relatively thin sheet shape having both principal surfaces. The diffusion sheet 17 has, for example, a base body (e.g., a transparent base body) having a sheet shape with both principal surfaces and a diffusion layer formed on one principal surface of the base body. The base body contains, for example, transparent resin as a main component and has a sheet shape. A material of the base body may include, for example, light-transmitting thermoplastic resin such as polyethylene terephthalate (PET), acryl, polycarbonate. The diffusion layer includes a diffusion agent and transparent resin. The diffusion layer may be formed, for example, by coating a coating material containing the diffusion agent on the base body and curing it. While, for example, an organic filler or an inorganic filler may be used as the diffusion agent, a cavitary particle may be used as the diffusion agent. The diffusion sheet 17 is not limited to those coated as described above, but a transfer printing type in which the embossing shape is transferred to the resin material may be used as the diffusion sheet 17. The transfer printing type diffusion sheet 17 having the embossing shape may be formed, for example, by coating energy-ray curable resin (such as ultraviolet curable resin) or thermoset resin on the base body, transferring the embossing shape capable of diffusion to the resin, and curing it. It is preferable that the transferred embossing shape is appropriately selected depending on a desired diffusion characteristic, such as a random embossing or an approximately hemisphere embossing (micro-lens).

Reflective Polarization Sheet

The reflective polarization sheet 18 has a multilayer structure (not shown), for example, obtained by alternately stacking layers having different refractive indices. The reflective polarization sheet 18 having such a structure splits the light having high directivity by the prism sheet 16 into a P-wave and an S-wave, transmits only the P-wave, and selectively reflects the S-wave. The reflected S-wave is reflected to the reflection sheet 13 arranged in the back surface of the light source 12 again, and split into the P-wave and the S-wave so that the S-wave reflected at the reflective polarization sheet 18 can be reused. It is preferable that the reflective polarization sheet 18 further includes diffusion layers formed in both principal surfaces of the multilayer structure. Since the multilayer structure is interposed between a pair of diffusion layers as described above, it is possible to widen a field of view by diffusing the P-wave transmitted through this multilayer structure in the diffusion layer within the reflective polarization sheet. In other words, it is possible to allow the reflective polarization sheet 18 to have a diffusion capability for improving the field of view.

Prism Sheet

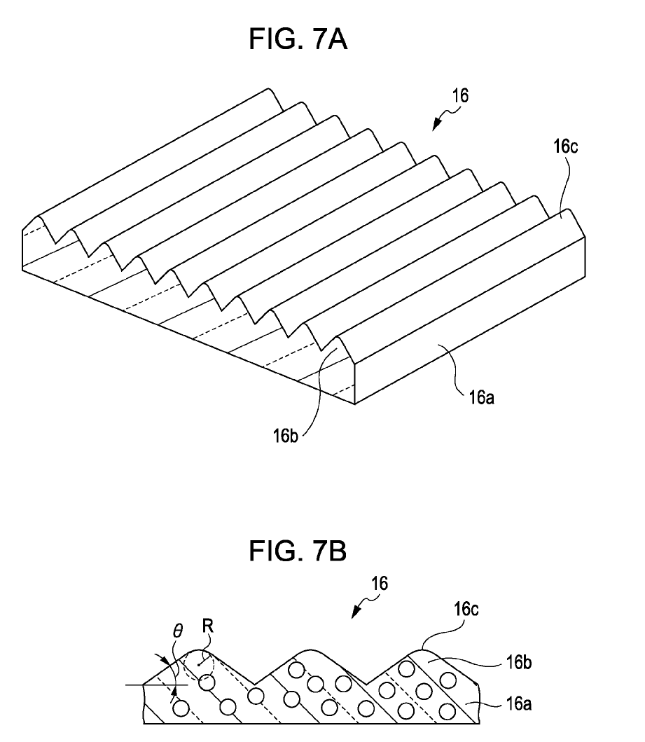

FIG. 7A is a perspective view illustrating a configuration example of the prism sheet. FIG. 7B is a cross-sectional diagram illustrating a configuration example of the prism sheet. As shown in FIGS. 7A and 7B, the prism sheet 16 includes a base body 16a having both principal surfaces with a sheet shape and a plurality of prisms 16b formed in one principal surface of the base body 16a. The one principal surface where the prism 16b is provided faces the liquid crystal panel 2. It is preferable that the base body 16a and a plurality of prisms 16b are integrated into a single piece because it is possible to improve transmittance of the prism sheet 16 by removing the reflection of light at an interface between the base body 16a and a plurality of prisms 16b.

A plurality of prisms 16b are convex portions extending in a single direction on one principal surface of the base body 16a facing the liquid crystal panel 2 and arranged in a direction perpendicular to the extending direction thereof. Specifically, for example, triangular poles having an acute summit with a curvature R at a summit, with a curvature R at a valley, or with a curvature R at both the summit and valley are closely arranged in a single direction. As a result, the prism sheet 16 refracts and transmits components arranged in the same direction as those of each prism out of the light incident to the other principal surface facing the light source 12 into a normal direction to the bottom surface so as to increase directivity and front luminance. The ridge line of the prism 16b may have a meandering shape. The cross section of the prism 16b may have an aspheric shape such as a hyperbolic curve shape.

The basic angle of the prism 16b is preferably equal to or larger than 30° and equal to or smaller than 42.5°, and more preferably, equal to or larger than 37.5° and equal to or smaller than 42.5°. By setting the basic angle of the prism 16b within this angle range, it is possible to suppress the luminance unevenness when the liquid crystal display device is seen from a front direction and the luminance unevenness when the liquid crystal display device is seen from an inclined direction. In addition, it is possible to prevent the stud pins from being observed or from being observed to an unrecognizable level. In a case where the basic angle is not recognizable due to the curvature R in the valley of the prism 16b or the like, the aforementioned basic angle is also denoted by an inclination angle. In other words, the inclination angle of the prism 16b is preferably equal to or larger than 30° and equal to or smaller than 42.5°, and more preferably, equal to or larger than 37.5° and equal to or smaller than 42.5°. Here, the “valley” refers to a concave portion provided between the neighboring prisms, and the “curvature” R of the valley means a curvature of the concave portion provided between the convex portions.

Meanwhile, in a case where the inclination surface of the prism 16b has a curvature R, the angle between the tangential line passing through the point where inclination surfaces of the neighboring prisms 16b are crossed and the direction perpendicular to the extending direction of the prisms 16b within the surface of the prism sheet 16 is considered as the aforementioned basic angle.

The prism 16b has a summit 16c, for example, sharpened or, preferably, having a curvature R because the transfer printing capability for the prism shape can be improved by applying the curvature R to the summit 16c when the prism sheet 16 is formed by a melt extrusion method or the like. In addition, the cutoff can be corrected by applying a curvature R to the summit, the valley, or both of the summit and the valley.

The prism 16b has, for example, an obtuse summit, of which the vertex angle is, preferably, equal to or larger than 95° and equal to or smaller than 120°, and more preferably, equal to or larger than 95° and equal to or smaller than 105°. By setting the vertex angle of the prism 16b to this angle range, it is possible to obtain the same effect as the case where the basic angle of the aforementioned prism 16b is set.

For example, this prism sheet 16 is formed as a single piece by a melt extrusion method using a light-transmitting resin material such as a single or plurality of kinds of thermoplastic resin. For example, the prism sheet 16 may be formed by coating energy-ray curable resin (e.g., ultraviolet curable resin) on a light-transmitting base body 16a made of polyethylene terephthalate as a main component, transferring the prism shape, and curing it. It is preferable that thermoplastic resin having a refractive index equal to or larger than 1.4 be used considering the function of controlling a light-emitting direction. Such a kind of resin may include polycarbonate resin, acrylic resin such as PMMA (poly(methyl methacrylate), polyolefin-based resin such as polyethylene (PE) and polypropylene (PP), polyester resin such as polyethylene terephthalate, amorphous copolymerization polyester resin such as MS (copolymer of methyl methacrylate and styrene), polystyrene resin, polyvinyl chloride resin, cycloolefin-based resin, urethane-based resin, natural rubber-based resin, artificial rubber-based resin, and a combination of them.

The prism sheet 16 preferably contains a diffusion agent. As the diffusion agent, for example, an organic filler or an inorganic filler may be used, and cavitary particles may be also used as the diffusion agent. The internal haze (JIS-K-7136) of the diffusion agent is preferably equal to or larger than 65% and equal to or smaller than 97%. Here, the internal haze of the diffusion agent means the haze caused by the diffusion agent contained internally when the prism portion of the prism sheet 16 is planarized.

### 2. Second Embodiment

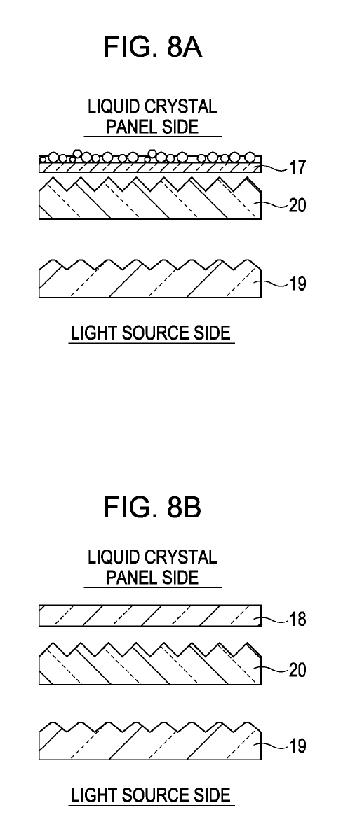

FIG. 8A is a schematic diagram illustrating a first configuration example of a sheet stack structure provided in a backlight unit according to a second embodiment. FIG. 8B is a schematic diagram illustrating a second configuration example of a sheet stack structure provided in a backlight unit according to a second embodiment. As shown in FIGS. 8A and 8B, the second embodiment is different from the first embodiment in that the prism sheet 16 and shaped diffusion plate 15 (shown in FIG. 5) of the first embodiment is substituted with the prism sheet 20 and the shaped diffusion plate 19.

Shaped Diffusion Plate

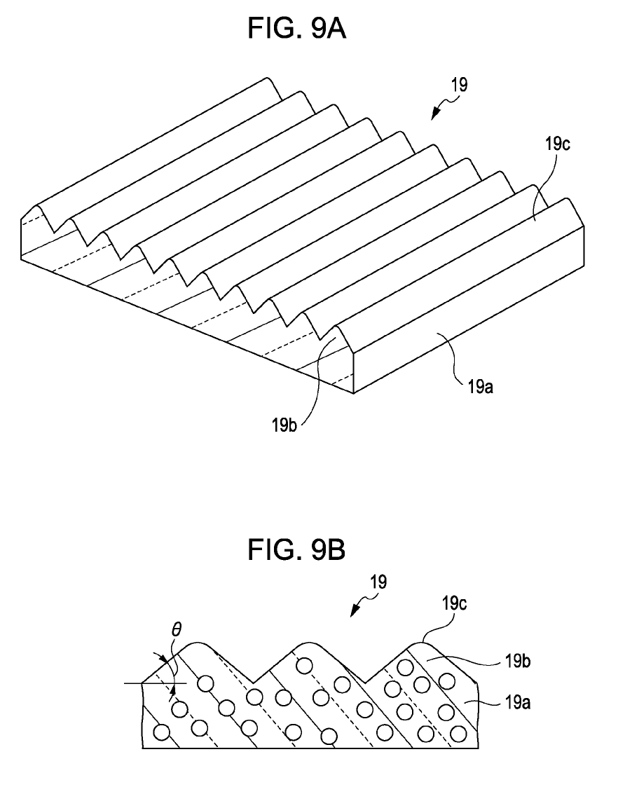

FIG. 9A is a perspective diagram illustrating a configuration example of the shaped diffusion plate 19. FIG. 9B is a cross-sectional diagram illustrating a configuration example of the shaped diffusion plate 19. As shown in FIGS. 9A and 9B, the shaped diffusion plate 19 includes a base body 19a having a plate shape having both principal surfaces and a plurality of convex portions 19b formed in one principal surface of the base body 19a. The one principal surface where the convex portions 19b are provided is disposed to face the liquid crystal panel 2. The base body 19a and a plurality of the convex portions 19b are preferably integrated as a single piece because the transmittance of the shaped diffusion plate 19 can be improved by removing the reflection of light at an interface between the base body 19a and a plurality of convex portions 19b.

A plurality of convex portions 19b extends in a single direction on one principal surface of the base body 19a facing the liquid crystal panel 2 and are arranged in a direction perpendicular to the extending direction. Specifically, for example, triangular poles having a curvature R at a summit are closely arranged in a single direction.

The basic angle of the convex portion 19b is preferably equal to or larger than 38° and equal to or smaller than 42°, more preferably equal to or larger than 39° and equal to or smaller than 42°, and more preferably, equal to or larger than 39° and equal to or smaller than 41°. A ratio R/Cp between the curvature R of the summit of the convex portion 19b and the pitch Cp of the convex portion is preferably set to 0.0014<R/Cp<0.43. By setting the basic angle of the convex portion 19b and the ratio R/Cp to the aforementioned ranges, it is possible to suppress the front luminance unevenness and the inclination luminance unevenness. In addition, it is possible to prevent the stud pin from being observed and further prevent the luminance unevenness caused by the dimension error of the backlight unit from being generated. The portion having the curvature R is not limited to the summit, but the summit or valley, or both of them may have the curvature R. Here, the “valley” means a concave portion provided between the neighboring convex portions, and the “curvature R of the valley” means a curvature of the concave portion provided between the convex portions. However, in a case where both the summit and valley of the convex portion 19b have the curvature R, the curvature of the summit is represented as R1, and the curvature of the valley is represented as R2, so that a relationship R=R1+R2 is defined.

Herein, in a case where the basic angle is not recognizable due to the curvature R of the valley of the convex portion 19b, the aforementioned basic angle is also denoted by an inclination angle. In other words, the inclination angle of the convex portion 19b is preferably equal to or larger than 38° and equal to or smaller than 42°, more preferably equal to or larger than 39° and equal to or smaller than 42°, and more preferably, equal to or larger than 39° and equal to or smaller than 41°.

Meanwhile, in a case where the inclination surface of the convex portion 19b has a curvature R, the angle between the tangential line passing through a point where inclination surfaces of the convex portions 19b are crossed and the direction perpendicular to the extending direction of the convex portions 19b within the surface of the shaped diffusion plate 19 is considered as the aforementioned basic angle.

The shaped diffusion plate 19 preferably contains the diffusion agent because the luminance unevenness can be suppressed. In a case where the diffusion agent is added to the shaped diffusion plate 19, a total light transmittance (JIS-K-7361) of the base body of the shaped diffusion plate 19 is preferably equal to or larger than 82.1% and equal to or smaller than 88.7%. Such total light transmittance of the base body can be obtained by planarizing the convex portions 19b of the shaped diffusion plate 19 using a solution and measuring the total light transmittance according to the standard JIS-K-7361.

Prism Sheet

The prism sheet 20 includes a base body having both principal surfaces with a sheet shape and a plurality of triangular prisms provided in one principal surface of the base body. One principal surface where this prism is provided is disposed to face the liquid crystal panel 2. It is preferable that the base body and a plurality of prisms are integrated into a single piece because it is possible to improve transmittance of the prism sheet by removing the reflection of light at an interface between the base body and a plurality of prisms.

A plurality of prisms are convex portions extending in a single direction on one principal surface of the base body facing the liquid crystal panel 2 and arranged in a direction perpendicular to the extending direction thereof. Specifically, for example, triangular poles having an acute summit with a curvature R at a summit are closely arranged in a single direction. As a result, the prism sheet 20 refracts and transmits components arranged in the same direction as those of each prism out of the light incident from the other principal surface facing the light source 12 into a normal direction to the bottom surface so as to increase directivity and front luminance. The ridge line of the prism may have a meandering shape. The cross section of the prism may have an aspheric shape such as a hyperbolic curve shape.

The prism has a summit, for example, sharpened or, preferably, having a curvature R because the transfer printing capability for the prism shape can be improved by applying the curvature R to the summit when the prism sheet 20 is formed by a melt extrusion method or the like. In addition, the cutoff can be corrected.

Modification of Shaped Diffusion Plate

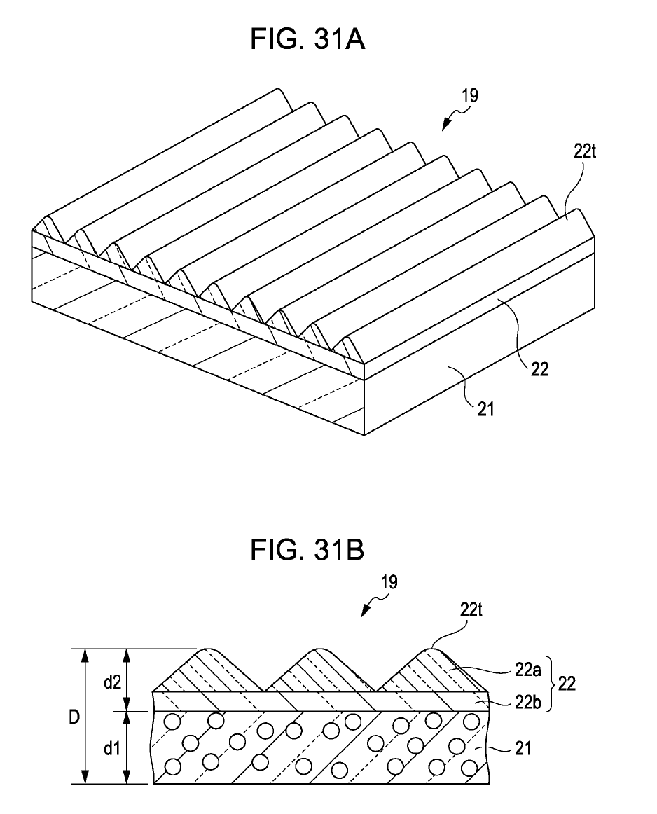

For example, the shaped diffusion plate 19 may include a stack structure having a lens layer 22 and a diffusion layer 21 as shown in FIGS. 31A and 31B. The diffusion layer 21 and the lens layer 22 are stacked in this order from the incident surface of the shaped diffusion plate 19 to the emitting surface.

Out of the diffusion layer 21 and the lens layer 22, only the diffusion layer 21 substantially contains the diffusion agent. In other words, the lens portion 22a and the light-transmitting layer 22b contains a resin material as a main component without the diffusion agent. On the contrary, the diffusion layer 21 contains the diffusion agent and the resin material as a main component to diffuse the light incident from the incident surface of the shaped diffusion plate 19 using the diffusion agent. If the content amount of the diffusion agent contained in the diffusion layer 21 is too large, the effect of the shape of the emitting surface tends to be degraded. Therefore, it is preferable to appropriately adjust the content amount of the diffusion agent. It is preferable that the refractive indices of the diffusion agent and the resin material included in the diffusion layer 21 are different from each other because the light incident to the diffusion layer 21 can be diffused using the diffusion agent. The average particle diameter of the diffusion agent contained in the diffusion layer 21 is preferably equal to or larger than 1 μm and equal to or smaller than 10 μm. If the average particle diameter is smaller than 1 μm, the transmittance increases, and the diffusion tends to weaken. Meanwhile, if the average particle diameter is larger than 10 μm, the diffusion property may not be satisfied without adding a large number of particles. Therefore, cost of the shaped diffusion plate 15 may increase. Here, the average particle diameter is a value obtained using a laser diffraction and dispersion granulometry measurement device (e.g., product name: HORIBA LA-920, manufactured by HORIBA, Inc.).

For example, at least one of an organic filler or an inorganic filler may be used as the diffusion agent. For example, one or more materials selected from a group including acrylic resin, styrene resin, and fluorine resin may be used as the organic filler. For example, one or more materials selected from a group including silica, alumina, talc, titan oxide, and barium sulfate may be used as the inorganic filler. The shape of the filler may include, for example, a spherical shape, a specular shape, an elliptical shape, a plate shape, a scale-like shape, or the like. For example, the cavitary particle may be used as the filler. As the diffusion agent, for example, a grain-size distribution diffusion agent or a mono-dispersed diffusion agent may be used.

The lens layer 22 includes a plurality of lens portions 22a and, if necessary, a light-transmitting layer 22b as a base body. In a case where the lens layer 22 includes the light-transmitting layer 22b, it is preferable that the lens portion 22a and the light-transmitting layer 22b are molded as a single piece because the transmittance of the shaped diffusion plate 19 can be improved by removing reflection of light at the interface between a plurality of lens portions 22a and the light-transmitting layer 22b.

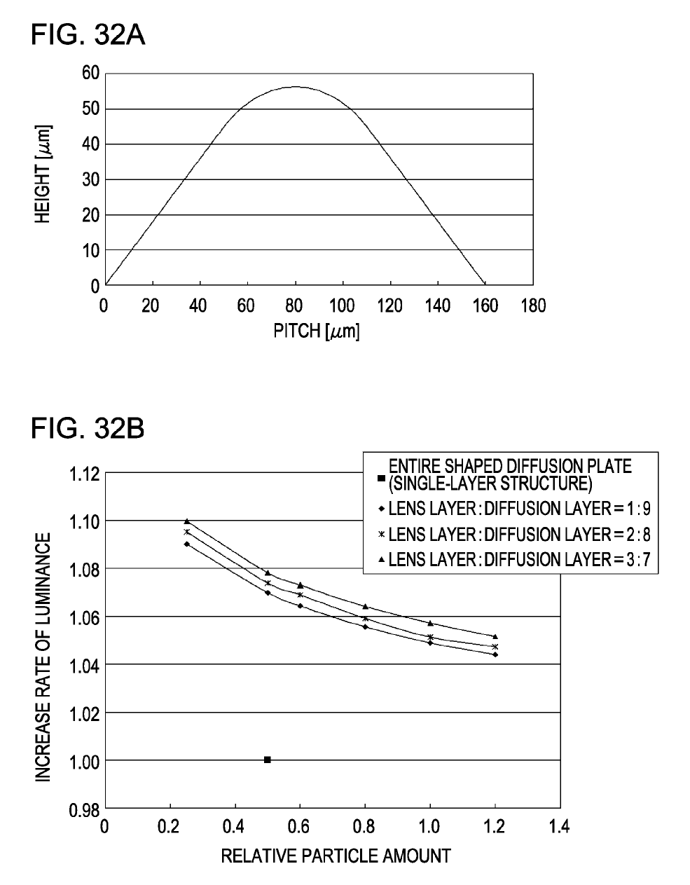

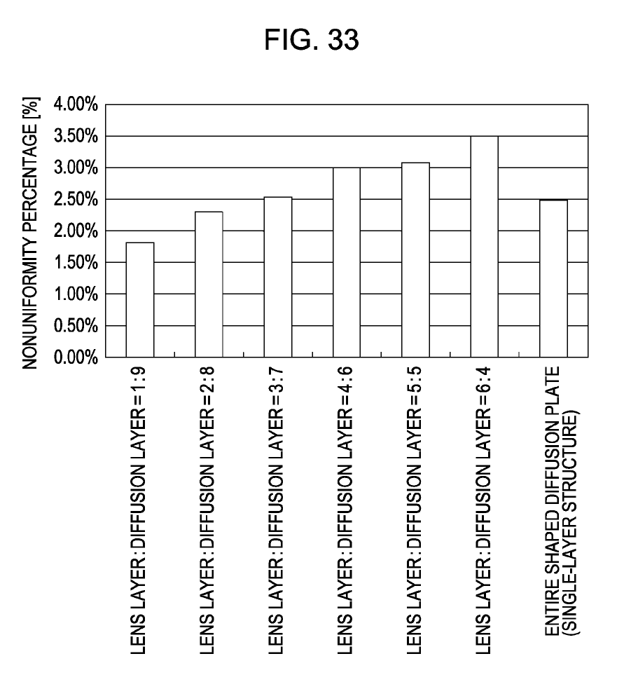

In a case where the shaped diffusion plate 19 has a double-layer structure, and the lens portion 22a has a triangular prism shape with a curvature R at the summit 22t, a percentage R_{D} of the thickness of the diffusion layer 21 with respect to the thickness of the entire shaped diffusion plate is preferably larger than 70%, more preferably, larger than 80%, and still more preferably, equal to or larger than 80% and equal to or smaller than 90%. By setting the percentage to such a range, it is possible to improve luminance and correct luminance unevenness (refer to FIGS. 32B and 33).

In a case where the shaped diffusion plate 19 has a double-layer structure, from the viewpoint of luminance improvement and luminance unevenness correction, the percentage R_{D} of the thickness of the diffusion layer 21 with respect to the thickness of the entire shaped diffusion plate is preferably equal to or larger than 80%, and more preferably, equal to or larger than 80% and equal to or smaller than 90%.

Here, the percentage R_{D} of the thickness of the diffusion layer and the percentage R_{L} of the thickness of the lens layer 22 are defined as follows.

R_{D}=[(a thickness d1 of the diffusion layer 21)/(a thickness D of the entire shaped diffusion plate)]×100(%)

R_{L}=[(a thickness d2 of the lens layer 22)/(a thickness D of the entire shaped diffusion plate)]×100(%)

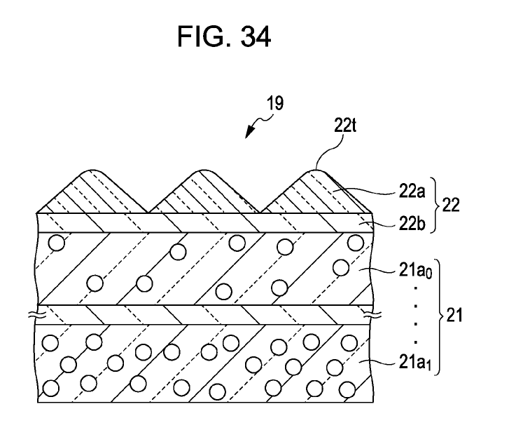

As shown in FIG. 34, the diffusion layer 21 of the shaped diffusion plate 19 may have a stack structure obtained by stacking two or more diffusion layers 21a₁, . . . , 21aₙ. The content amount of the diffusion agent is different between the diffusion layers 21a₁, . . . , 21aₙ. For example, the content amount of the diffusion agent of each diffusion layer 21a₁, . . . , 21aₙ is set to sequentially increase or decrease from the incident surface side to the emitting surface side of the shaped diffusion plate 19. Particularly, it is preferable that the content amount of the diffusion agent sequentially increases from the incident surface side to the emitting surface side.

### 3. Third Embodiment

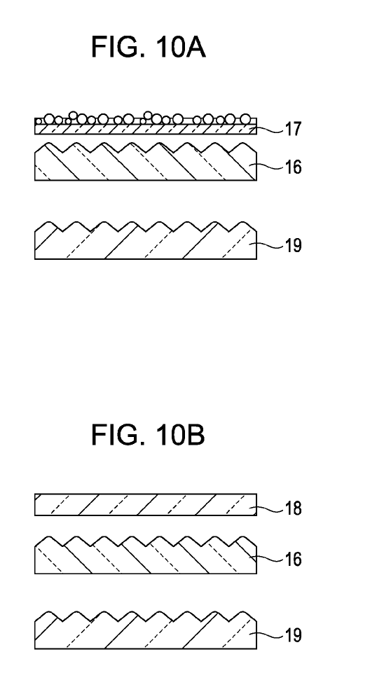

FIG. 10A is a schematic diagram illustrating a first configuration example of a sheet stack structure provided in a liquid crystal display device according to a third embodiment. FIG. 10B is a schematic diagram illustrating a second configuration example of a sheet stack structure provided in a liquid crystal display device according to a third embodiment. As shown in FIG. 10A and 10B, the third embodiment is different from the first and second embodiments in that the prism sheet 16 according to the first embodiment and the shaped diffusion plate 19 according to the second embodiment are combined. By combining the prism sheet 16 according to the first embodiment and the shaped diffusion plate 19 according to the second embodiment, it is possible to suppress the front luminance unevenness, and the oblique luminance unevenness. In addition, it is possible to prevent the stud pins from being observed and the luminance unevenness caused by the dimension error of the backlight unit from being generated.

### 4. Fourth Embodiment

Sheet Stack Structure

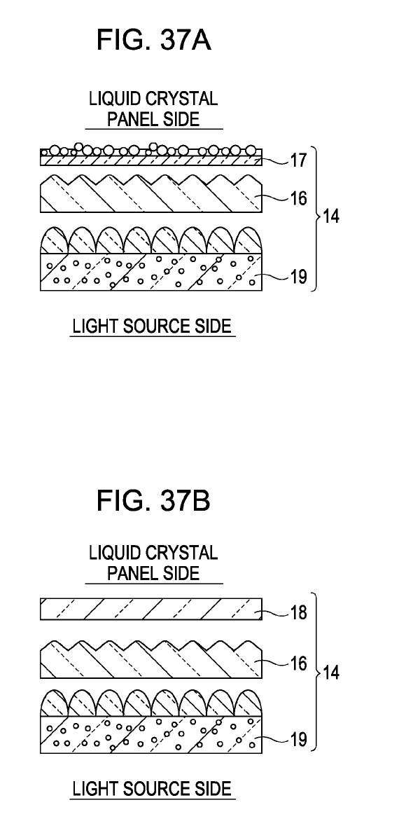

FIG. 37A is a schematic diagram illustrating a first configuration example of a sheet stack structure according to a fourth embodiment. As shown in FIG. 37A, the sheet stack structure 14 of the first configuration example includes a shaped diffusion plate 19, a prism sheet 16, and a diffusion sheet 17. The sheet stack structure 14 has an incident surface to which the light emitted from light source 12 is incident and an emitting surface from which the light incident from the incident surface is emitted. The shaped diffusion plate 19, the prism sheet 16, and the diffusion sheet 17 are stacked in this order from the incident surface to the emitting surface of the sheet stack structure 14.

FIG. 37B is a schematic diagram illustrating a second configuration example of a sheet stack structure according to a fourth embodiment. As shown in FIG. 37B, the sheet stack structure 14 of the second configuration example includes a shaped diffusion plate 19, a prism sheet 16, and a reflective polarization sheet 18. The shaped diffusion plate 19, the prism sheet 16, and the reflective polarization sheet 18 are stacked in this order from the incident surface to the emitting surface of the sheet stack structure 14.

Shaped Diffusion Plate

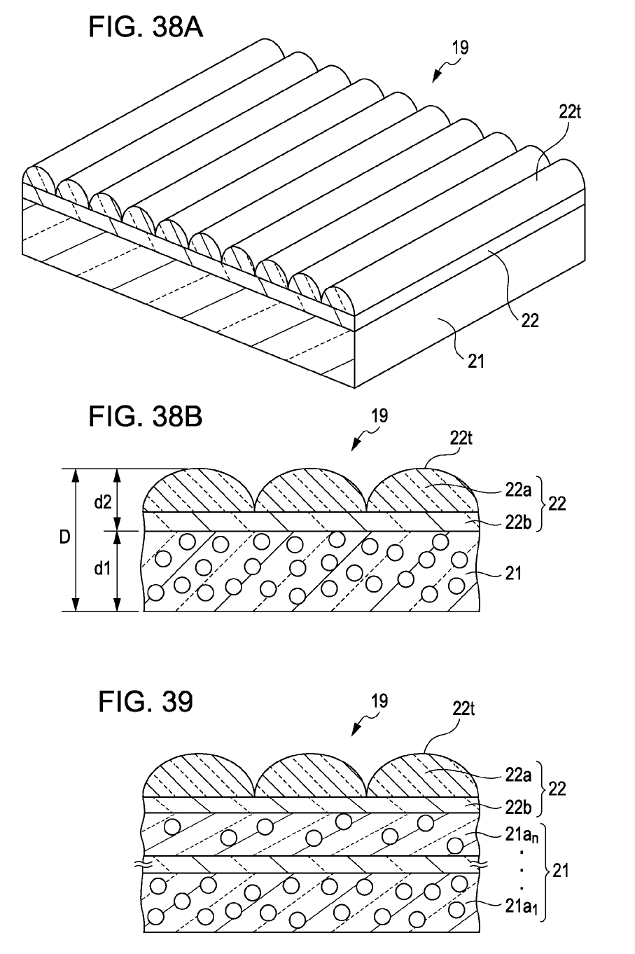

FIG. 38A is a perspective diagram illustrating a configuration example of the shaped diffusion plate according to a fourth embodiment. FIG. 38B is a cross-sectional diagram illustrating a configuration example of the shaped diffusion plate according to a fourth embodiment. The shaped diffusion plate 19 has, for example, a relatively thick plate shape. The shaped diffusion plate 19 has an incident surface (first principal surface) to which the light emitted from the light source 12 is incident and an emitting surface (second principal surface) from which the light incident from the incident surface is emitted. The shaped diffusion plate 19 has a stack structure including the lens layer 22 and the diffusion layer 21. The diffusion layer 21 and the lens layer 22 are stacked in this order from the incident surface to the emitting surface of the shaped diffusion plate 19. It is preferable that a randomly-embossing shape by several tens or several hundreds of micrometers is provided on the incident surface of the shaped diffusion plate 19 facing the light source side from the viewpoint of damage protection.

Out of the diffusion layer 21 and the lens layer 22, only the diffusion layer 21 substantially contains the diffusion agent. In other words, the lens portion 22a and the light-transmitting layer 22b contains a resin material as a main component without the diffusion agent. On the contrary, the diffusion layer 21 contains the diffusion agent and the resin material as a main component to diffuse the light incident from the incident surface of the shaped diffusion plate 19 using the diffusion agent. If the content amount of the diffusion agent contained in the diffusion layer 21 is too large, the effect of the shape of the emitting surface tends to be degraded. Therefore, it is preferable to appropriately adjust the content amount of the diffusion agent. It is preferable that the refractive indices of the diffusion agent and the resin material included in the diffusion layer 21 are different from each other because the light incident to the diffusion layer 21 can be diffused using the diffusion agent. The average particle diameter of the diffusion agent contained in the diffusion layer 21 is preferably equal to or larger than 1 μm and equal to or smaller than 10 μm. If the average particle diameter is smaller than 1 μm, the transmittance increases, and the diffusion tends to weaken. Meanwhile, if the average particle diameter is larger than 10 μm, the diffusion property may not be satisfied without adding a large number of particles. Therefore, cost of the shaped diffusion plate 19 may increase. Here, the average particle diameter is a value obtained using a laser diffraction and dispersion granulometry measurement device (e.g., HORIBA Ltd., Co., product name: HORIBA LA-920).

For example, at least one of an organic filler or an inorganic filler may be used as the diffusion agent. For example, one or two or more materials selected from a group including acrylic resin, styrene resin, and fluorine resin may be used as the organic filler. For example, one or two or more materials selected from a group including silica, alumina, talc, titan oxide, and barium sulfate may be used as the inorganic filler. The shape of the filler may include, for example, a spherical shape, a specular shape, an elliptical shape, a plate shape, a scale-like shape, or the like. For example, the cavitary particle may be used as the filler. As the diffusion agent, for example, a grain-size distribution diffusion agent or a mono-dispersed diffusion agent may be used.

The lens layer 22 includes a plurality of lens portions 22a and, if necessary, a light-transmitting layer 22b as a base body. In a case where the lens layer 22 includes the light-transmitting layer 22b, it is preferable that the lens portion 22a and the light-transmitting layer 22b are molded as a single piece because the transmittance of the shaped diffusion plate 19 can be improved by removing reflection of light at the interface between a plurality of lens portions 22a and the light-transmitting layer 22b.

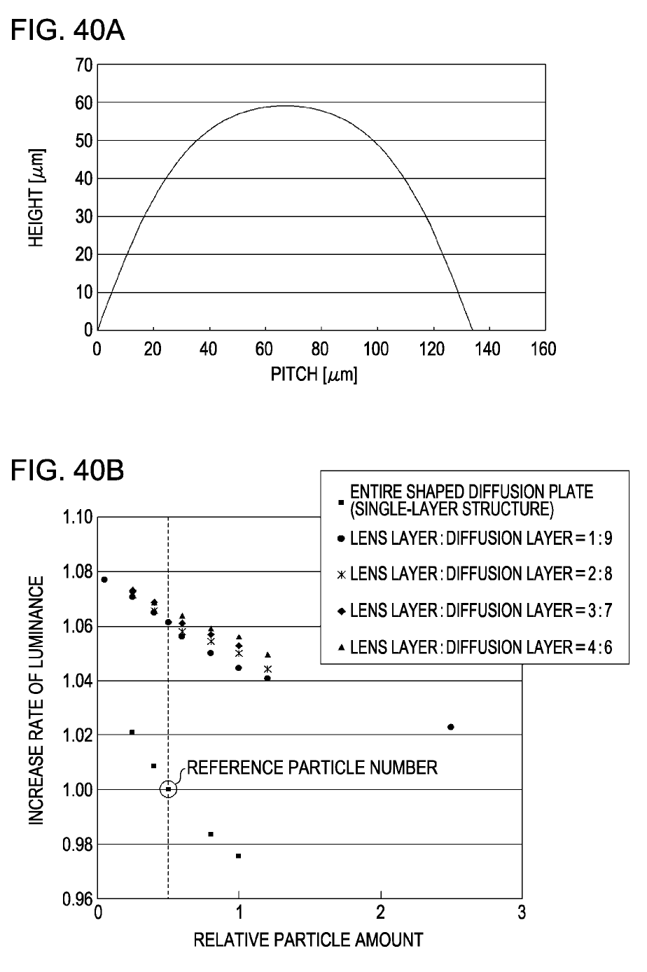

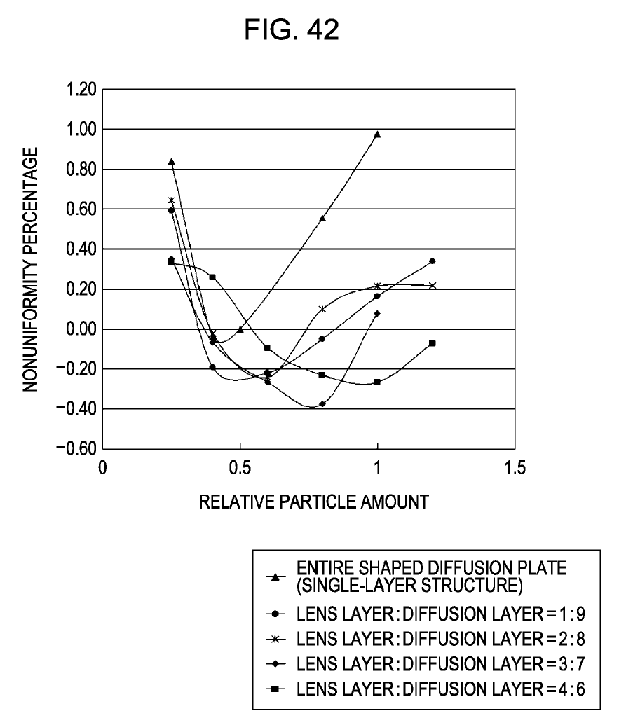

In a case where the shaped diffusion plate 19 has a double-layer structure, and the lens portion 22a has a lenticular shape, a percentage R_{D} of the thickness of the diffusion layer 21 with respect to the thickness of the entire shaped diffusion plate is preferably larger than 60%, more preferably, larger than 70%, and still more preferably, equal to or larger than 70% and equal to or smaller than 90%. Here, the percentage R_{L} is a percentage of the thickness of the lens layer 22 with respect to the thickness of the entire shaped diffusion plate. By setting the percentage R_{D} to be equal to or larger than 60%, it is possible to improve luminance and a margin of the content amount of the diffusion agent (refer to FIGS. 40B and 42). In addition, by setting the percentage R_{D} to be equal to or larger than 70% and equal to or smaller than the percentage R_{L} of the thickness of the lens layer 22, it is possible to improve luminance and correct luminance unevenness (refer to FIGS. 40B and 42).

In a case where the shaped diffusion plate 19 has a double-layer structure, and the lens portion 22a has a triangular prism shape with a curvature R at the summit 22t, a percentage R_{D} of the thickness of the diffusion layer 21 with respect to the thickness of the entire shaped diffusion plate is preferably larger than 70%, more preferably, larger than 80%, and still more preferably, equal to or larger than 80% and equal to or smaller than 90%. By setting the percentage to such a range, it is possible to improve luminance and correct luminance unevenness (refer to FIGS. 32B and 33).

In a case where the shaped diffusion plate 19 has a double-layer structure, from the viewpoint of improving luminance and correcting luminance unevenness independently on the shape of the lens portion 22a, the percentage R_{D} of the thickness of the diffusion layer 21 with respect to the thickness of the entire shaped diffusion plate is preferably equal to or larger than 80%, and more preferably, equal to or larger than 80% and equal to or smaller than 90%.

Here, the percentage R_{D} of the thickness of the diffusion layer and the percentage R_{L} of the thickness of the lens layer 22 are defined as follows.

R_{D}=[(a thickness d1 of the diffusion layer 21)/(a thickness D of the entire shaped diffusion plate)]×100(%)

R_{L}=[(a thickness d2 of the lens layer 22)/(a thickness D of the entire shaped diffusion plate)]×100(%)

The lens portion 22a is a convex portion extending in a single direction on the emitting surface of the shaped diffusion plate 19, and a plurality of lens portions 22a are arranged in a direction perpendicular to the extending direction thereof A plurality of lens portions 22a has the function of an optical diffusion for diffusing the light from each light source 12 or the returned light from the prism sheet 16 by virtue of the shape of the convex portion thereof The shape of the lens portion 22a may include, for example, a triangular shape with a curvature R at a summit 22t or a lenticular shape. Here, the “lenticular” shape means that the cross-sectional shape perpendicular to the ridge line of the convex portion has a part of an arc shape, a nearly arc shape, an elliptical arc shape, or a nearly elliptical arc shape.

Materials of the lens layer 22 and the diffusion layer 21 preferably includes a transparent polymer resin material. Such a resin material may include, for example, light-transmitting thermoplastic resin such as polyethylene terephthalate (PET), acryl, polycarbonate, polystyrene, polypropylene (PP), poly(methyl methacrylate) (PMMA) resin, a copolymer (MS) of methyl methacrylate and styrene.

Prism Sheet, Diffusion Sheet, and Reflective Polarization Sheet

The sheets described in conjunction with the first embodiment may be used as the prism sheet 16, the diffusion sheet 17, and the reflective polarization sheet 18.

According to a fourth embodiment, since the shaped diffusion plate 19 includes a diffusion layer containing the diffusion agent, it is possible to diffuse the light incident to the shaped diffusion plate 19 from the linear-shape light source using the diffusion agent contained in the diffusion layer 21. Therefore, it is possible to correct luminance unevenness in the backlight unit. In addition, the shaped diffusion plate 19 includes the diffusion layer 21 and the lens layer 22, and the diffusion layer 21 contains the diffusion agent. Therefore, it is possible to prevent luminance from being degraded.

### 5. Fifth Embodiment

FIG. 39 is a cross-sectional diagram illustrating a configuration example of the shaped diffusion plate provided in the liquid crystal display device according to a fifth embodiment. As shown in FIG. 39, the fifth embodiment is different from the fourth embodiment in that the diffusion layer 21 of the shaped diffusion plate 19 has a stack structure obtained by stacking two or more diffusion layers 21a₁, . . . , 21aₙ. In addition, like reference numerals denote like elements as in the fourth embodiment described above, and descriptions thereof will be omitted.

The shaped diffusion plate 19 includes an incident surface (first principal surface) to which the light emitted from the light source 12 is incident and an emitting surface (second principal surface) from which the light incident from the incident surface is emitted. The content amount of the diffusion agent is different between the diffusion layers 21a₁, . . . , 21aₙ. The content amount of the diffusion agent of each of the diffusion layers 21a₁, . . . , 21aₙ is set to, for example, sequentially increases or decreases from the incident surface to the emitting surface of the shaped diffusion plate 19. Particularly, it is preferable that the content amount of the diffusion agent sequentially increases from the incident surface to the emitting surface.

### Examples

Hereinafter, examples will be described in detail with reference to the first to third embodiments.

In the following examples, the shaped diffusion plate A, the diffusion plate A, the diffusion sheet, the prism sheet A, the standard backlight dimension, and the backlight units A1 to B2 are prepared as follows.

Shaped Diffusion Plate A

The shaped diffusion plate A having the following configuration was used.
shape of convex portion: shape 2 shown in FIG. 6
thickness: 1.0 mm
refractive index: 1.59
content amount of diffusion agent: 0%,

Here, the thickness represents the thickness of the entire shaped diffusion plate including the base body and the convex portions.

Diffusion Plate A

As the diffusion plate A, a typical unshaped diffusion plate having a total light transmittance of about 65%, which conforms to a standard (JIS-K-7361), was used.

Diffusion Sheet

As the diffusion sheet, model No. PTD737 manufactured by SHINWHA INTERTEK, Inc., was used. In addition, it is possible to obtain a similar result by using model No. BS912 manufactured by KEIWA, Inc., or model No. SD743 manufactured by SHINWHA INTERTEK, Inc.

Prism Sheet A

As the prism sheet A, the following configuration was used.
thickness: 350 μm
refractive index: 1.59
lens pitch Cp of convex portion: 110 μm
basic angle: 45°
curvature R of summit: 10 μm

Here, the thickness represents the thickness of the entire prism sheet including the base body and the convex portions.

Standard Backlight Dimension

The distances H, P, and L shown in FIG. 4 represent the following distances.
distance H: a distance between the center of the light source and the back surface of the shaped diffusion plate (or the back surface of the diffusion plate)
distance P: a distance between centers of the light sources
distance L: a distance between the center of the light source and the surface of the reflections sheet

The distances H, P, and L of the standard backlight dimension are designated as follows.
distance P=45 mm, distance H=18 mm, and distance L=4 mm

Backlight Unit A1

The backlight unit A1 is a backlight unit of a 32-inch liquid crystal television set having 8 light sources manufactured by SONY, Inc. The light source is a cold cathode fluorescent lamp (CCFL).

The sheet stack structure of this backlight unit is configured as follows.

(light source side) shaped diffusion plate (or diffusion plate)—prism sheet—diffusion sheet (liquid crystal panel side)

Backlight Unit A2

The backlight unit A2 is a backlight unit of a 32-inch liquid crystal television set having 8 light sources manufactured by SONY, Inc. The light source is a cold cathode fluorescent lamp (CCFL).

The sheet stack structure of this backlight unit is configured as follows.

(light source side) shaped diffusion plate (or diffusion plate)—prism sheet—DBEF (manufactured by 3M, Inc.) (liquid crystal panel side)

Backlight Unit B1

The backlight unit B1 is a backlight unit of a 40-inch liquid crystal television set having 12 light sources manufactured by SONY, Inc. The light source is a cold cathode fluorescent lamp (CCFL).

The sheet stack structure of this backlight unit is configured as follows.

(light source side) shaped diffusion plate (or diffusion plate)—prism sheet—diffusion sheet (liquid crystal panel side)

Backlight Unit B2

The backlight unit B2 is a backlight unit of a 40-inch liquid crystal television set having 12 light sources manufactured by SONY, Inc. The light source is a cold cathode fluorescent lamp (CCFL).

The sheet stack structure of this backlight unit is configured as follows.

(light source side) shaped diffusion plate (or diffusion plate)—prism sheet—DBEF (manufactured by 3M, Inc.,) (liquid crystal panel side)

In the following examples, it is assumed that the front luminance unevenness evaluation, the oblique luminance unevenness evaluation, the stud pin visibility evaluation, the prism sheet haze evaluation, the luminance evaluation, and simulation are performed using the following evaluation method and simulation software.

Front Luminance Unevenness Evaluation

Whether or not the dark luminance unevenness on the light source is corrected was evaluated and graded by visually inspecting the backlight unit from the front direction based on the following score criterion. Since it is difficult to practically measure and quantify the luminance unevenness, the score evaluation was performed based on a visual inspection.

5 points: the luminance unevenness is not visible.

4 points: the luminance unevenness is barely visible.

3 points: the luminance unevenness is slightly visible.

2 points: the luminance unevenness is visible.

1 point: the luminance unevenness is clearly visible.

Oblique Luminance Unevenness Evaluation

Whether or not the bright luminance unevenness near the light source is corrected was evaluated and graded by visually inspecting the backlight unit with an inclination of 30° from a front direction (radiation direction) based on the following score criterion.

5 points: the luminance unevenness is not visible.

4 points: the luminance unevenness is barely visible.

3 points: the luminance unevenness is slightly visible.

2 points: the luminance unevenness is visible.

1 point: the luminance unevenness is clearly visible.

Stud Pin Visibility Evaluation

Whether or not the stud pin is observed was evaluated by visually inspecting the backlight unit from the front direction based on the following criterion. The result was expressed using the following marks.

©: the stud pin is not visible.

◯: the stud pin is barely visible.

Δ: the stud pin is slightly visible.

Prism Sheet Haze Evaluation

The shape portion of prism sheet was melted using a solution for planarization, and only the haze caused by the diffusion agent contained inside was evaluated according to the standard JIS-K-7136 (relating to the internal haze). The measurement of the haze was performed using model No. HM-150 manufactured by MURAKAMI COLOR RESEARCH LABORATORY.

Luminance Evaluation

The luminance was evaluated as follows.

The center of the backlight unit was measured from the front direction using a luminance meter, model No. CS1000 manufactured by KONIKA MINOLTA, Inc.

In addition, it is assumed that the luminance is represented as a relative value by setting the luminance of the backlight unit A1 having the following sheet stack structure to 100 as a reference value.

(light source side) shaped diffusion plate A—prism sheet A—diffusion sheet (liquid crystal panel side)

Simulation

The optical property of the backlight unit was obtained based on the Monte Carlo method using an optical simulation software tool LightTools manufactured by ORA® (Optical Research Associates).

Examples will be described in the following sequence.

1. REVIEW OF PRISM SHEET (corresponding to the first embodiment)

1-1. Review of the basic angle of the triangular prism from the viewpoint of suppressing the front luminance unevenness.

1-2. Review of the triangular prism having a curvature R at the summit from the viewpoint of suppressing the front luminance unevenness.

1-3. Review of the basic angle from the viewpoint of improving the luminance and the field of view.

1-4. Review of the basic angle from the viewpoint of suppressing the oblique luminance unevenness.

1-5. Review of the haze from the viewpoint of suppressing the stud pin visibility

2. REVIEW OF SHAPED DIFFUSION PLATE (corresponding to the second embodiment)

2-1. Review of the diffusion agent and the basic angle from the viewpoint of the front luminance unevenness

2-2. Review of the diffusion agent and the basic angle from the viewpoint of the oblique luminance unevenness

2-3. Review of the shape of the convex portion from the viewpoint of suppressing the luminance unevenness caused by the dimension error

2-4. Review of the haze from the viewpoint of suppressing stud pin visibility

2-5. Review of luminance improvement by virtue of the shaped diffusion plate having a multilayer structure and a triangular prism shape with a curvature R at a summit

2-6. Review of luminance improvement and luminance unevenness correction by virtue of the shaped diffusion plate having a multilayer structure and a triangular prism shape with a curvature R at a summit

3. REVIEW OF COMBINATION OF PRISM SHEET AND SHAPED DIFFUSION PLATE (corresponding to the third embodiment)

3-1. Review from the viewpoint of suppressing the front luminance unevenness, the oblique luminance unevenness, and the stud pin visibility

3-2. Review from the viewpoint of suppressing the luminance variation

### 1. Review of Prism Sheet (Corresponding to the First Embodiment)

1-1. Review of the Basic Angle of the Triangular Prism from the Viewpoint of Suppressing the Front Luminance Unevenness.

Experiment 1

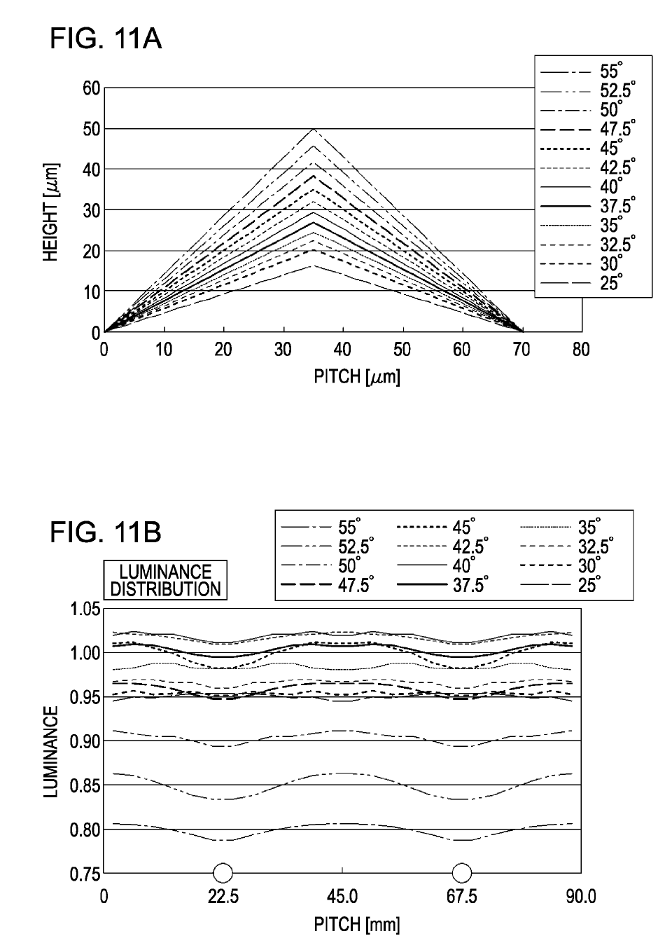

As shown in FIG. 11A, the front luminance of the backlight unit was obtained by changing the basic angle of the triangular prism of the prism sheet through simulation. The result is shown in FIG. 11B.

The simulation was performed based on the following conditions.
backlight unit: standard backlight dimension
sheet configuration: (light source side) shaped diffusion plate A—prism sheet—diffusion sheet (light source side)

(Here, the prism sheet has a thickness of 0.35 mm, a refractive index of 1.59, and a pitch Cp of the convex portion of 70 μm).

From FIG. 11B, it is possible to understand the following fact.

As the basic angle of the prism decreases from 45° (corresponding to the basic angle of the prism of the related art), the dark luminance unevenness on the light source is gradually corrected and nearly perfectly eliminated when the basic angle is equal to or larger than 30° and equal to or smaller than 42.5°. However, as the basic angle of the prism is reduced below 30° and reaches 25°, in turn, the light source becomes brighter, and luminance unevenness is generated.

Considering the aforementioned fact, from the viewpoint of correcting the luminance unevenness, the basic angle of the prism is preferably equal to or larger than 30° and equal to or smaller than 42.5°, and more preferably, equal to or larger than 37.5° and equal to or smaller than 42.5°.

### Example 1-1

First, a prism sheet having a plurality of triangular prisms provided on one principal surface was prepared. Details of the configuration of this prism sheet are as follows.
basic angle: 41°
curvature R of summit: 0 μm
pitch Cp of prism: 200 μm
thickness: 350 μm
resin material: polycarbonate resin

Next, the shaped diffusion plate A, the prism sheet, and the diffusion sheet were mounted on the backlight unit A1. As a result, a backlight unit as a sample was obtained.

### Example 1-2

A backlight unit similar to that of Example 1 was obtained except that the shaped diffusion plate A, the prism sheet, and the reflective polarization sheet (product name DBEF manufactured by 3M, Inc.,) are mounted on the backlight unit A2.

### Comparison Example 1-1

A backlight unit similar to that of Example 1-1 was obtained except that the basic angle of the prism sheet is set to 45°, and the curvature R of the summit is set to 0 μm.

### Comparison Example 1-2

A backlight unit similar to that of Example 1-2 was obtained except that the basic angle of the prism sheet is set to 45°, and the curvature R of the summit is set to 0 μm.

Front Luminance Unevenness Evaluation

The front luminance unevenness was evaluated for the backlight units obtained as described above. The evaluation result is as follows.

Examples 1-1 and 1-2 (a triangular prism having a basic angle of 41° and a curvature R of the summit of 0 μm): 3 points
Comparison Examples 1-1 and 1-2 (a triangular prism having a basic angle of 45° and a curvature R of the summit of 0 μm): 2 points

From the evaluation results, it is recognized that the backlight unit that was practically manufactured also has the same tendency as the simulation between the basic angle of the prism and the luminance unevenness correction.

1-2. Review of the Triangular Prism Having a Curvature R at a Summit from the Viewpoint of Suppressing the Front Luminance Unevenness.

Experiment 2

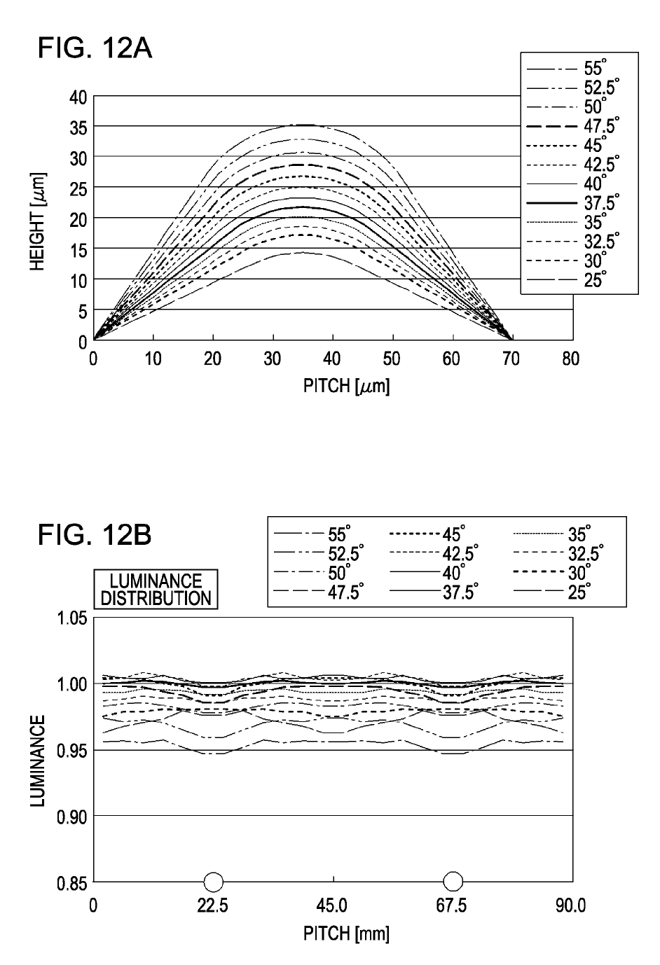

As shown in FIG. 12A, the front luminance of the backlight unit was obtained through simulation by setting a curvature R of the summit to 20 μm and a percentage R/Cp of (the curvature R of the summit)/(the pitch Cp of the convex portion) to 29% and changing the basic angle of the prism. The result is shown in FIG. 12B.

From FIG. 12B, it is recognized that Experiment 2 also has the same tendency as that of Experiment 1. In other words, as the basic angle of the prism decreases from 45° (corresponding to the basic angle of the prism of the related art), the dark luminance unevenness on the light source is gradually corrected and nearly perfectly eliminated when the basic angle is equal to or larger than 30° and equal to or smaller than 42.5°. However, as the basic angle of the prism is reduced below 30° and reaches 25°, in turn, the light source becomes brighter, and the luminance unevenness is generated.

Considering the aforementioned fact, even when the curvature R is applied to the summit of the prism, from the viewpoint of correcting the luminance unevenness, the basic angle of the prism is preferably equal to or larger than 30° and equal to or smaller than 42.5°, and more preferably, equal to or larger than 37.5° and equal to or smaller than 42.5°.

### Example 2-1

First, a prism sheet having a plurality of triangular prisms with a curvature R at the summit provided on one principal surface was prepared. Details of the configuration of this prism sheet are as follows.
basic angle: 40°
curvature R of summit: 20 μm
pitch Cp of prism: 70 μm
thickness: 350 μm
resin material: polycarbonate resin

Next, the shaped diffusion plate A, the prism sheet, and the diffusion sheet were mounted on the backlight unit A1. As a result, a backlight unit as a sample was obtained.

### Example 2-2

A backlight unit similar to that of Example 1 was obtained except that the shaped diffusion plate A, the prism sheet, and the reflective polarization sheet (product name DBEF manufactured by 3M, Inc.,) are mounted on the backlight unit A2.

### Comparison Example 2-1

A backlight unit similar to that of Example 2-1 was obtained except that the basic angle of the prism sheet is set to 45°, the curvature R of the summit is set to 0 μm, and the prism pitch Cp is set to 70 μm.

### Comparison Example 2-2

A backlight unit similar to that of Example 2-2 was obtained except that the basic angle of the prism sheet is set to 45°, the curvature R of the summit is set to 0 μm, and the prism pitch Cp is set to 70 μm.

### Comparison Example 2-3

A backlight unit similar to that of Example 2-1 was obtained except that the basic angle of the prism sheet is set to 45°, the curvature R of the summit is set to 20 μm, and the prism pitch Cp is set to 110 μm.

### Comparison Example 2-4

A backlight unit similar to that of Example 2-2 was obtained except that the basic angle of the prism sheet is set to 45°, the curvature R of the summit is set to 20 μm, and the prism pitch Cp is set to 110 μm.

### Examples 2-3 and 2-4

Backlight units similar to those of Examples 2-1 and 2-2 were obtained using the backlight units B1 and B2.

### Comparison Examples 2-5 to 2-8

Backlight units similar to those of Examples 2-1 to 2-4 were obtained using the backlight units B1 and B2.

Front Luminance Unevenness Evaluation

The front luminance unevenness was evaluated for the backlight units obtained as described above. The evaluation result is as follows. For reference purposes, the evaluation result of the luminance evenness of Examples 1-1 and 1-2 are also shown below.
Examples 2-1 and 2-4 (a triangular prism having a basic angle of 40°, a curvature R of the summit of 20 μm, and a pitch Cp of 70 μm): 4 points
Comparison Examples 2-1, 2-2, 2-5, and 2-6 (a triangular prism having a basic angle of 45°, a curvature R of the summit of 0 μm, and a pitch Cp of 70 μm): 2 points
Comparison Examples 2-3, 2-4, 2-7, and 2-8 (a triangular prism having a basic angle of 45°, a curvature R of the summit of 20 μm, and a pitch Cp of 110 μm): 2 points
Examples 1-1 and 1-2 (a triangular prism having a basic angle of 41° and a curvature R of the summit of 0 μm): 3 points

From the evaluation results, it is recognized that the backlight unit that was practically manufactured also has the same tendency as the simulation between the basic angle of the prism and the luminance unevenness correction. In other words, it is recognized that the dark luminance unevenness on the light source is corrected by setting the basic angle of the prism to be, preferably, equal to or larger than 30° and equal to or smaller than 42.5°, and more preferably, equal to or larger than 37.5° and equal to or smaller than 42.5° even when the summit of the prism has a curvature R.

It is also recognized that the dark luminance unevenness on the light source is corrected more effectively in the prism sheets (a triangular prism having a basic angle of 40°, a curvature R of the summit of 20 μm, and a pitch Cp of 70 μm) of Examples 2-1 and 2-2 in comparison with the prism sheets (a triangular prism having a basic angle of 41°, and a curvature R of the summit of 0 μm) of Examples 1-1 and 1-2.

It is also recognized that the same effect can be obtained in both cases that the 40-inch model having 12 light sources and the 32-inch model having 8 light sources manufactured by SONY, Inc., are used.

Experiment 3

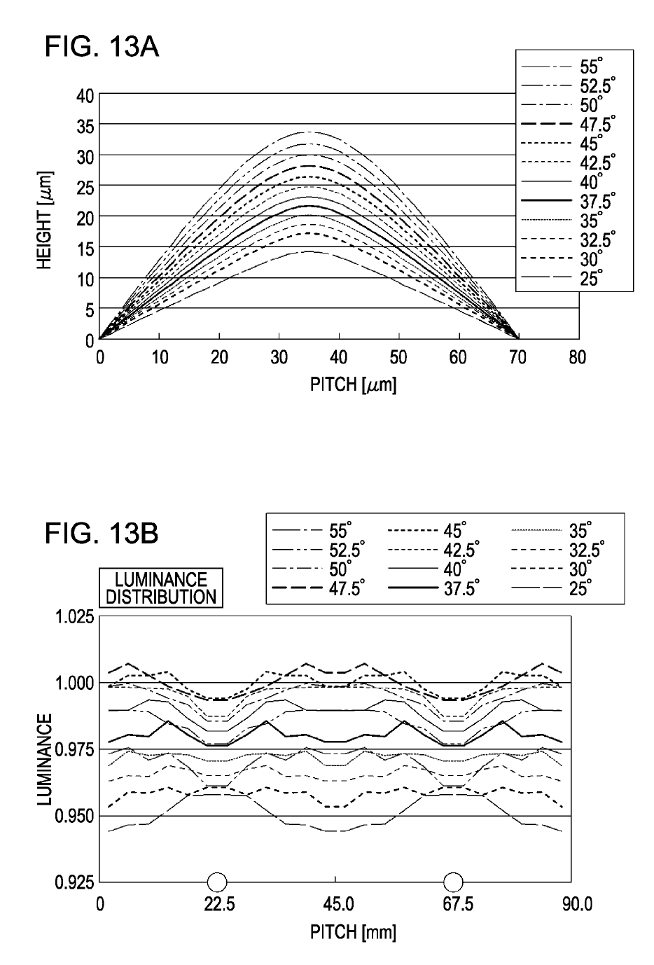

As shown in FIG. 13A, the front luminance of the backlight unit was obtained through simulation by changing the basic angle of the prism for the prism sheet having an aspherical prism defined by the following Equation (1). The result is shown in FIG. 13B.

$$y = \frac{{x}^{2}}{R + \sqrt{{R}^{2} - ( 1 + k ) {x}^{2}}} + {cx}^{4} + {dx}^{6} + {ex}^{8} + … \qquad ( 1 )$$

where, R=10 μm, c=d=e= . . . =0, and k corresponds to an asymptotic line angle of an inclination surface as shown in Table 1.

TABLE 1

| | ASPHERIC ASYMPTOTIC |
|---|---|
| k | LINE ANGLE |
| −1.49 | 55° |
| −1.59 | 52.5° |
| −1.7 | 50° |
| −1.84 | 47.5° |
| −2 | 45° |
| −2.19 | 42.5° |
| −2.42 | 40° |
| −2.7 | 37.5° |
| −3.04 | 35° |
| −3.46 | 32.5° |
| −4 | 30° |
| −5.6 | 25° |

From FIG. 13B, it is recognized that the same tendency as that of Experiment 1 can be obtained also in Experiment 3. In other words, as the basic angle of the prism decreases from 45° (corresponding to the basic angle of the prism of the related art), the dark luminance unevenness on the light source is gradually corrected and nearly perfectly eliminated when the basic angle is equal to or larger than 30° and equal to or smaller than 42.5°. However, as the basic angle of the prism is reduced below 30° and reaches 25°, in turn, the light source becomes brighter, and the luminance unevenness is generated.

Considering the aforementioned fact, even when the prism is aspherical, from the viewpoint of correcting the luminance unevenness, the basic angle of the prism is preferably equal to or larger than 30° and equal to or smaller than 42.5°, and more preferably, equal to or larger than 37.5° and equal to or smaller than 42.5°.

It is preferable that the summit has a curvature R when the prism sheet is formed by a melt extrusion method or the like because the transfer capability of the convex portion is improved. In addition, as described in the following section 1-3, it is preferable that the summit has a curvature R from the viewpoint of the field of view because the cutoff can be corrected.

1-3. Review of the Basic Angle from the Viewpoint of Improving the Luminance and the Field of View

Experiment 4-1

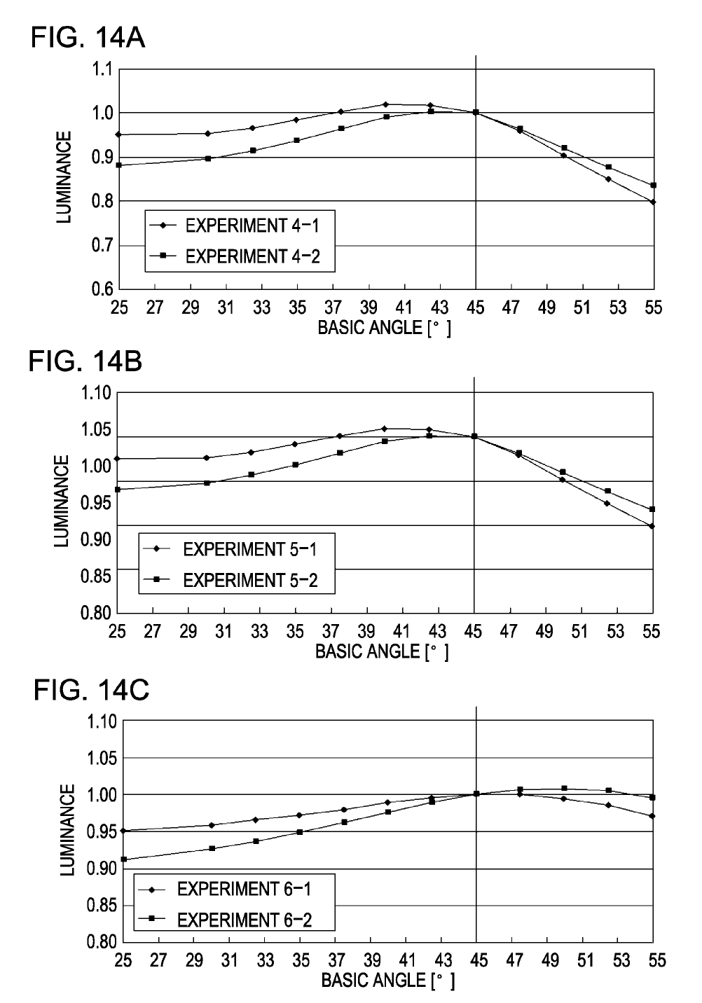

A variation in the front luminance of the backlight unit was obtained through simulation by changing the basic angle of the triangular prism of the prism sheet. The result is shown in FIG. 14A. In FIG. 14A, the luminance curve is normalized such that the luminance obtained when the basic angle of the prism is 45° becomes a reference value (luminance=1). Even in the following Experiments 4-2 to 6-2, the luminance curve obtained through simulation is normalized similar to Experiment 4-1.

The simulation was performed based on the following conditions.
backlight unit: standard backlight dimension
sheet configuration: (light source side) shaped diffusion plate A—triangular prism sheet—diffusion sheet (light source side)

(Here, the prism sheet has a thickness of 0.35 mm, a refractive index of 1.59, and a pitch Cp of the convex portion of 70 μm).

Experiment 4-2

A variation in the front luminance of the backlight unit was obtained through simulation in a similar way to Experiment 4-1 except that the sheet structure of the backlight unit is configured as follows. The result is shown in FIG. 14A.

The simulation was performed based on the following conditions.
backlight unit: standard backlight dimension
sheet configuration: (light source side) diffusion plate A—triangular prism sheet—diffusion sheet (liquid crystal panel side)

(Here, the prism sheet has a thickness of 0.35 mm, a refractive index of 1.59, and a pitch Cp of the convex portion of 70 μm).

Experiment 5-1

A variation in the front luminance of the backlight unit was obtained through simulation by changing the basic angle of the prism in the prism sheet having a curvature R of the summit of 20 μm and a percentage R/Cp of (the curvature R of the summit)/(the pitch Cp of the convex portion) of 29%. The result is shown in FIG. 14B.

The simulation was performed based on the following conditions.
backlight unit: standard backlight dimension
sheet configuration: (light source side) shaped diffusion plate A—triangular prism sheet having a curvature R of 20 μm at a summit—diffusion sheet (liquid crystal panel side)

(Here, the prism sheet has a thickness of 0.35 mm, a refractive index of 1.59, and a pitch Cp of the convex portion of 70 μm).

Experiment 5-2

A variation in the front luminance of the backlight unit was obtained through simulation in a similar way to Experiment 5-1 except that the sheet structure of the backlight unit is configured as follows. The result is shown in FIG. 14B.

The simulation was performed based on the following conditions.
backlight unit: standard backlight dimension
sheet configuration: (light source side) diffusion plate A—triangular prism sheet having a curvature R of 20 μm at a summit—diffusion sheet (liquid crystal panel side)

(Here, the prism sheet has a thickness of 0.35 mm, a refractive index of 1.59, and a pitch Cp of the convex portion of 70 μm).

Experiment 6-1

A variation in the front luminance of the backlight unit was obtained by changing the basic angle of the prism in the prism sheet having an aspherical prism defined in the aforementioned Equation (1). The result is shown in FIG. 14C.

The simulation was performed based on the following conditions.
backlight unit: standard backlight dimension
sheet configuration: (light source side) diffusion plate A—aspheric type triangular prism sheet having a curvature R of 10 μm, where c=d=e= . . . =0—diffusion sheet (liquid crystal panel side)

(Here, the prism sheet has a thickness of 0.35 mm, a refractive index of 1.59, and a pitch Cp of the convex portion of 70 μm).

Experiment 6-2

A variation in the front luminance of the backlight unit was obtained through simulation in a similar way to Experiment 6-1 except that the sheet structure of the backlight unit is configured as follows. The result is shown in FIG. 14C.

The simulation was performed based on the following conditions.
backlight unit: standard backlight dimension
sheet configuration: (light source side) diffusion plate A—aspheric type triangular prism sheet having a curvature R of 10 μm, where c=d=e= . . . =0—diffusion sheet (liquid crystal panel side)

(Here, the prism sheet has a thickness of 0.35 mm, a refractive index of 1.59, and a pitch Cp of the convex portion of 70 μm).

In the diffusion plate configuration (Experiments 4-2, 5-2, and 6-2), the luminance decreases as the basic angle decreases. However, it is recognized that it is difficult to decrease the luminance, or the luminance increases by combining the shaped diffusion plate and the prism sheet having a small basic angle in a similar way to Experiments 4-1, 5-1, and 6-1.

As will be described later, the prism sheet having a small basic angle improves the field of view by alleviating the cutoff phenomenon of the prism sheet. Typically, the prism sheet having a small basic angle exhibits poor luminance. However, it is possible to improve the field of view without degrading luminance by disposing the prism sheet immediately on the shaped diffusion plate.

Experiment 7

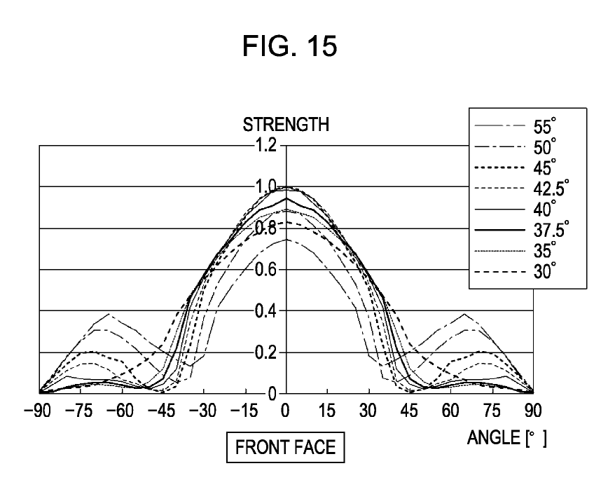

A strength field-of-view distribution was obtained through simulation by changing the basic angle of the triangular prism of the prism sheet. The result is shown in FIG. 15 and Table 2.

The simulation was performed based on the following conditions.
backlight unit: standard backlight dimension
sheet configuration: (light source side) shaped diffusion plate A—triangular prism (liquid crystal panel side)

(Here, the prism sheet has a thickness of 0.35 mm, a refractive index of 1.59, and a pitch Cp of the convex portion of 70 μm).

TABLE 2

| BASE | | SIDE LOBE STRENGTH/ |
|---|---|---|
| ANGLE | CUTOFF ANGLE | FRONT STRENGTH |
| 55° | 35° | 0.512 |
| 50° | 40° | 0.346 |
| 45° | 45° | 0.203 |
| 42.5° | 47.5° | 0.145 |
| 40° | 50° | 0.085 |
| 37.5° | 52.5° | 0.056 |
| 35° | 57.5° | 0.049 |
| 30° | 90° (REMOVED) | 0.000 |

FIG. 15 illustrates a luminance distribution viewed from an oblique direction perpendicular to the prism sheet ridge line, in which the ordinate value 0° is a front direction. As shown in FIG. 15, the prism sheet having a basic angle of 45° has a point where the luminance approaches 0° when the inclination angle is near 45°, and this is called a “cutoff.” While this cutoff phenomenon is slightly alleviated when the diffusion sheet is provided on the prism sheet, it is a main reason of degrading the field of view.

In addition, this simulation was performed without the diffusion sheet on the prism sheet in order to make it easier to identify a variation in the cutoff.

Referring to FIG. 15 and Table 2, as the basic angle increases from 45°, the cutoff point is shifted to the front 0° side, and the field of view is degraded. On the contrary, as the basic angle decreases from 45°, the cutoff point drifts farther from the front 0°, and a phenomenon (i.e., side lobe) in which the luminance increases again at an angle higher than the cutoff point is remarkably reduced, so that it is possible to effectively use the light. At the basic angle of 30°, the cutoff is disappeared.

By combining the shaped diffusion plate and the prism sheet having a small basic angle, which is equal to or larger than 30° and equal to and smaller than 42.5°, it is possible to correct the field-of-view cutoff while suppressing the luminance degradation or increasing the luminance. When the basic angle is within a range equal to or larger than 37.5° and equal to or smaller than 42.5°, it is possible to correct the field-of-view cutoff while increasing the luminance.

1-4. Review of the Basic Angle from the Viewpoint of Suppressing the Oblique Luminance Unevenness.

Experiment 8-1

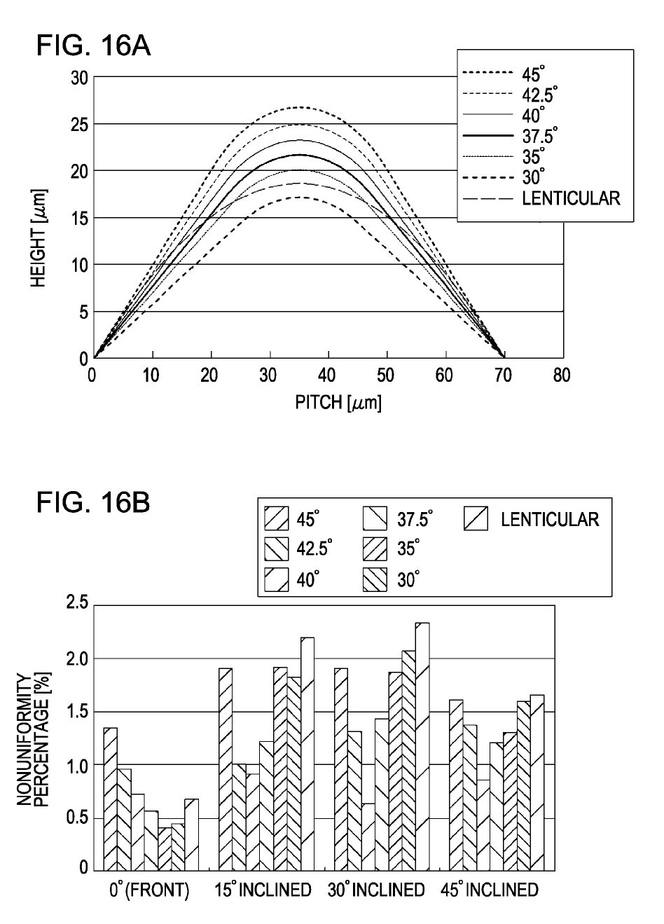

As shown in FIG. 16A, a variation in the luminance in a direction perpendicular to the prism sheet ridge line and in an inclination direction (0°, 15°, 30°, and 45°) to the normal line of the prism sheet was obtained through simulation by changing the basic angle of the prism of the prism sheet. The result is shown in FIG. 16B. In FIG. 16B, an unevenness percentage denoted in the ordinate is defined as ((a maximum value of the luminance distribution)−(a minimum value of the luminance distribution))/(the average value of the luminance distribution)). Therefore, a smaller unevenness percentage is preferable from the viewpoint of the characteristics.

The simulation was performed based on the following conditions.
backlight unit: standard backlight dimension
sheet configuration: (light source side) shaped diffusion plate A—prism sheet—diffusion sheet (light source side)

(Here, the prism sheet has a thickness of 0.35 mm, a refractive index of 1.59, a pitch of the convex portion Cp of 70 μm, and a curvature R of the summit of 20 μm) (refer to FIG. 16A).

Experiment 8-2

A variation in the luminance was obtained through simulation in a similar way to Experiment 8-1 except that the prism shape of the prism sheet is lenticular.

As recognized from FIG. 16B, as the basic angle decreases from 45° as described above, the luminance unevenness is corrected in a front direction of 0°. On the contrary, in an oblique direction, within a range equal to or larger than 37.5° and equal to or smaller than 42.5°, it is recognized that the unevenness percentage is lowered and the oblique luminance unevenness is corrected in the prism having a basic angle of 45°, the prism having a basic angle equal to or smaller than 35°, and the lenticular prism. Particularly, the prism having a basic angle of 40° has a much smaller unevenness percentage.

Through the following experiments, the reason why the oblique luminance unevenness can be corrected within a basic angle range equal to or larger than 37.5° and equal to and smaller than 42.5° was investigated.

Experiment 9-1

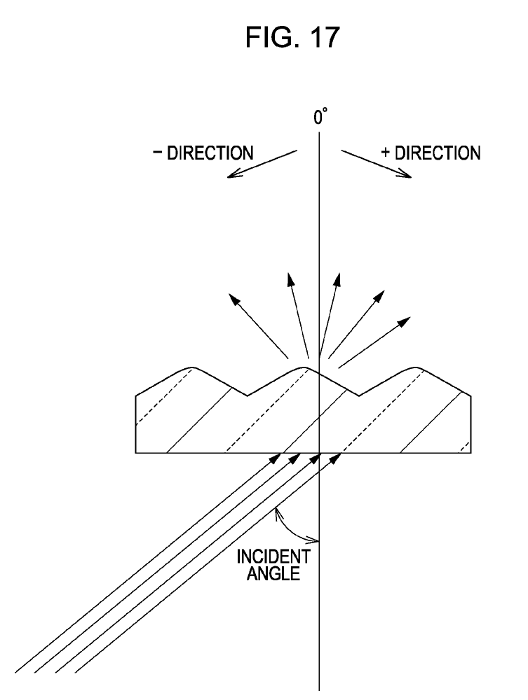

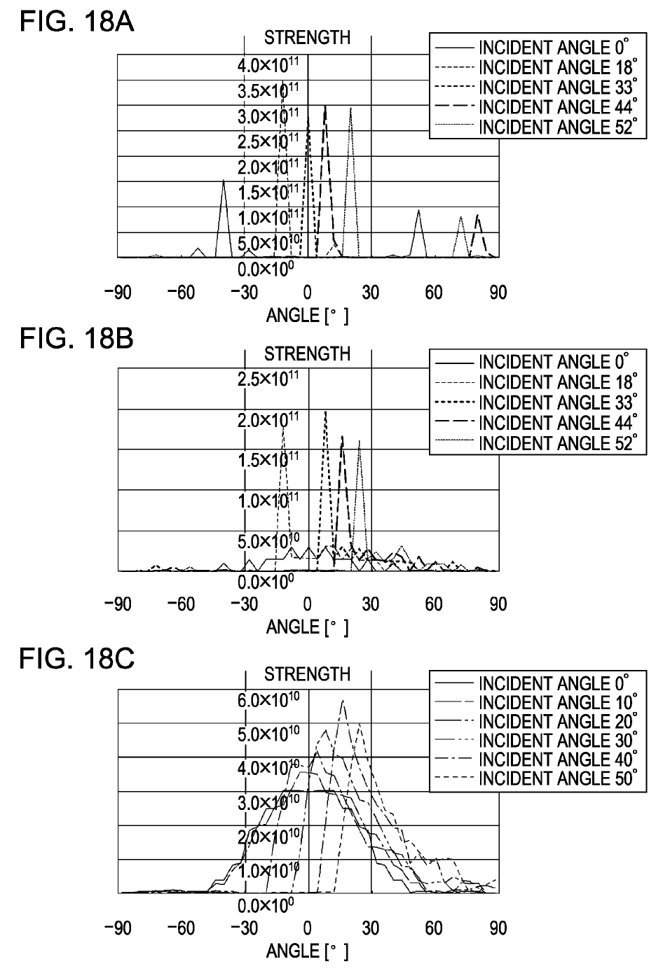

As shown in FIG. 17, for the back surface of the prism sheet having a prism having a basic angle of 45°, an angular strength distribution of the emitted light was obtained through simulation by changing an incident angle of the parallel light. The result is shown in FIG. 18A.

Experiment 9-2

As shown in FIG. 17, for the back surface of the prism sheet having a prism having a basic angle of 40° and a curvature R of the summit of 10 μm, an angular strength distribution of the emitted light was obtained through simulation by changing an incident angle of the parallel light. The result is shown in FIG. 18B.

Experiment 9-3

As shown in FIG. 17, for the back surface of the prism sheet having a lenticular prism shown in FIG. 16A, an angular strength distribution of the emitted light was obtained through simulation by changing an incident angle of the parallel light. The result is shown in FIG. 18C.

The incident angle of the incident light corresponds to a positional relationship with the light source. For example, an incident angle of 0° corresponds to the angular strength distribution immediately on the light source, and an incident angle of 52° corresponds to the angular strength distribution between the light source and the light source. If a particular incident light beam propagates in an oblique direction, the oblique unevenness is aggravated. As shown in FIG. 18A, in the prism having a basic angle of 45°, the light beam having an incident angle of about 0° propagates in an oblique direction with an emission angle of ±30° or more. As shown in FIG. 18C, in the lenticular prism, the light beam having an incident angle of 30° to 50° propagates in an oblique direction with an emission angle of ±30° or more. On the contrary, as shown in FIG. 18B, in the prism having a curvature R of 10 μm at a summit and a basic angle of 40°, the light beam propagating in an oblique direction with an emission angle of ±30° or more does not nearly exist. This is the reason why the oblique unevenness is corrected with a range equal to or larger than 37.5° and equal to or smaller than 42.5° in the aforementioned Experiment 8-1.

### Example 3-1

First, a prism sheet having a plurality of triangular prisms provided on one principal surface with a curvature R at a summit was prepared. Details of the configuration of this prism sheet are as follows.
basic angle: 40°
curvature R of summit: 20 μm
pitch Cp of prism: 70 μm
thickness: 350 μm
resin material: polycarbonate resin

Next, the shaped diffusion plate A, the prism sheet, and the diffusion sheet were mounted on the backlight unit A1. As a result, a backlight unit as a sample was obtained.

### Example 3-2

A backlight unit similar to that of Example 3-1 was obtained except that the shaped diffusion plate A, the prism sheet, and the reflective polarization sheet (product name DBEF manufactured by 3M, Inc.,) are mounted on the backlight unit A2.

### Comparison Example 3-1-1

A backlight unit similar to that of Example 3-1 was obtained except that the basic angle of the prism sheet is set to 45°, the curvature R of the summit is set to 20 μm, and the pitch Cp is set to 110 μm.

### Comparison Example 3-1-2

A backlight unit similar to that of Example 3-2 was obtained except that the basic angle of the prism sheet is set to 45°, the curvature R of the summit is set to 20 μm, and the pitch Cp is set to 110 μm.

### Comparison Example 3-2-1

A backlight unit similar to that of Example 3-1 was obtained except that the basic angle of the prism sheet is set to 45°, the curvature R of the summit is set to 20 μm, the pitch Cp is set to 110 μm, and the prism sheet containing a diffusion agent with a haze of 65% is used.

### Comparison Example 3-2-2

A backlight unit similar to that of Example 3-2 was obtained except that the basic angle of the prism sheet is set to 45°, the curvature R of the summit is set to 20 μm, the pitch Cp is set to 110 μm, and the prism sheet containing a diffusion agent with a haze of 65% is used.

### Comparison Example 3-3-1

A backlight unit similar to that of Example 3-1 was obtained except that the lenticular prism sheet shown in FIG. 16A is used.

### Comparison Example 3-3-2

A backlight unit similar to that of Example 3-2 was obtained except that the lenticular prism sheet shown in FIG. 16A is used.

Luminance Unevenness Evaluation in Front and Oblique Directions

The front luminance unevenness and the oblique luminance unevenness were evaluated for the backlight units obtained as described above. The evaluation result is as follows.
Examples 3-1 and 3-2 (a triangular prism having a basic angle of 40°, a curvature R of the summit of 20 μm, and a pitch Cp of 70 μm):

front luminance unevenness: 4 points

oblique luminance unevenness: 4 points
Comparison Examples 3-1-1 and 3-1-2 (a triangular prism having a basic angle of 45°, a curvature R of the summit of 20 μm, and a pitch Cp of 110 μm):

front luminance unevenness: 2 points

oblique luminance unevenness: 3 points
Comparison Examples 3-2-1 and 3-2-2 (the same triangular prism as those of Comparison examples 3-1-1 and 3-1-2 obtained by adding a diffusion agent so that the haze becomes 65%):

front luminance unevenness: 3 points

oblique luminance unevenness: 3 points
Comparison Examples 3-3-1 and 3-3-2 (the lenticular prism shown in FIG. 16A):

front luminance unevenness: 4 points

oblique luminance unevenness: 2 points

1-5. Review of the Haze from the Viewpoint of Suppressing the Stud Pin Visibility

### Example 4

First, the following configuration was prepared as the shaped diffusion plate.
convex portion shape: shape 3 shown in FIG. 6
thickness: 1.2 mm
refractive index: 1.59
content amount of diffusion agent: 0%

Next, the following configuration as a prism sheet was prepared by changing the content amount (i.e., concentration) of the diffusion agent.
basic angle: 45°
thickness: 0.35 mm
refractive index: 1.59
pitch Cp of prism: 110 μm
curvature R of summit: 20 μm
content amount (concentration) of diffusion agent: 0 wt %, 0.1 wt %, 1.0 wt %, 1.25 wt %, 1.5 wt %, 2.0 wt %, and 4.0 wt %

Next, the haze of the prepared prism sheet was measured. The result is shown in Table 3. Next, the shaped diffusion plate, the prism sheet, and the diffusion sheet were mounted on the backlight unit B1.

Stud Pin Visibility Evaluation

The stud pin visibility of the backlight unit obtained as described above was evaluated. The result is shown in Table 3.

Luminance Evaluation

The luminance of the backlight unit obtained as described above was evaluated. The result is shown in Table 3.

TABLE 3

| DIFFUSION | | | |
|---|---|---|---|
| AGENT | | VISIBILITY OF | |
| CONCENTRATION | HAZE | STUD PIN | LUMINANCE |
| 0% | 0% | Δ | 100 |
| 0.10% | 9% | Δ | — |
| 1.00% | 56% | Δ | 91 |
| 1.25% | 65% | ◯ | 90 |
| 1.50% | 71% | ◯ | 89 |
| 2.00% | 81% | ◯ | 87 |
| 4.00% | 97% | ⊚ | 80 |

From Table 3, it is possible to understand the following fact.

It is recognized that the stud pin visibility was reduced by adding the diffusion agent within a range equal to or larger than 1.25 wt % and equal to or smaller than 4.0 wt %. In addition, since the concentration of the diffusion agent depends on the type of the diffusion agent, the content amount of the diffusion agent of 1.25 wt % corresponds to the haze of 65% (JIS-K-7136).

It is recognized that, if the diffusion agent is added in order to submerge the stud pin (increase the diffusion degree), the luminance is significantly degraded. If the amount of the diffusion agent is equal to or larger than 1.25%, i.e., the haze of 65% or more (JIS-K-7136), the stud pin visibility is reduced, but the luminance is also degraded by 10%.

As a result, it is preferable that the prism sheet is allowed to have a diffusion capability by adding the diffusion agent to the prism sheet in order to prevent reduction of the diffusion degree when the diffusion sheet between the shaped diffusion plate and the prism sheet is removed.

### 2. Review of Shaped Diffusion Plate (Corresponding to the Second Embodiment)

2-1. Review of the Diffusion Agent and the Basic Angle from the Viewpoint of the Front Luminance Unevenness

Experiment 10

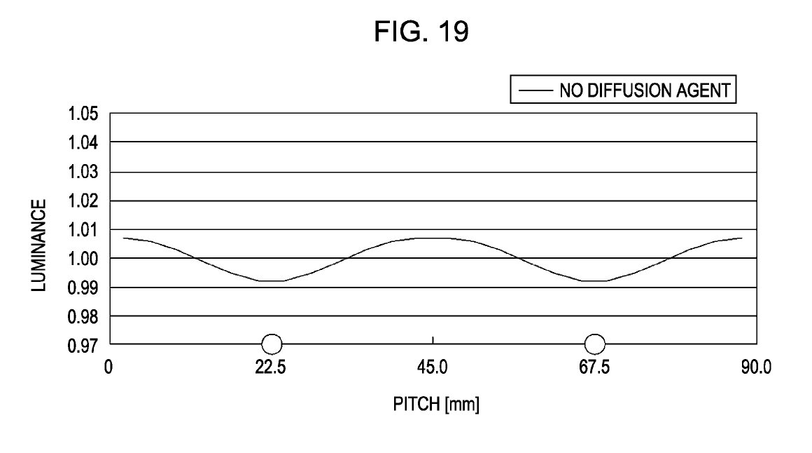

The luminance of the backlight unit was obtained through simulation using the shaped diffusion plate A. The result is shown in FIG. 19.

The simulation was performed based on the following conditions.
backlight unit: standard backlight dimension
sheet configuration: (light source side) shaped diffusion plate A—prism sheet A—diffusion sheet (light source side)

From FIG. 19, since the luminance on the light source is reduced and becomes dark, it is necessary to correct the luminance unevenness.

Experiments 11-1 to 11-3

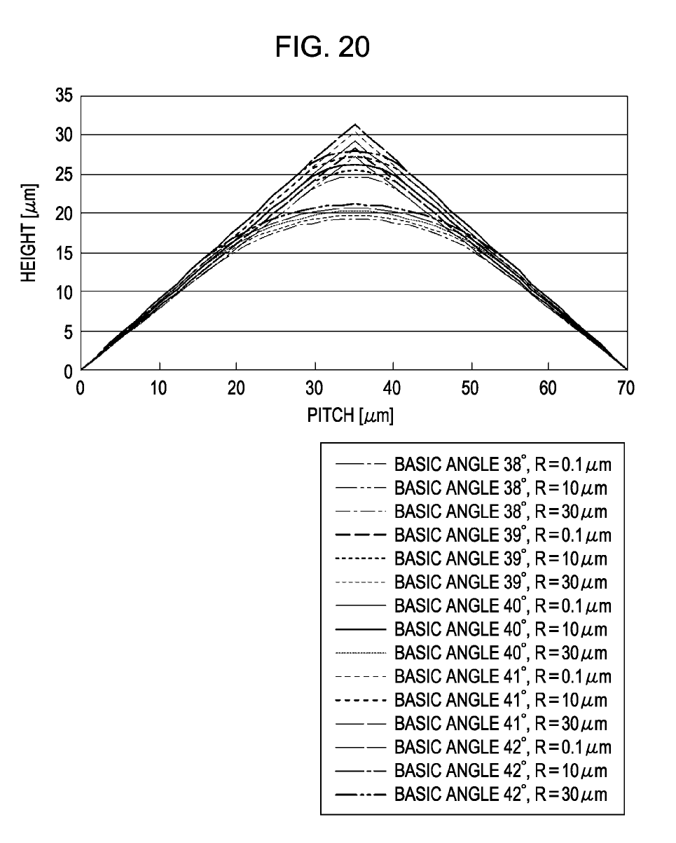

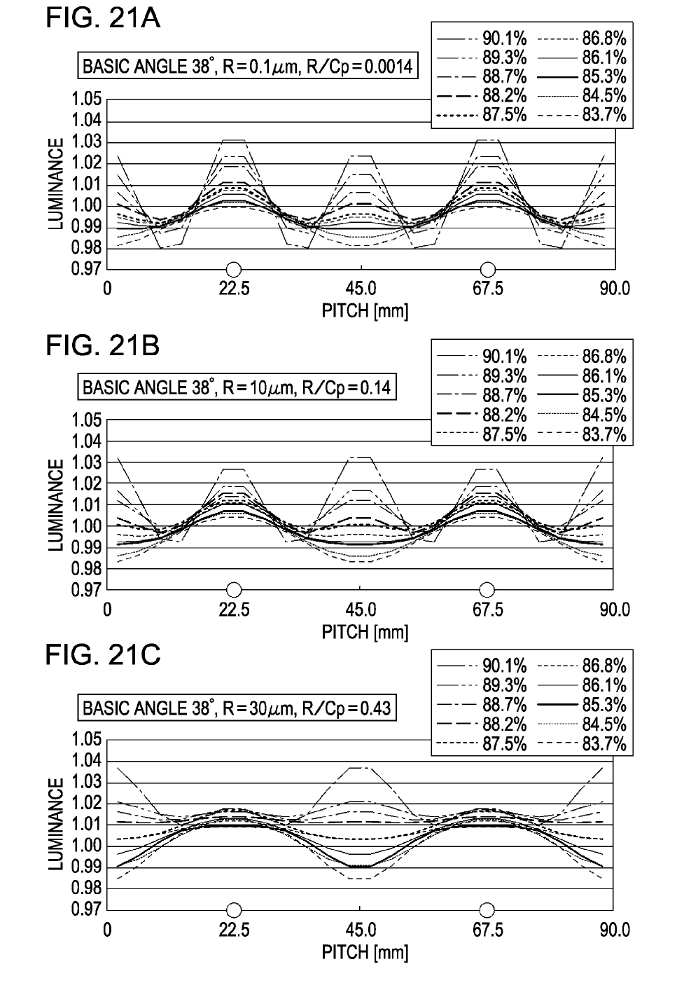

As shown in FIG. 20, in a case where the shape of the convex portion of the shaped diffusion plate is set as described below, the luminance distribution was obtained through simulation by changing the content amount of the diffusion agent contained in the shaped diffusion plate. The result is shown in FIGS. 21A to 21C. Referring to FIGS. 21A to 21C, the average luminance (the average value of the luminance distribution of FIG. 19) of the backlight unit (Experiment 10) using the shaped diffusion plate A is normalized to 1. Similarly, in the following Experiments 12-1 to 15-3, by setting the average luminance of the backlight unit (Experiment 10) using the shaped diffusion plate A to 1, the luminance distribution obtained through simulation is normalized.
Experiment 11-1: basic angle=38°, curvature R of summit=0.1 μm, and ratio R/Cp between curvature R of summit and pitch Cp of convex portion=0.0014
Experiment 11-2: basic angle=38°, curvature R of summit=10 μm, and ratio R/Cp between curvature R of summit and pitch Cp of convex portion=0.14
Experiment 11-3: basic angle=38°, curvature R of summit=30 μm, and ratio R/Cp between curvature R of summit and pitch Cp of convex portion=0.43

Here, the shaped diffusion plate has a thickness of 1.2 mm and a refractive index of 1.59.

The simulation was performed based on the following conditions.
backlight unit: standard backlight dimension
sheet configuration: (light source side) shaped diffusion plate—prism sheet A—diffusion sheet (light source side)

Experiments 12-1 to 12-4

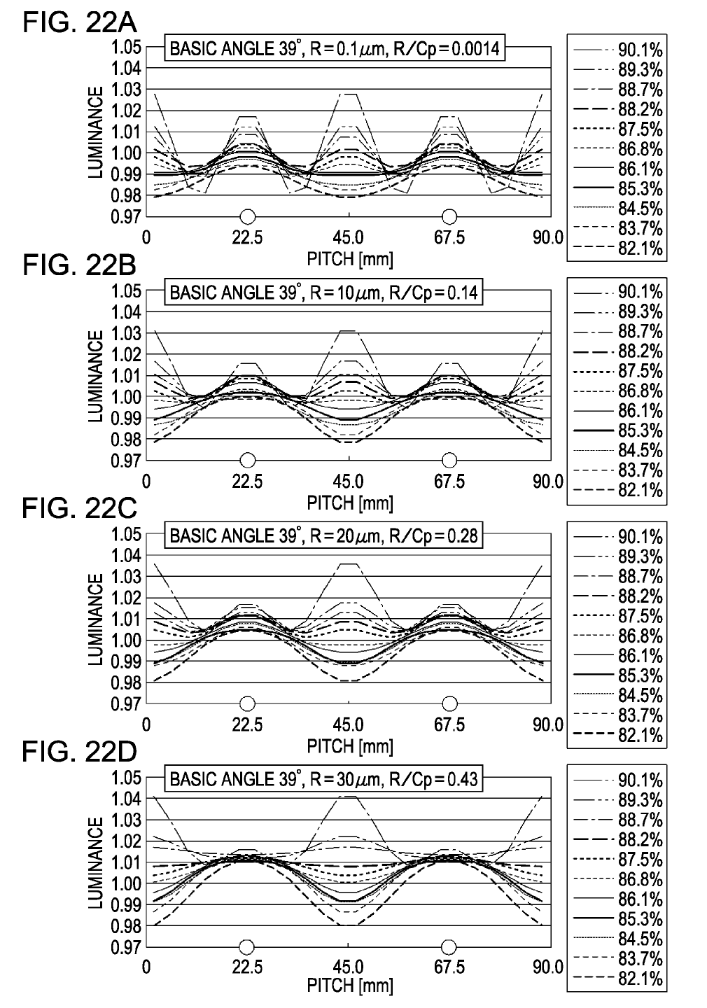

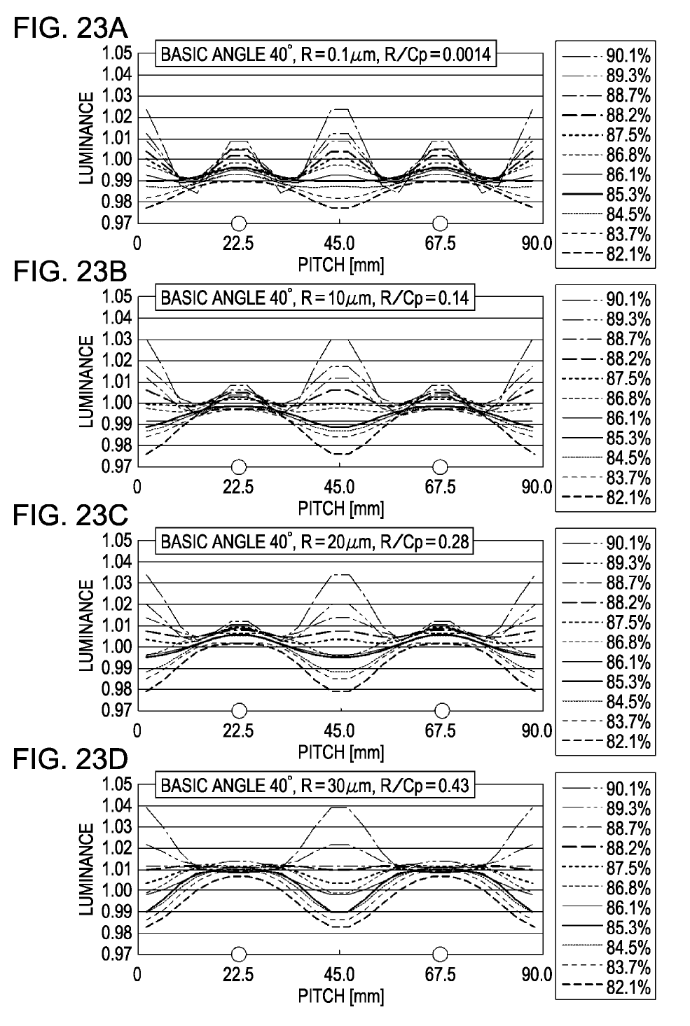

As shown in FIG. 20, in a case where the shape of the convex portion of the shaped diffusion plate is set as described below, the luminance distribution was obtained through simulation by changing the content amount of the diffusion agent contained in the shaped diffusion plate. The result is shown in FIGS. 22A to 22D.
Experiment 12-1: basic angle=39°, curvature R of summit=0.1 μm, and ratio R/Cp between curvature R of summit and pitch Cp of convex portion=0.0014
Experiment 12-2: basic angle=39°, curvature R of summit=10 μm, and ratio R/Cp between curvature R of summit and pitch Cp of convex portion=0.14
Experiment 12-3: basic angle=39°, curvature R of summit=20 μm, and ratio R/Cp between curvature R of summit and pitch Cp of convex portion=0.28
Experiment 12-4: basic angle=39°, curvature R of summit=30 μm, and ratio R/Cp between curvature R of summit and pitch Cp of convex portion=0.43

The dimension of the backlight unit and the simulation condition of the sheet configuration are similar to those of Experiments 11-1 to 11-3.

Experiments 13-1 to 13-4

As shown in FIG. 20, in a case where the shape of the convex portion of the shaped diffusion plate is set as described below, the luminance distribution was obtained through simulation by changing the content amount of the diffusion agent contained in the shaped diffusion plate. The result is shown in FIGS. 23A to 23C.
Experiment 13-1: basic angle=40°, curvature R of summit=0.1 μm, and ratio R/Cp between curvature R of summit and pitch Cp of convex portion=0.0014
Experiment 13-2: basic angle=40°, curvature R of summit=10 μm, and ratio R/Cp between curvature R of summit and pitch Cp of convex portion=0.14
Experiment 13-3: basic angle=40°, curvature R of summit=20 μm, and ratio R/Cp between curvature R of summit and pitch Cp of convex portion=0.28
Experiment 13-4: basic angle=40°, curvature R of summit=30 μm, and ratio R/Cp between curvature R of summit and pitch Cp of convex portion=0.43

The dimension of the backlight unit and the simulation condition of the sheet configuration are similar to those of Experiments 11-1 to 11-3.

Experiments 14-1 to 14-4

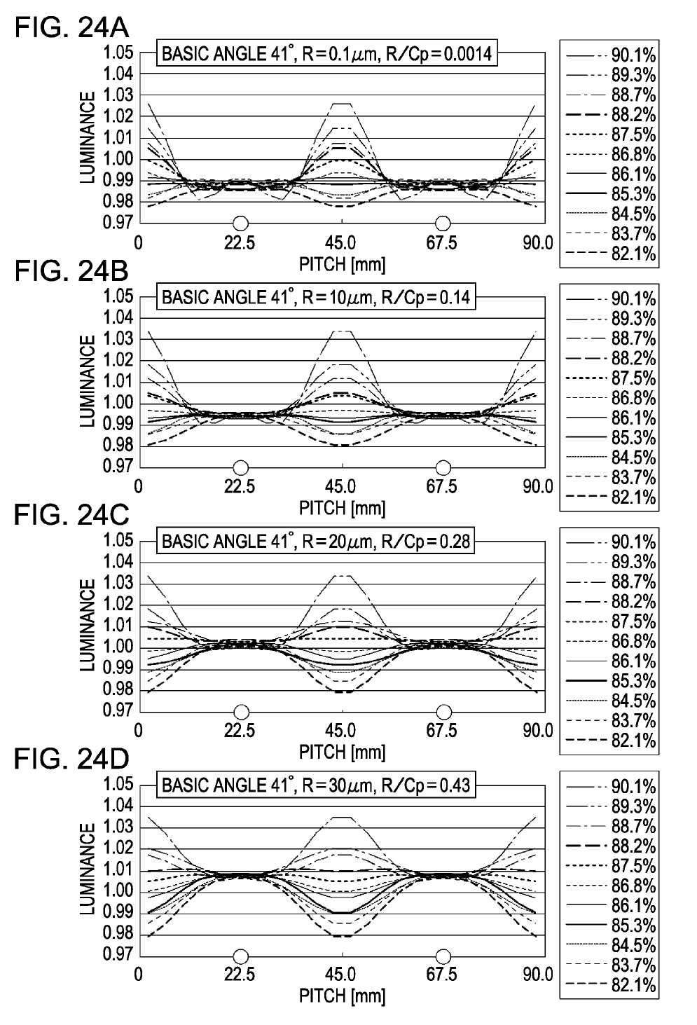

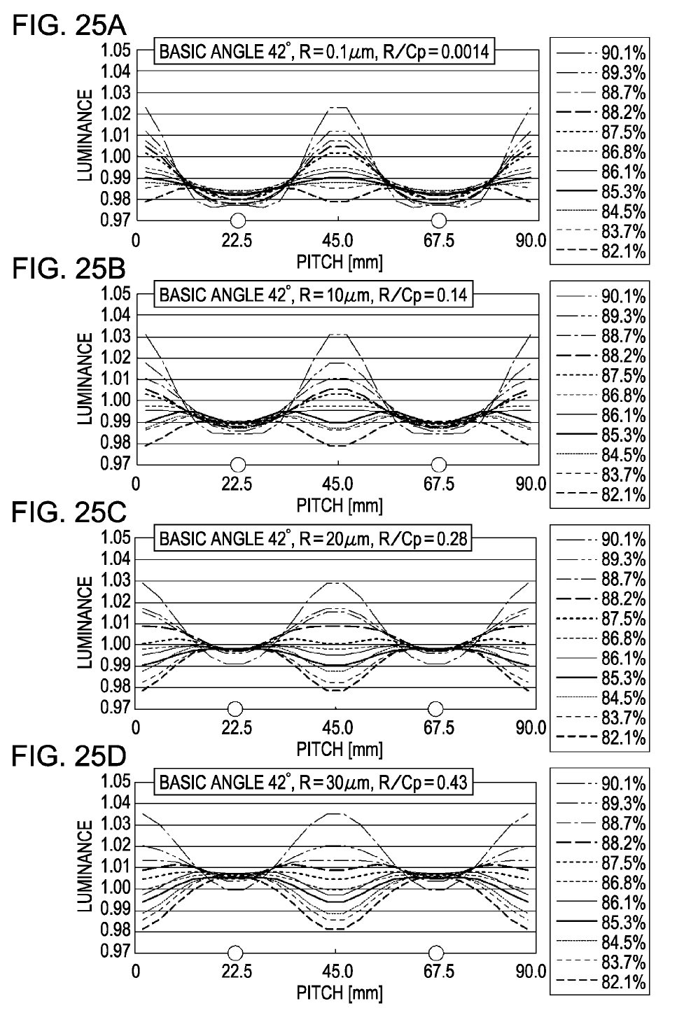

As shown in FIG. 20, in a case where the shape of the convex portion of the shaped diffusion plate is set as described below, the luminance distribution was obtained through simulation by changing the content amount of the diffusion agent contained in the shaped diffusion plate. The result is shown in FIGS. 24A to 24D.
Experiment 14-1: basic angle=41°, curvature R of summit=0.1 μm, and ratio R/Cp between curvature R of summit and pitch Cp of convex portion=0.0014
Experiment 14-2: basic angle=41°, curvature R of summit=10 μm, and ratio R/Cp between curvature R of summit and pitch Cp of convex portion=0.14
Experiment 14-3: basic angle=41°, curvature R of summit=20 μm, and ratio R/Cp between curvature R of summit and pitch Cp of convex portion=0.28
Experiment 14-4: basic angle=41°, curvature R of summit=30 μm, and ratio R/Cp between curvature R of summit and pitch Cp of convex portion=0.43

The dimension of the backlight unit and the simulation condition of the sheet configuration are similar to those of Experiments 11-1 to 11-3.

Experiments 15-1 to 15-4

As shown in FIG. 20, in a case where the shape of the convex portion of the shaped diffusion plate is set as described below, the luminance distribution was obtained through simulation by changing the content amount of the diffusion agent contained in the shaped diffusion plate. The result is shown in FIGS. 25A to 25D.
Experiment 15-1: basic angle=42°, curvature R of summit=0.1 μm, and ratio R/Cp between curvature R of summit and pitch Cp of convex portion=0.0014
Experiment 15-2: basic angle=42°, curvature R of summit=10 μm, and ratio R/Cp between curvature R of summit and pitch Cp of convex portion=0.14
Experiment 15-3: basic angle=42°, curvature R of summit=20 μm, and ratio R/Cp between curvature R of summit and pitch Cp of convex portion=0.28
Experiment 15-4: basic angle=42°, curvature R of summit=30 μm, and ratio R/Cp between curvature R of summit and pitch Cp of convex portion=0.43

The dimension of the backlight unit and the simulation condition of the sheet configuration are similar to those of Experiments 11-1 to 11-3.

In addition, the explanatory notes described in FIGS. 21A to 25D do not refer to the concentration of the diffusion agent, but refer to a total light transmittance (JIS-K-7361) of the diffusion agent because the concentration depends on the type of the diffusion agent.

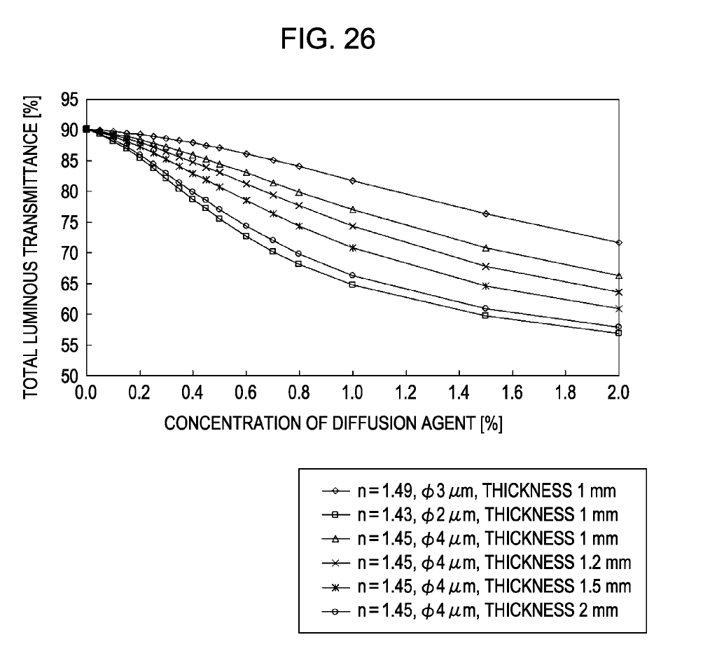

The total light transmittance was calculated and measured for the base body of the shaped diffusion plate. In other words, the shape portion of the shaped diffusion plate is melted using a solvent for planarization, and a portion affected by the diffusion agent contained inside was measured (internal diffusion). In the measurement, model No. HM-150 manufactured by MURAKAMI COLOR RESEARCH LABORATORY was used. FIG. 26 shows a calculation result of a relationship between the total light transmittance and the concentration when the following diffusion agent and a base body (a resin plate, the same as that obtained by melting the shape portion of the shaped diffusion plate using a solvent) are used.
diffusion agent (refractive index n=1.49, diameter φ=3 μm), base body (thickness=1 mm, refractive index n=1.59)
diffusion agent (refractive index n=1.43, diameter 4=2 μm), base body (thickness=1 mm, refractive index n=1.59)
diffusion agent (refractive index n=1.45, diameter 4=4 μm), base body (thickness=1 mm, refractive index n=1.59)
diffusion agent (refractive index n=1.45, diameter 4=4 μm), base body (thickness=1.2 mm, refractive index n=1.59)
diffusion agent (refractive index n=1.45, diameter 4=4 μm), base body (thickness=1.5 mm, refractive index n=1.59)
diffusion agent (refractive index n=1.45, diameter 4=4 μm), base body (thickness=2 mm, refractive index n=1.59)

In a case where the total light transmittance is converted into a concentration of the diffusion agent, the result is changed depending on a thickness or refractive index of the base body, a refractive index or type of the diffusion agent, or a diameter. Therefore, it is necessary to perform the calculation using simulation as described above. Basically, the optical characteristics such as luminance unevenness depend on a total light transmittance. If the total light transmittance is equal, it does not depend on the type of the diffusion agent.

As shown in FIGS. 21A to 25D, it is recognized that the luminance unevenness can be lowered to 1.5% or less by optimizing the amount of the diffusion agent in each shape. For example, in a case where the basic angle is 40°, and the curvature R of the summit is 10 μm (FIG. 23B), the amount of the diffusion agent is optimal when the total light transmittance is 87.5%, so that the luminance unevenness is 1.0% or less.

In a case where the basic angle is equal to or larger than 38° and equal to or smaller than 42°, the curvature R of the summit is equal to or larger than 0.1 and equal to or smaller than 30, i.e., where a percentage R/Cp of (the curvature R of the summit)/(the pitch Cp of the convex portion) is 0.014<R/Cp<0.43, the total light transmittance when the amount of the diffusion agent is optimized is ranged between 82.1% and 88.7%.

More Preferable Basic Angle Range (equal to or Larger Than 39° and Equal to or Smaller Than 42°):

it is recognized that, in a case where the shape has a basic angle of 38° (FIGS. 21A to 21C), and the amount of the diffusion agent (i.e., the total light transmittance) is optimized, in terms of the luminance unevenness, the light looks bright between the light sources as well as on the light source in comparison with the shape having a basic angle equal to or larger than 39 and equal to or smaller than 42° (FIGS. 22A to 24D). This may be viewed as a thin bright line on the light source and is preferably removed. Hereinafter, a preferable range of the basic angle and a relationship between the ratio R/Cp and the total light transmittance will be described with reference to Table 5.

TABLE 5

| | R/Cp | | |
|---|---|---|---|
| | EQUAL TO OR LARGER | EQUAL TO OR LARGER | EQUAL TO OR LARGER |
| | THAN 0.0014 AND EQUAL | THAN 0.14 AND EQUAL TO | THAN 0.28 AND EQUAL TO |
| BASIC ANGLE | TO OR SMALLER THAN 0.14 | OR SMALLER THAN 0.28 | OR SMALLER THAN 0.43 |
| 39-40° | | ◯ | ◯ |
| 40-41° | | ◯ | ◯ |
| 41-42° | | | ◯ |

: the total light transmittance is equal to or larger than 82.1% and equal to or smaller than 87.5%
◯: the total light transmittance is equal to or larger than 84.5% and equal to or smaller than 88.7%

In a Case where the Curvature R of the Summit is Relatively Small, or the Basic Angle is Relatively Large:

it is recognized that, as shown in FIGS. 21A to 25D, as the basic angle increases, and the curvature R of the summit decreases, the optimal total light transmittance decreases (i.e., the optimal amount of the diffusion agent increases). In this case, the optimal total light transmittance is equal to or larger than 82.1% and equal to or smaller than 87.5%. As a result, it is advantageous that a diffusion capability increases, and the stud pins which will be described later are hardly observed. In order to obtain a corresponding range of the total light transmittance while maintaining the luminance unevenness (an unevenness percentage of 2% or less), if the basic angle is equal to or larger than 39° and equal to or smaller than 40°, it is preferable that the ratio R/Cp is set to 0.0014<R/Cp<0.14. If the basic angle is equal to or larger than 40° and equal to or smaller than 42°, it is preferable that the ratio R/Cp is se to 0.0014<R/Cp<0.28.

In a Case where the Curvature R of the Summit is Relatively Large, or the Basic Angle is Relatively Small:

if the shape having a basic angle of 39° (FIGS. 22A to 22D) is compared by changing the curvature R of the summit to 0.1 (FIG. 22A), 10 (FIG. 22B), and 30 (FIG. 22D), it is recognized that the thin bright line on the light source is suppressed as the curvature R of the summit increases. In other words, as the curvature R of the summit increases, the luminance unevenness is corrected. Furthermore, in terms of the front luminance (the average value of the luminance distribution curve in the drawing), the luminance is improved by 0.5% (corresponding to a curvature R of the summit of 0.1) when the curvature R of the summit is 10 and by 1.5% (corresponding to a curvature R of the summit of 0.1) when the curvature R of the summit is 30. This is because, as shown in FIGS. 21A to 25D, the optimal total light transmittance is large (i.e., the optimal amount of the diffusion agent is small) as the curvature R of the summit increases, and the basic angle decreases. In this case, the optimal total light transmittance is equal to or larger than 84.5% and equal to or smaller than 88.7%. In order to obtain a range of the corresponding total light transmittance while the luminance unevenness is maintained (the unevenness percentage is 2% or less), if the basic angle is equal to or larger than 39° and equal to or smaller than 41°, it is preferable that the ratio R/Cp is set to 0.14<R/Cp<0.43. Otherwise, if the basic angle is equal to or larger than 41° and equal to or smaller than 42°, it is preferable that the ratio R/Cp is set to 0.28<R/Cp<0.43. As such, if the optimal total light transmittance is relatively larger, it is preferable that the ratio R/Cp is set to 0.14<R/Cp<0.43.

More preferable range of the basic angle (equal to or larger than 39° and equal to or smaller than)41°:

it is recognized that, in a case where the shape has a basic angle of 42° (FIGS. 25A to 25D), and the amount of the diffusion agent (i.e., the total light transmittance) is optimal, in terms of the luminance unevenness, the light looks dark on the light source as well as between the light sources in comparison with the basic angle equal to or larger than 39° and equal to or smaller than 41° (FIGS. 22A to 24D). This may be viewed as a thin dark line on the light source and is preferably eliminated. For the range of the basic angle equal to or larger than 39° and equal to or smaller than 41°, the total light transmittance at the optimal amount of the diffusion agent is equal to or larger than 84.5% and equal to or smaller than 87.5%.

2-2. Review of the Diffusion Agent and the Basic Angle from the Viewpoint of the Oblique Luminance Unevenness

Experiments 16-1 to 16-3 and 17-1 to 17-8

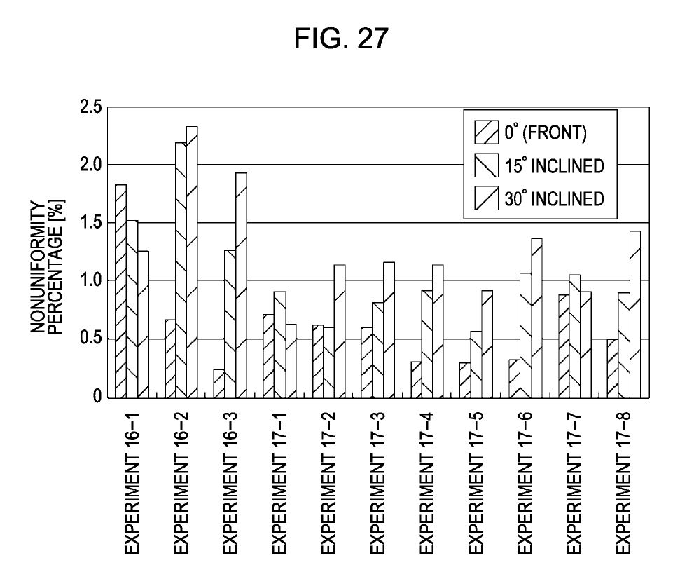

A variation of the luminance was obtained through simulation in a direction perpendicular to the prism sheet ridge line and oblique directions (0°, 15°, and 30°) with respect to the normal line of the prism sheet by changing the configuration of the sheet stack structure and the shape of the convex portion of the shaped diffusion plate as follows. The result is shown in FIG. 27. In FIG. 27, the unevenness percentage at the ordinate is defined as ((the maximum value of the luminance distribution)−(the minimum value of the luminance distribution))/(the average value of the luminance distribution). Therefore, it is preferable that the luminance unevenness percentage is smaller from the viewpoint of characteristics.
Experiment 16-1: (light source side) shaped diffusion plate A—prism sheet A—diffusion sheet (liquid crystal panel side)
Experiment 16-2: (light source side) shaped diffusion plate A—lenticular prism sheet of FIG. 12B—diffusion sheet (liquid crystal panel side)
Experiment 16-3: (light source side) shaped diffusion plate having the shape 2 of FIG. 6, in which the diffusion agent (a total light transmittance of 86.1%) is added—prism sheet A—diffusion sheet (liquid crystal panel side)
Experiment 17-1: (light source side) shaped diffusion plate A—prism sheet having a basic angle of 40° of FIGS. 12A and 12B—diffusion sheet (liquid crystal panel side)
Experiment 17-2: (light source side) shaped diffusion plate having a basic angle of 39°, a curvature R of the summit of 30 μm, and a diffusion agent of a total light transmittance of 88.2%—prism sheet A—diffusion sheet (liquid crystal panel side)
Experiment 17-3: (light source side) shaped diffusion plate having a basic angle of 40°, a curvature R of the summit of 10 μm, and a diffusion agent of a total light transmittance of 87.5%—prism sheet A—diffusion sheet (liquid crystal panel side)
Experiment 17-4: (light source side) shaped diffusion plate having a basic angle of 40°, a curvature R of the summit of 30 μm, and a diffusion agent of a total light transmittance of 88.2%—prism sheet A—diffusion sheet (liquid crystal panel side)
Experiment 17-5: (light source side) shaped diffusion plate having a basic angle of 41°, a curvature R of the summit of 10 μm, and a diffusion agent of a total light transmittance of 86.1%—prism sheet A—diffusion sheet (liquid crystal panel side)
Experiment 17-6: (light source side) shaped diffusion plate having a basic angle of 41°, a curvature R of the summit of 30 μm, and a diffusion agent of a total light transmittance of 87.5%—prism sheet A—diffusion sheet (liquid crystal panel side)
Experiment 17-7: (light source side) shaped diffusion plate having a basic angle of 42°, a curvature R of the summit of 10 μm, and a diffusion agent of a total light transmittance of 85.3%—prism sheet A—diffusion sheet (liquid crystal panel side)
Experiment 17-8: (light source side) shaped diffusion plate having a basic angle of 42°, a curvature R of the summit of 30 μm, and a diffusion agent of a total light transmittance of 87.5%—prism sheet A—diffusion sheet (liquid crystal panel side)

Here, the shaped diffusion plate has a thickness of 1.2 mm and a refractive index of 1.59. The prism sheet has a thickness of 0.35 mm and a refractive index of 1.59.

In Experiment 16-1, the sheet stack structure includes the shaped diffusion plate A, the prism sheet A, and the diffusion sheet in this order. As shown in FIG. 19, dark luminance unevenness exists on the light source. In FIG. 27, the unevenness percentage is high at an angel of 0° (the front side), and the luminance unevenness also exists.

In Experiment 16-2, as mentioned in the section 1-4, the shape of the prism sheet A of Experiment 16-1 is substituted with the lenticular prism sheet to correct the luminance unevenness at an angle of 0° (the front side). However, the luminance unevenness is degraded in an oblique direction, and this is not preferable.

In Experiment 16-3, the diffusion agent (having a total light transmittance of 86.1%) was added to the shaped diffusion plate A of Experiment 16-1 in order to correct the luminance unevenness at an angle of 0° (the front side). However, the luminance unevenness is degraded in an oblique direction, and this is not preferable.

In Experiment 17-1, as mentioned in the section 1-4, the shape of the prism sheet A of Experiment 16-1 is substituted with the shape corresponding to 40° of FIG. 16A to correct the luminance unevenness at an angle of 0° (the front side). As mentioned in the section 1-4, the luminance unevenness is not aggravated even in an oblique direction, and this is preferable.

In Experiments 17-2 to 17-8, the shaped diffusion plate described in the section 2-1 was used. The content amount of the diffusion agent is optimally adjusted in terms of the basic angle and the curvature R of the summit. In comparison with Experiment 16-2 or 16-3, the luminance unevenness is lowered in both the front and oblique directions.

The luminance unevenness in an oblique direction is corrected because the principle such as the angular strength distribution described in the section 1-4 is applied to the shaped diffusion plate.

### Example 5

First, a prism sheet having a plurality of triangular prisms with a curvature R at the summit provided on one principal surface was prepared. Details of the configuration of this prism sheet are as follows.
thickness: 1.2 mm
refractive index: 1.59
pitch Cp of prism: 70 μm
basic angle, summit: (basic angle=40°, curvature R of summit=20 μm), (basic angle=39.5°, curvature R of summit=10 μm)
total light transmittance:

total light transmittance of a sample having a shape of a basic angle of 40° and a curvature R of the summit of 20 μm: 86.0%, 87.0%, 87.8%, 88.2%, and 88.7%

total light transmittance of a sample having a shape of a basic angle of 39.5° and a curvature R of the summit of 10 μm: 84.3%, 86.0%, and 87.8%

Here, the shaped diffusion plate has a thickness of 1.2 mm and a refractive index of 1.59.

Then, the shaped diffusion plate, the prism sheet A, and the diffusion sheet were mounted on the backlight unit A1.

Luminance Unevenness Evaluation in Front and Oblique Directions

The results of the luminance unevenness of various shaped diffusion plates are described as follows.

In the case of the shaped diffusion plate having a basic angle of 40° and a curvature R of the summit of 20 μm
diffusion agent having total light transmittance of 86.0%: front luminance unevenness: 4 points, oblique luminance unevenness: 4 points
diffusion agent having total light transmittance of 87.0%: front luminance unevenness: 5 points, oblique luminance unevenness: 4 points
diffusion agent having total light transmittance of 87.8%: front luminance unevenness: 5 points, oblique luminance unevenness: 4 points
diffusion agent having total light transmittance of 88.2%: front luminance unevenness: 5 points, oblique luminance unevenness: 4 points
diffusion agent having total light transmittance of 88.7%: front luminance unevenness: 4 points, oblique luminance unevenness: 4 points

In the case of the shaped diffusion plate having a basic angle of 39.5° and a curvature R of the summit of 10 μm
diffusion agent having total light transmittance of 84.3%: front luminance unevenness: 4 points, oblique luminance unevenness: 4 points
diffusion agent having total light transmittance of 86.0%: front luminance unevenness: 5 points, oblique luminance unevenness: 5 points
diffusion agent having total light transmittance of 87.8%: front luminance unevenness: 4 points, oblique luminance unevenness: 4 points

Consequently, it is recognized that the sample that has been practically manufactured also has the same tendency as that of the aforementioned simulation result.

2-3. Review of the Shape of the Convex Portion from the Viewpoint of Suppressing the Luminance Unevenness Caused by the Dimension Error

Experiments 18-1, 18-2, and 19-1 to 19-6

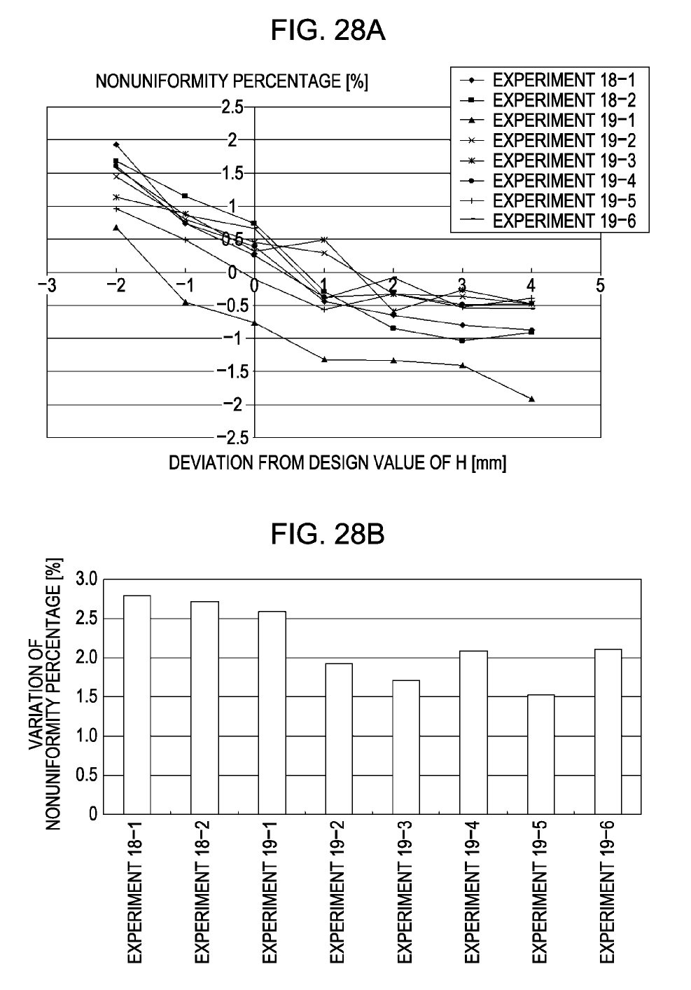

A variation of the unevenness percentage (%) was obtained through simulation by changing a distance H (mm) between the center of the light source and the shaped diffusion plate from the standard backlight dimension. The result is shown in FIG. 28A.

The negative sign of the unevenness percentage denotes a case where the light looks brighter in a gap between the light sources in comparison with the light on the light source.

Specifically, the unevenness percentage is obtained as follows.

In a Case where the Light Looks Brighter on the Light Source in Comparison with the Light in a Gap Between the Light Sources

unevenness percentage=((maximum value of luminance distribution)−(minimum value of luminance distribution))/(average value of luminance distribution)

In a case where the Light Looks Brighter in a Gap Between the Light Sources in Comparison with the Light on the Light Source

unevenness percentage=−((maximum value of luminance distribution)−(minimum value of luminance distribution))/(average value of luminance distribution)

In addition, in FIG. 28B, a variation of the unevenness percentage (%) when a difference from a design value of the distance H is ranged from −2 mm to +4 mm is shown for each experiment for each understanding.

Hereinafter, the configurations of the sheet stack structure used in Experiments 18-1, 18-2, and 19-1 to 19-6 are described as follows.

Experiment 18-1:(light source side) shaped diffusion plate A—lenticular prism sheet of FIG. 16A—diffusion sheet (liquid crystal panel side)

Experiment 18-2:(light source side) shaped diffusion plate containing diffusion agent (total light transmittance 86. 1%) and having shape 2 of FIG. 6—prism sheet A—diffusion sheet (liquid crystal panel side)

Experiment 19-1:(light source side) shaped diffusion plate A—prism sheet having basic angle of 40° of FIG. 12A—diffusion sheet (liquid crystal panel side)

Experiment 19-2:(light source side) shaped diffusion plate having basic angle of 39° and curvature R of 30 μm at summit and containing diffusion agent having total light transmittance of 88.2%—prism sheet A—diffusion sheet (liquid crystal panel side)

Experiment 19-3:(light source side) shaped diffusion plate having basic angle of 40° and curvature R of 10 μm at summit and containing diffusion agent having total light transmittance of 87.5%—prism sheet A—diffusion sheet (liquid crystal panel side)

Experiment 19-4:(light source side) shaped diffusion plate having basic angle of 40° and curvature R of 30 μm at summit and containing diffusion agent having total light transmittance of 88.2%—prism sheet A—diffusion sheet (liquid crystal panel side)

Experiment 19-5:(light source side) shaped diffusion plate having basic angle of 41° and curvature R of 10 μm at summit and containing diffusion agent having total light transmittance of 86.1%—prism sheet A—diffusion sheet (liquid crystal panel side)

Experiment 19-6:(light source side) shaped diffusion plate having basic angle of 41° and curvature R of 30 μm at summit and containing diffusion agent having total light transmittance of 87.5%—prism sheet A—diffusion sheet (liquid crystal panel side)

In addition, in all of Experiments 18-1, 18-2, and 19-1 to 19-6, the backlight dimension is set to a standard backlight dimension. The shaped diffusion plate has a thickness of 1.2 mm and a refractive index of 1.59.

In Experiments 18-1, 18-2, and 19-1 using the cylindrical shaped diffusion plate, a variation of the unevenness percentage is high with respect to a variation of the height H. From FIG. 28B, it is recognized that the variation of the unevenness percentage is equal to or larger than 2.6%. On the contrary, from FIG. 28B, it is recognized that the variation the variation of the unevenness percentage is equal to or smaller than 2.2%, and it is possible to prevent the luminance unevenness caused by the dimension error if a triangular shaped diffusion plate having a curvature R at the summit is used.

### Example 6-1

First, the following configuration was prepared as the prism sheet.
prism shape: lenticular shaped shown in FIG. 16A
content amount of diffusion agent: 65%

Next, the shaped diffusion plate A, the prism sheet, and the diffusion sheet were mounted on the backlight unit A1 and A2, and the distance H between the center of the light source and the back surface of the shaped diffusion plate was changed by −2 mm, −1 mm, 0 mm, 1 mm, 2 mm, and 3 mm.

Front Luminance Unevenness Evaluation

The front luminance unevenness was evaluated for the backlight units obtained as described above. The evaluation result is as follows.
distance H=−2 mm: 2 points
distance H=−1 mm: 3 points
distance H=0 mm: 4 points
distance H=1 mm: 5 points
distance H=2 mm: 5 points
distance H=3 mm: 4 points

### Example 6-2

First, the following configuration was prepared as the shaped diffusion plate.
basic angle: 40°
curvature R of summit: 20 μm
pitch Cp of convex portion: 70 μm
total light transmittance of diffusion agent: 87.0%
thickness: 1.2 mm
refractive index: 1.59

Next, the shaped diffusion plate, the prism sheet A, and the diffusion sheet were mounted on the backlight units A1 and A2, and the distance H between the center of the light source and the back surface of the shaped diffusion plate was changed by −2 mm, −1 mm, 0 mm, 1 mm, 2 mm, and 3 mm.

Front Luminance Unevenness Evaluation

The front luminance unevenness was evaluated for the backlight units obtained as described above. The evaluation result is as follows.
distance H=−2 mm: 3 points
distance H=−1 mm: 4 points
distance H=0 mm: 5 points
distance H=1 mm: 5 points
distance H=2 mm: 5 points
distance H=3 mm: 5 points

### Example 6-3

First, the following configuration was prepared as the shaped diffusion plate.
basic angle: 39.5°
curvature R of summit: 10 μm
pitch Cp of convex portion: 70 μm
total light transmittance of diffusion agent: 86.0%
thickness: 1.2 mm
refractive index: 1.59

Next, the shaped diffusion plate, the prism sheet A, and the diffusion sheet were mounted on the backlight units A1 and A2, and the distance H between the center of the light source and the back surface of the shaped diffusion plate was changed by −2 mm, −1 mm, 0 mm, 1 mm, 2 mm, and 3 mm.

Front Luminance Unevenness Evaluation

The front luminance unevenness was evaluated for the backlight units obtained as described above. The evaluation result is as follows.
distance H=−2 mm: 4 points
distance H=−1 mm: 5 points
distance H=0 mm: 5 points
distance H=1 mm: 5 points
distance H=2 mm: 5 points
distance H=3 mm: 5 points

In Examples 6-2 and 6-3, it is possible to prevent the luminance unevenness even when the backlight unit is viewed from the front direction and the distance H is changed. In Example 6-1, the distance H is reduced, and there is a tendency that an insufficient margin is provided, for example, when the shaped diffusion plate is bent so as to be close to the light source.

### 2-4. Review of the Haze from the Viewpoint of Suppressing Stud Pin Visibility

### Example 7

First, a shaped diffusion plate having the following configuration was prepared by changing the shaped of the convex portion and the total light transmittance. In addition, the total light transmittance was changed by adjusting the content amount of the diffusion agent.
shape of convex portion: shape 3 shown in FIG. 6
thickness: 1.2 mm
refractive index: 1.59
basic angle: 39°, 40°, and 41°
curvature R of summit: 5 μm, 20 μm, 1 μm
total light transmittance: 81%, 86%, 87%, 88.2%, and 89%

Next, the shaped diffusion plate, the prism sheet, and the diffusion sheet are mounted on the backlight unit A1.

Stud Pin Visibility Evaluation

The visibility of the stud pin of the backlight unit obtained as described above was evaluated. The result is shown in Table 4.

Luminance Evaluation

The luminance of the backlight unit obtained as described above was evaluated. The result is shown in Table 4.

TABLE 4

| SHAPE OF SHAPED | TOTAL LIGHT | VISIBILITY OF | |
|---|---|---|---|
| DIFFUSION PLATE | TRANSMITTANCE | STUD PIN | LUMINANCE |
| BASE ANGLE 39°, R = 5 | 86% | ⊚ | 101 |
| BASE ANGLE 40°, R = 20 | 86% | ⊚ | 101 |
| BASE ANGLE 40°, R = 20 | 87% | ⊚ | 101 |
| BASE ANGLE 40°, R = 20 | 88.20% | ⊚ | 101 |
| BASE ANGLE 40°, R = 20 | 89% | ⊚ | 101 |
| BASE ANGLE 41°, R = 1 | 81% | ⊚ | 99 |

From Table 4, it is possible to understand the following fact.

A diffusion capability is improved by adding the diffusion agent to the shaped diffusion plate, but the diffusion agent is not added to the prism sheet because it hinders the luminance improvement. Therefore, it is possible to submerge the stud pin without losing the luminance.

From Table 3, it is envisaged that it is difficult improve both the front luminance and the stud pin visibility even when a diffusion capability is given to the prism sheet by adding the diffusion agent to the prism sheet. However, as shown in Table 4, it is possible to submerge the stud pin without losing the luminance if the diffusion agent is added to the shaped diffusion plate to increase the diffusion capability because the diffusion agent which hinders the luminance improvement is not added to the prism sheet.

Experiments 20-1 to 20-3

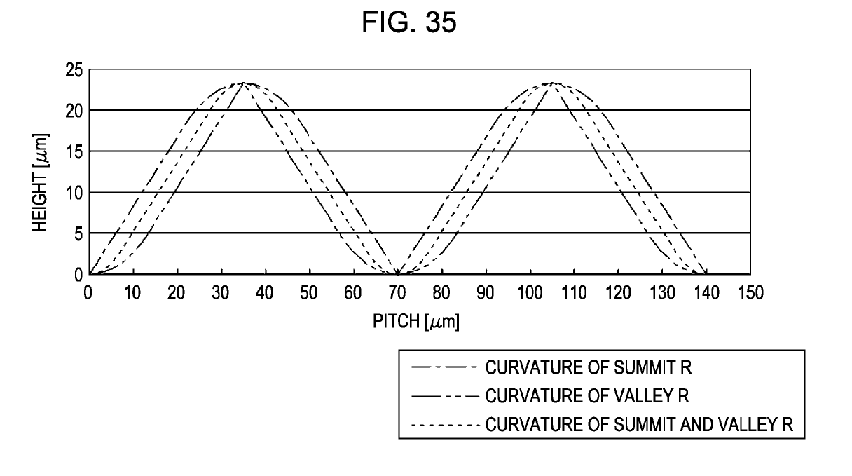

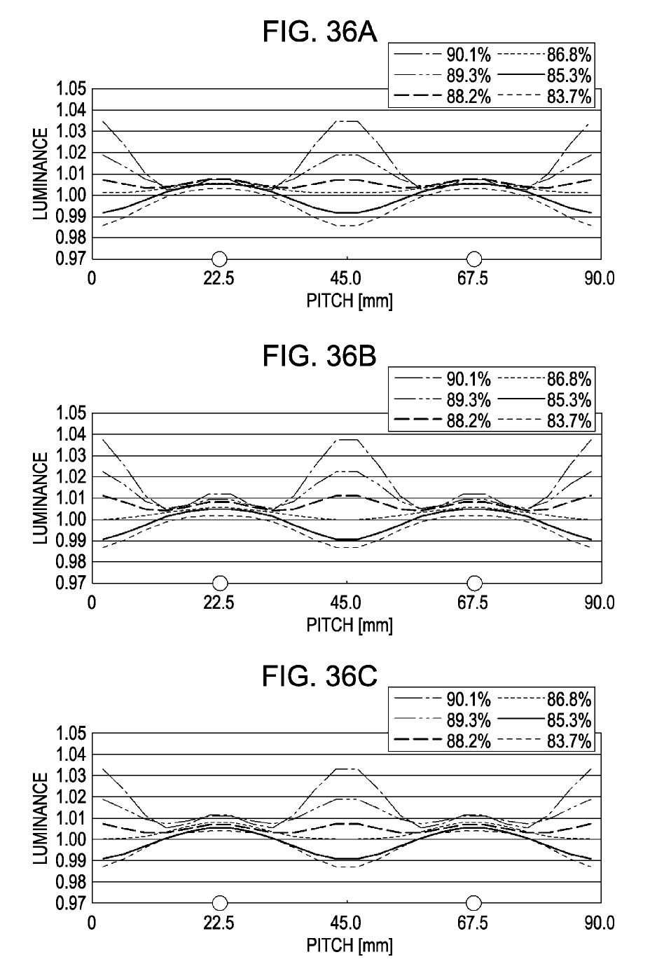

As shown in FIG. 35A, in a case where the shape of the convex portion of the shaped diffusion plate is set as follows, the luminance distribution was obtained through simulation by changing the content amount of the diffusion agent contained in the shaped diffusion plate. The result is shown in FIGS. 36A to 36C.
Experiment 20-1: basic angle=40°, curvature R of summit=20 μm, no curvature in valley, and ratio R/Cp between curvature R of summit and pitch Cp of convex portion=0.26
Experiment 20-2: basic angle=40°, curvature R of summit=20 μm, no curvature in valley, and ratio R/Cp between curvature R of summit and pitch Cp of convex portion=0.26
Experiment 20-3: basic angle=40°, curvature R1 of summit=10 μm, curvature R2 of valley=10 μm, R=R1+R2, and ratio R/Cp between curvature R of summit and pitch Cp of convex portion=0.26

Simulation conditions of the backlight dimension and the sheet configuration were similar to those of Experiments 11-1 to 11-3.

From FIGS. 36A to 36C, it is recognized that the distribution of the luminance unevenness is substantially the same even when a curvature R is applied either to the valley or to both the summit and valley if the and ratio R/Cp between curvature R and the pitch Cp of the convex portion and the total light transmittance (JIS-K-7361) are the same. However, if both the summit and valley of the convex portion have curvatures, a curvature R1 of the summit and a curvature R2 of the valley satisfy the condition R=R1+R2. In addition, if the valley has a curvature R, the basic angle is also denoted by an inclination angle.

2-5. Review of Luminance Improvement by Virtue of the Shaped Diffusion Plate Having a Multilayer Structure and a Triangular Prism Shape with a Curvature R at a Summit

Backlight Dimension
distance P=39 mm, distance H=18 mm, and distance L=5 mm

Sheet Configuration of Backlight Unit

(light source side) shaped diffusion plate—prism sheet—diffusion sheet (liquid crystal panel side)

Shaped Diffusion Plate

The configurations in each of the following experiments were used as the shaped diffusion plate.

Prism Sheet
thickness: 300 μm
refractive index: 1.59
lens shape: prism shape
lens pitch: 110 μm
basic angle: 45°
curvature R of summit: 5 μm

Diffusion Sheet
general diffusion sheet (model No. PTD737 manufactured by SHINWHA INTERTEK, Inc.)

Experiment 21

In the shaped diffusion plate of a single-layer structure having the following configuration, the front luminance increase rate of the backlight unit was obtained through simulation by adding the diffusion agent to the entire shaped diffusion plate and changing the content amount. The result is shown in FIG. 32B. In addition, a relative particle amount denoted in the abscissa of FIG. 32B is shown by normalizing the number of particles such that the number of particles of about 150,000/mm³ becomes a reference value of 0.5. The luminance increase rate denoted in the ordinate of FIG. 32B is a value obtained by defining the luminance of a relative particle amount of 0.5 as a reference value “1” and defining the luminance of other relative particle amounts as a relative value. In addition, similarly in the following experiments 22-1 to 22-3, the luminance increase rate denotes a relative value obtained by defining the luminance of the relative particle amount of 0.5 as a reference value of “1.”

Configuration of Shaped Diffusion Plate
layer structure of shaped diffusion plate: single-layer structure
thickness of entire shaped diffusion plate: 1.2 mm
shape of lens portion: a triangular prism shape having curvature R at leading end shown in FIG. 32A
thickness (height) of lens portion: about 56 μm
refractive index of base body: 1.59
refractive index of diffusion agent: 1.45
shape of diffusion agent: spherical shape
average particle diameter of diffusion agent: 4 μm
relative particle amount of diffusion agent: 0.5

Here, the refractive index of the base body means a refractive index of a resin material of the shaped diffusion plate.

Experiment 22-1

In the shaped diffusion plate of a double-layer structure having the following configuration, the front luminance increase rate was obtained through simulation by setting the ratio (d1:d2) between the thickness d1 of the lens layer and the thickness d2 of the diffusion layer to 1:9 and changing the amount of the diffusion agent added to the diffusion layer. The result is shown in FIG. 32B.

Configuration of Shaped Diffusion Plate
layer structure of shaped diffusion plate: multilayer structure having lens layer and diffusion layer (lens layer: diffusion layer=1:9)
thickness of entire shaped diffusion plate: 1.2 mm

Lens Layer
shape of lens portion: triangular prism shape having curvature R at leading end shown in FIG. 32A
thickness (height) of lens portion: 120 μm
refractive index: 1.59
relative particle amount of diffusion agent: 0

Diffusion Layer
refractive index of base body: 1.59
shape of diffusion agent: spherical shape
refractive index of diffusion agent: 1.45
average particle diameter of diffusion agent: 4 μm
relative particle amount of diffusion agent: 0.25 to 1.2

Here, the refractive index of the base body means a refractive index of a resin material of the shaped diffusion plate.

Experiment 22-2

The front luminance increase rate was obtained by setting the ratio (d1:d2) between the thickness d1 of the lens layer and the thickness d2 of the diffusion layer to 2:8 and setting other conditions to the same values as those of Experiment 22-1. The result is shown in FIG. 32B.

Experiment 22-3

The front luminance increase rate was obtained by setting the ratio (d1:d2) between the thickness d1 of the lens layer and the thickness d2 of the diffusion layer to 3:7 and setting other conditions to the same values as those of Experiment 22-1. The result is shown in FIG. 32B.

From FIG. 32B, it is possible to understand the following fact.

It is possible to improve the luminance by about 5% in Experiments 22-1 to 22-3 in which the diffusion agent is added to only the diffusion layer and the shaped diffusion plate has a double-layer structure compared to Experiment 1 in which the shaped diffusion plate has a single-layer structure, and the diffusion agent is added to the entire diffusion plate. In other words, from the viewpoint of the luminance improvement, it is preferable that the shaped diffusion plate has a double-layer structure including the lens layer and the diffusion layer, and the diffusion agent is added to only the diffusion layer.

It is guessed that the aforementioned luminance can be improved due to the following reasons:

Increasing Difference of Refractive Index

A difference of the refractive indices between the lens layer and the air to which the light is emitted increases by providing a multi-layer structure and removing the diffusion agent from the lens layer. As a result, an angular area capable of generating total reflection in the lens layer is widened. The light essentially anticipated to transmit in an oblique direction is totally reflected at an interface and increases the recycled light.

Emphasis on Lens Effect

Since the diffusion agent does not exist in the lens portion of the lens layer, the light diffused by the diffusion layer is not diffused in the lens portion, and a rising-edge effect is emphasized.

2-6. Review of Luminance Improvement and Luminance Unevenness Correction by Virtue of Shaped Diffusion Plate Having Multilayer Structure and Triangular Prism Shape with Curvature R at Summit

Experiment 23

The unevenness percentage was obtained through simulation by configuring the shaped diffusion plate as described in conjunction with Experiment 21. The unevenness percentage corresponding to a relative particle amount of 0.5 is shown in FIG. 33. In addition, the unevenness percentage is defined in the following equation as described above.

unevenness percentage=((maximum value of luminance distribution)−(minimum value of luminance distribution))/(average value of luminance distribution))

Experiments 24-1 to 24-3

The unevenness percentage was obtained through simulation by configuring the shaped diffusion plate as described in conjunction with Experiment 22-1 to 22-3. The unevenness percentage corresponding to a relative particle amount of 0.5 is shown in FIG. 33.

Experiment 24-4

The luminance increase rate was obtained by setting the ratio (d1:d2) between the thickness d1 of the lens layer and the thickness d2 of the diffusion layer to 4:6 and setting other conditions to the same values as those of Experiment 22-1. The unevenness percentage corresponding to a relative particle amount of 0.5 is shown in FIG. 33.

Experiment 24-5

The luminance increase rate was obtained by setting the ratio (d1:d2) between the thickness d1 of the lens layer and the thickness d2 of the diffusion layer to 5:5 and setting other conditions to the same values as those of Experiment 22-1. The unevenness percentage corresponding to a relative particle amount of 0.5 is shown in FIG. 33.

Experiment 24-6

The luminance increase rate was obtained by setting the ratio (d1:d2) between the thickness d1 of the lens layer and the thickness d2 of the diffusion layer to 6:4 and setting other conditions to the same values as those of Experiment 22-1. The unevenness percentage corresponding to a relative particle amount of 0.5 is shown in FIG. 33.

From FIG. 33, it is possible to understand the following fact.

In a case where the shaped diffusion plate has a double-layer structure, and the lens portion has a triangular prism shape with a curvature R at the summit, it is possible to correct luminance unevenness in comparison with a single-layer structure of the shaped diffusion plate by setting a percentage R_{L} of the thickness of the diffusion layer with respect to the thickness of the entire shaped diffusion plate to be, preferably, larger than 70%, and more preferably equal to or larger than 80%.

Therefore, from the viewpoint of improving luminance and correcting luminance unevenness, it is preferable that the shaped diffusion plate has a double-layer structure, and a percentage R_{L} of the thickness of the diffusion layer with respect to the thickness of the entire shaped diffusion plate is preferably larger than 70%, and more preferably, equal to or larger than 80%.

### 3. Review of Combination of Prism Sheet and Shaped Diffusion Plate (Corresponding to the Third Embodiment)

3-1. Review from the Viewpoint of Suppressing the Front Luminance Unevenness, the Oblique Luminance Unevenness, and the Stud Pin Visibility

Experiment 25

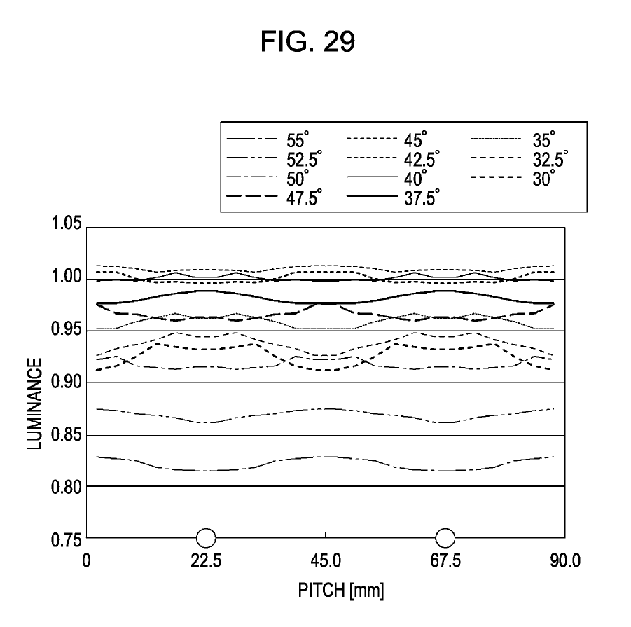

The front luminance of the backlight unit was obtained through simulation by changing the basic angle of the triangular prism of the prism sheet. The result is shown in FIG. 29.

The simulation was performed based on the following conditions.
backlight unit: standard backlight dimension
sheet configuration: (light source side) shaped diffusion plate—prism sheet—diffusion sheet (light source side)

Here, the prism sheet has a thickness of 0.35 mm, a refractive index of 1.59, and a pitch Cp of the convex portion of 70 μm. The simulation was performed by changing the basic angle of the triangular prism as shown in FIG. 11A.

In addition, the shaped diffusion plate has a thickness of 1.2 mm and a refractive index of 1.59. The shape of the convex portion has a basic angle of 40.5°, a curvature R of the summit of 20 μm, and a pitch Cp of 70 μm. The simulation was performed by adding the diffusion agent such that the total light transmittance becomes 87.5%.

From FIG. 29, it is recognized that the front luminance unevenness is suppressed to 1% by setting the basic angle of the prism from 45° (corresponding to the prism angle of the related art) to 37.5°.

### Example 8-1

First, a prism sheet having a plurality of triangular prisms provided on one principal surface was prepared. Details of the configuration of this prism sheet are as follows.
basic angle: 41°
curvature R of summit: 0 μm
pitch Cp of prism: 200 μm
thickness: 350 μm
resin material: polycarbonate resin

Next, a shaped diffusion plate having a plurality of convex portions provided on one principal surface was prepared. Details of the configuration of this shaped diffusion plate are as follows.
basic angle: 40°
curvature R of summit: 20 μm
total light transmittance of diffusion agent: 88.2%

Next, the shaped diffusion plate, the prism sheet, and the diffusion sheet were mounted on the backlight unit A1.

### Example 8-2

A backlight unit similar to that of Example 1 was obtained except that the shaped diffusion plate, the prism sheet, and the reflective polarization sheet (model name DBEF manufactured by 3M, Inc.,) are mounted on the backlight unit A2.

### Example 9-1

A backlight unit similar to that of Example 8-1 was obtained except that a shaped diffusion plate having a basic angle of 39.5°, a curvature R of the summit 10 μm, and a diffusion agent having a total light transmittance of 86.0% is used.

### Example 9-2

A backlight unit similar to that of Example 8-2 was obtained except that a shaped diffusion plate having a basic angle of 39.5°, a curvature R of the summit 10 μm, and a diffusion agent having a total light transmittance of 86.0% is used.

### Example 10-1

A backlight unit similar to that of Example 8-1 was obtained except that the backlight unit A is used.

### Example 10-2

A backlight unit similar to that of Example 10-1 was obtained except that the backlight unit A2 is used.

### Example 11-1

A backlight unit similar to that of Example 10-1 was obtained except that a shaped diffusion plate having a basic angle of 39.5°, a curvature R of the summit 10 μm, and a diffusion agent having a total light transmittance of 86.0% is used.

### Example 11-2

A backlight unit similar to that of Example 10-2 was obtained except that a shaped diffusion plate having a basic angle of 39.5°, a curvature R of the summit 10 μm, and a diffusion agent having a total light transmittance of 86.0% is used.

Luminance Unevenness Evaluation in Front and Oblique Directions

The luminance unevenness in front and oblique directions was evaluated for the backlight units obtained as described above. The evaluation result is as follows. In addition, Examples 10-1 to 11-2 correspond to the second embodiment.

In a case where a shaped diffusion plate having a basic angle of 40°, a curvature R of the summit of 20 μm, and a diffusion agent having a total light transmittance of 88.2% is used:
Examples 8-1 and 9-1 (triangular prism having a basic angle of 41° and a curvature R of summit of 0 μm): front luminance unevenness: 5 points, oblique luminance unevenness: 4 points
Examples 10-1 and 11-1 (prism sheet A) (triangular prism having a basic angle of 45° and a curvature R of summit of 0 μm): front luminance unevenness: 5 points, oblique luminance unevenness: 4 points

In a case where a shaped diffusion plate having a basic angle of 39.5°, a curvature R of the summit of 10 μm, and a diffusion agent having a total light transmittance of 86.0% is used:
Examples 8-2 and 9-2 (triangular prism having a basic angle of 41° and a curvature R of summit of 0 μm): front luminance unevenness: 5 points, oblique luminance unevenness: 5 points
Examples 10-2 and 11-2 (prism sheet A) (triangular prism having a basic angle of 45° and a curvature R of summit of 0 μm): front luminance unevenness: 5 points, oblique luminance unevenness: 5 points

Since even the oblique luminance unevenness is corrected using the shaped diffusion plate, it is possible to obtain a satisfactory result without using the prism sheet.

Stud Pin Visibility Evaluation

A stud pin visibility of the backlight unit obtained as described above was evaluated. As a result, it is possible to obtain a satisfactory result that no stud pin is observed. This is because the stud pin visibility is improved using the aforementioned configuration of the shaped diffusion plate as described above.

3-2. Review from the Viewpoint of Suppressing the Luminance Variation

Experiment 26-1

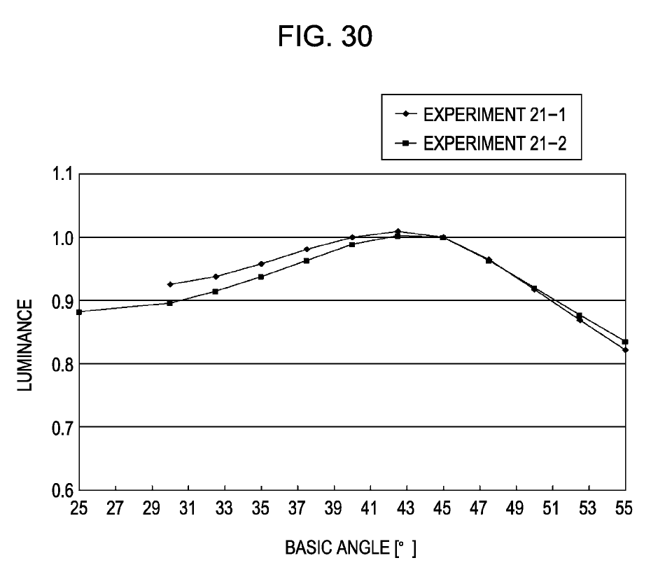

As shown in FIG. 11A, a variation of the front luminance of the backlight unit was obtained through simulation by changing the basic angle of the triangular prism of the prism sheet. The result is shown in FIG. 30. In addition, the luminance was normalized such that the luminance of the basic angle of 45° becomes a reference value (luminance=1).

The simulation was performed based on the following conditions.
backlight unit: standard backlight dimension
sheet configuration: (light source side) shaped diffusion plate—prism sheet—diffusion sheet (light source side)

Here, the prism sheet has a thickness of 0.35 mm, a refractive index of 1.59, and a pitch Cp of the convex portion of 70 μm. The simulation was performed by changing the basic angle of the triangular prism as shown in FIG. 11A.

In addition, the shaped diffusion plate has a thickness of 1.2 mm and a refractive index of 1.59. The shape of the convex portion has a basic angle of 40.5°, a curvature R of the summit of 20 μm, and a pitch Cp of 70 μm. The simulation was performed by adding the diffusion agent such that the total light transmittance becomes 87.5%.

Experiment 26-2

A variation of the front luminance of the backlight unit was obtained through simulation by setting conditions similar to those of Experiment 26-1 except that the sheet stack structure is configured as follows. The result is shown in FIG. 30.

In addition, the luminance was normalized such that the luminance of the basic angle of 45° becomes a reference value (luminance=1).
sheet configuration: (light source side) diffusion plate—triangular prism sheet—diffusion sheet (liquid crystal panel side)

In the configuration of the diffusion plate of Experiment 26-2, there is a tendency that the luminance decreases as the basic angle of the prism sheet is reduced. However, it is recognized that the luminance is hardly degraded or improved by combining the shaped diffusion plate and the prism sheet having a small basic angle.

The prism sheet having a small basic angle alleviates the cutoff phenomenon in the prism sheet and improves the field of view as described above. Typically, the luminance is degraded in the prism sheet having a small basic angle. However, it is possible to prevent degradation of the luminance and improve a field of view by disposing the prism sheet immediately on the shaped diffusion plate.

Hereinafter, Hereinafter, fourth and fifth embodiments will be exemplarily described in detail.

The simulation conditions used in this example is as follows.

Backlight Dimension
distance P=39 mm, distance H=18 mm, and distance L=5 mm

Here, the distances H, P and L are defined as follows (refer to FIG. 4)
distance H: distance between center of light source and back surface of shaped diffusion plate (or back surface of diffusion plate)
distance P: distance between centers of light sources
distance L: distance between center of light source and reflection sheet surface

Configuration of Backlight Unit
(light source side) shaped diffusion plate—lens sheet—diffusion sheet (liquid crystal panel side)

Shaped Diffusion Plate

The shaped diffusion plate has a configuration as described in the following experiments.

Lens Sheet
thickness: 300 μm
refractive index: 1.59
lens shape: prism shape
lens pitch: 110 μm
basic angle: 45°
curvature R of summit: 5 μm

Diffusion Sheet
general diffusion sheet (model No. PTD737 manufactured by SHINWHA INTERTEK, Inc.)

Simulation Software

The optical property of the backlight unit was obtained based on the Monte Carle method using an optical simulation software tool (LightTools) manufactured by ORA® (Optical Research Associates).

Examples will be described in the following sequence.

1. Review of the shaped diffusion plate having a multilayer structure from the viewpoint of luminance improvement

2. Review of the shaped diffusion plate having multilayer structure from the viewpoint of improvement in a manufacturing margin

3. Review of the shape of the lens portion of the shaped diffusion plate from the viewpoint of luminance improvement

4. Review of the shaped diffusion plate having multilayer structure from the viewpoint of luminance improvement and luminance unevenness correction

1. Review of the Shaped Diffusion Plate Having a Multilayer Structure from the Viewpoint of Luminance Improvement

Experiment 27

In the shaped diffusion plate of a single-layer structure having the following configuration, the front luminance increase rate of the backlight unit was obtained through simulation by adding the diffusion agent to the entire shaped diffusion plate and changing the content amount. The result is shown in FIG. 40B. In addition, a relative particle amount denoted in the abscissa of FIG. 40B is shown by normalizing the number of particles such that the number of particles of about 150,000/mm³ becomes a reference value of 0.5. In addition, the luminance increase rate denoted in the ordinate of FIG. 40B is a value obtained by defining the luminance of a relative particle amount of 0.5 as a reference value “1” and defining the luminance of other relative particle amounts as a relative value. In addition, similarly, in the following experiments 28-1 to 28-4, the luminance increase rate denotes a relative value obtained by defining the luminance of the relative particle amount of 0.5 as a reference value of “1.”

Configuration of Shaped Diffusion Plate
layer structure of shaped diffusion plate: single-layer structure
thickness of entire shaped diffusion plate: 1.2 mm
shape of lens portion: lenticular shaped shown in FIG. 40A
thickness (height) of lens portion: about 60 μm (59.13 μm)
refractive index of base body: 1.59
refractive index of diffusion agent: 1.45
shape of diffusion agent: spherical shape
average particle diameter of diffusion agent: 4 μm
relative particle amount of diffusion agent: 0.25 to 1

Here, the refractive index of the base body means a refractive index of a resin material of the shaped diffusion plate.

Experiment 28-1

In the shaped diffusion plate of a double-layer structure having the following configuration, the front luminance increase rate was obtained through simulation by setting the ratio (d1:d2) between the thickness d1 of the lens layer and the thickness d2 of the diffusion layer to 1:9 and changing the amount of the diffusion agent added to the diffusion layer. The result is shown in FIG. 40B.

Configuration of Shaped Diffusion Plate
layer structure of shaped diffusion plate: multilayer structure having lens layer and diffusion layer (lens layer: diffusion layer=1:9)
thickness of entire shaped diffusion plate: 1.2 mm

Lens Layer
shape of lens portion: lenticular shape shown in FIG. 40A
thickness (height) of lens portion: 120 μm
refractive index: 1.59
relative particle amount of diffusion agent: 0

Diffusion Layer
refractive index of base body: 1.59
shape of diffusion agent: spherical shape
refractive index of diffusion agent: 1.45
average particle diameter of diffusion agent: 4 μm
relative particle amount of diffusion agent: 0.05 to 2.5

Here, the refractive index of the base body means a refractive index of a resin material of the shaped diffusion plate.

Experiment 28-2

The front luminance increase rate was obtained by setting the ratio (d1:d2) between the thickness d1 of the lens layer and the thickness d2 of the diffusion layer to 2:8 and setting other conditions to the same values as those of Experiment 28-1. The result is shown in FIG. 40B.

Experiment 28-3

The front luminance increase rate was obtained by setting the ratio (d1:d2) between the thickness d1 of the lens layer and the thickness d2 of the diffusion layer to 3:7 and setting other conditions to the same values as those of Experiment 28-1. The result is shown in FIG. 40B.

Experiment 28-4

The front luminance increase rate was obtained by setting the ratio (d1:d2) between the thickness d1 of the lens layer and the thickness d2 of the diffusion layer to 4:6 and setting other conditions to the same values as those of Experiment 28-1. The result is shown in FIG. 40B.

From FIG. 40B, it is possible to understand the following fact.

It is possible to improve the luminance by about 5% in Experiments 28-1 to 28-3 in which the diffusion agent is added to only the diffusion layer and the shaped diffusion plate has a double-layer structure compared to Experiment 27 in which the shaped diffusion plate has a single-layer structure, and the diffusion agent is added to the entire diffusion plate. In other words, from the viewpoint of the luminance improvement, it is preferable that the shaped diffusion plate has a double-layer structure including the lens layer and the diffusion layer, and the diffusion agent is added to only the diffusion layer.

It is guessed that the aforementioned luminance can be improved due to the following reasons.

Increasing Difference of Refractive Index

A difference of the refractive indices between the lens layer and the air to which the light is emitted increases by providing a multi-layer structure and removing the diffusion agent from the lens layer. As a result, an angular area capable of generating total reflection in the lens layer is widened. The light essentially anticipated to transmit in an oblique direction (the light that is not affected by the lens effect) is totally reflected at an interface and increases the recycled light.

Emphasis on Lens Effect

Since the diffusion agent does not exist in the lens portion of the lens layer, the light diffused by the diffusion layer is not diffused in the lens portion, and a rising-edge effect is emphasized.

2. Review of the Shaped Diffusion Plate Having Multilayer Structure from the Viewpoint of Improvement in a Manufacturing Margin

Experiment 29

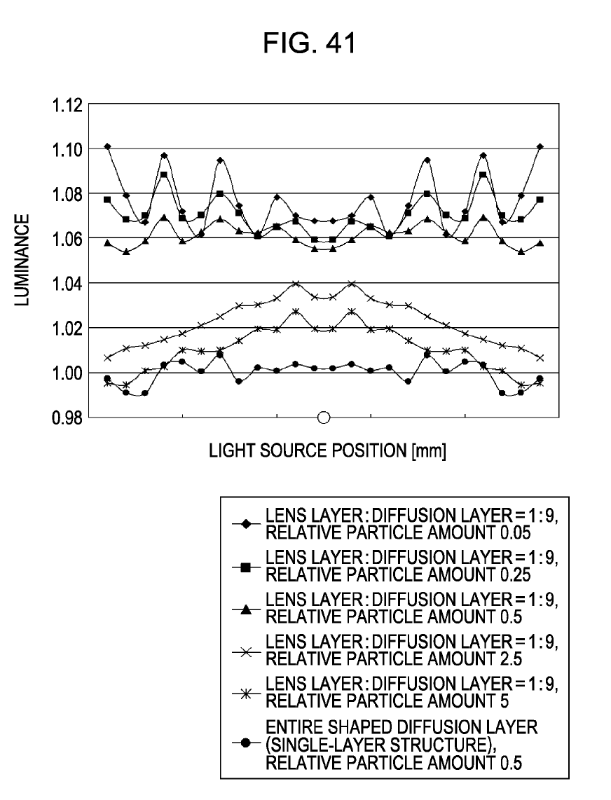

The front luminance distribution and unevenness percentage were obtained through simulation by configuring the shaped diffusion plate as described in conjunction with Experiment 27. The result is shown in FIGS. 41 and 42. In addition, in FIG. 41, the front luminance distribution when a relative particle amount of the diffusion agent is set to 0.5 is representatively shown.

A relative particle amount denoted in the abscissa of FIG. 42 is shown by normalizing the number of particles such that the number of particles of about 150,000/mm³ becomes a reference value of 0.5. The unevenness percentage denoted in the ordinate of FIG. 42 is a value obtained by defining the unevenness percentage of a relative particle amount of 0.5 as a reference value “0” and defining the unevenness percentage of other relative particle amounts as a relative value. In addition, similarly, in the following experiments 30-1 to 30-4, the unevenness percentage denotes a relative value obtained by defining the unevenness percentage of the relative particle amount of 0.5 as a reference value of “0.”

The unevenness percentage is defined using the following equation. However, in the graph shown in FIG. 42, the unevenness percentage defined in the following equation is denoted by a relative value as described above.

In a Case where the Light Looks Brighter on the Light Source in Comparison with the Light in a Gap Between the Light Sources

unevenness percentage=((maximum value of front luminance distribution)−(minimum value of front luminance distribution))/(average value of front luminance distribution)

In a Case where the Light Looks Brighter in a Gap Between the Light Sources in Comparison with the Light on the Light Source

unevenness percentage=−((maximum value of front luminance distribution)−(minimum value of front luminance distribution))/(average value of front luminance distribution)

Experiments 30-1 to 30-4

The luminance distribution and the unevenness percentage were obtained through simulation by configuring the shaped diffusion plate as described in conjunction with Experiment 28-1 to 28-4. The result is shown in FIGS. 41 and 42. In addition, in FIG. 41, in a case where the ratio (d1:d2) between the thickness d1 of the lens layer and the thickness d2 of the diffusion layer is set to 1:9 (in Experiment 30-1), the luminance distribution when the relative particle amount is set to 0.05, 0.25, 0.5, 2.5, and 5 is representatively shown.

From FIGS. 41 and 42, it is possible to understand the following fact.

In Experiment 29 in which the shaped diffusion plate has a single-layer structure, and the diffusion agent is added to the entire shaped diffusion plate, the front luminance unevenness is significantly changed with respect to the variation of the relative particle amount of the diffusion agent. In other words, this means that fluctuation in the unevenness is large, and a margin is small for external factors such as the dimension error in the backlight unit or the bended condition of the diffusion plate. Meanwhile, in Experiments 30-1 to 30-4 in which the shaped diffusion plate has a multilayer structure, and diffusion agent is added to only the diffusion layer, it is possible to reduce the unevenness percentage within a wider range of the relative particle amount in comparison with Experiment 29. Therefore, it is possible to reduce a variation of the unevenness percentage with respect to the variation of the relative particle amount of the diffusion agent. In other words, it is possible to widen a margin of the relative particle amount of the diffusion agent. In addition, an optimal value of the amount of the added diffusion agent varies depending on a ratio of the thickness of the diffusion layer with respect to the thickness of the entire shaped diffusion plate. Therefore, from the viewpoint of reducing the unevenness percentage, it is preferable that a thickness ratio and a relative particle amount of the diffusion agent are appropriately adjusted. Particularly, when the diffusion agent is added as much as the same amount, the smaller thickness of the diffusion layer is preferable because the diffusion agent is condensed within a narrower range of the shaped diffusion plate, so that the density of the diffusion agent increases, and the whiteness increases. Therefore, the stud visibility is also improved.

Specifically, in a case where the shaped diffusion plate has a double-layer structure, and the lens portion has a lenticular shape, it is possible to reduce the unevenness percentage within a wide range of the relative particle amount by setting the percentage R_{D} of the thickness of the diffusion layer with respect to the thickness of the shaped diffusion plate to be equal to or larger than 60% and equal to or smaller than 90%.

In addition, in a case where the shaped diffusion plate has a double-layer structure, and the lens portion has a lenticular shape, it is possible to reduce the unevenness percentage within nearly the entire range of the relative particle amount by setting the percentage R_{D} to be equal to or larger than 70% and equal to or smaller than 90% in comparison with a case where the shaped diffusion plate has a single-layer structure.

Therefore, from the viewpoint of improving luminance and a margin of the relative particle amount, it is preferable that the percentage R_{D} is set to be equal to or larger than 60% and equal to or smaller than 90%.

In addition, from the viewpoint of the luminance improvement and the unevenness percentage correction, it is preferable that the percentage R_{D} is set to be equal to larger than 70% and equal to or smaller than 90%.

3. Review of the Shape of the Lens Portion of the Shaped Diffusion Plate from the Viewpoint of Luminance Improvement

Experiment 31

The luminance increase rate was obtained through simulation by setting the shape of the lens portion of the shaped diffusion plate to a triangular prism shape having a curvature R at a leading end as shown in FIG. 32A and setting other conditions to the same values as those of Experiment 27. The result is shown in FIG. 32B.

Experiments 31-1 to 32-3

The luminance increase rate was obtained through simulation by setting the shape of the lens portion of the shaped diffusion plate to a triangular prism shape having a curvature R at a leading end as shown in FIG. 32A and setting other conditions to the same values as those of Experiments 28-1 to 28-3. The result is shown in FIG. 32B.

From FIG. 32B, it is possible to understand the following fact.

In Experiments 31 and 32-1 to 32-3, it is recognized that there is the same tendency as that of Experiments 27 and 28-1 to 28-3 between the content amount of the diffusion agent and the luminance increase rate. In other words, even in a case where the cross-sectional shape of the lens portion has a triangular prism shape having a curvature R at a leading end (refer to FIG. 32A), there is substantially the same tendency between the content amount of the diffusion agent and the luminance increase rate as the case where the lens portion has the lenticular shape (refer to FIG. 40A).

4. Review of the Shaped diffusion Plate Having Multilayer Structure from the Viewpoint of Luminance Improvement and Luminance Unevenness Correction

Experiment 33

The unevenness percentage was obtained through simulation by setting the configuration of the shaped diffusion plate to that of Experiment 31. The unevenness percentage corresponding to a relative particle amount of 0.5 is shown in FIG. 33. In addition, the unevenness percentage is defined in the following equation as described above.

unevenness percentage=((maximum value of front luminance distribution)−(minimum value of front luminance distribution))/(average value of front luminance distribution)

Experiments 34-1 to 34-3

The unevenness percentage was obtained through simulation by setting the configuration of the shaped diffusion plate to that of Experiment 32-1 to 32-3. The unevenness percentage corresponding to a relative particle amount of 0.5 is shown in FIG. 33.

Experiment 34-4

The luminance increase rate was obtained by setting the ratio (d1:d2) between the thickness d1 of the lens layer and the thickness d2 of the diffusion layer to 4:6 and setting other conditions to those of Experiment 34-1. The unevenness percentage corresponding to the relative particle amount of 0.5 is shown in FIG. 33.

Experiment 34-5

The luminance increase rate was obtained by setting the ratio (d1:d2) between the thickness d1 of the lens layer and the thickness d2 of the diffusion layer to 5:5 and setting other conditions to those of Experiment 34-1. The unevenness percentage corresponding to the relative particle amount of 0.5 is shown in FIG. 33.

Experiment 34-6

The luminance increase rate was obtained by setting the ratio (d1:d2) between the thickness d1 of the lens layer and the thickness d2 of the diffusion layer to 6:4 and setting other conditions to those of Experiment 34-1. The unevenness percentage corresponding to the relative particle amount of 0.5 is shown in FIG. 33.

From FIG. 33, it is possible to understand the following fact.

In a case where the shaped diffusion plate has a double-layer structure, and the lens portion has a triangular prism shape with a curvature R at the summit, it is possible to suppress the unevenness percentage in comparison with a single-layer structure of the shaped diffusion plate by setting a percentage R_{L} of the thickness of the diffusion layer with respect to the thickness of the entire shaped diffusion plate to be, preferably, larger than 70%, and more preferably, equal to or larger than 80%.

Therefore, from the viewpoint of luminance improvement and luminance unevenness correction, it is preferable that the shaped diffusion plate has a double-layer structure, and a percentage R_{L} of the thickness of the diffusion layer with respect to the thickness of the entire shaped diffusion plate is preferably larger than 70%, and more preferably, equal to or larger than 80%.

The configurations, methods, shapes, materials, and numerical values in the aforementioned embodiments are just exemplary, but any other configurations, methods, shapes, materials, and numerical values may be used as necessary.

Each of the configurations of the aforementioned embodiments may be combined with one another.

While, in the aforementioned embodiments, convex lens portions extending in a single direction are arranged in a one-dimensional array on the emitting surface of the shaped diffusion plate, the embodiments are applicable to the shaped diffusion plate in which convex lens portions having a semi-spherical or semi-elliptical spherical shape are arranged in a two-dimensional array on the emitting surface of the shaped diffusion plate.

While, in the aforementioned embodiments, the linear-shape light source is exemplified, the embodiments are applicable to a case where point-like light sources such as an LED are arranged in a grid shape or a meandering shape. In this case, at least two pieces of the aforementioned shaped diffusion plate or the prism sheet may be prepared, and the shaped diffusion plate or the prism sheet may be interchangeably used such that the extending direction of the prism or the convex portion of the shaped diffusion plate follows each arrangement direction of the point-like light sources.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A diffusion plate comprising:
a base body including a plurality of convex portions formed on a principal surface of the base body,
wherein an angle of inclination of the convex portions at a base of the convex portions ranges from 38° to 42°, and
wherein a ratio R/Cp between a curvature R of a summit of the convex portions and a pitch Cp between adjacent convex portions is 0.0014<R/Cp<0.43.

2. The diffusion plate of claim 1, wherein the base body and the plurality of convex portions are an integrated structure.

3. The diffusion plate of claim 1, wherein the plurality of convex portions are arranged in a direction perpendicular to an extending direction of the diffusion plate.

4. The diffusion plate of claim 1, wherein the angle of inclination of the convex portions at the base of the convex portions ranges from 39° to 41°.

5. The diffusion plate of claim 1, wherein the diffusion plate has a stacked structure including a lens layer and a diffusion layer.

6. The diffusion plate of claim 5, wherein the lens layer includes a lens portion and a light-transmitting layer, the lens portion including the plurality of convex portions.

7. The diffusion plate of claim 6, wherein the diffusion layer includes a diffusion agent and a resin material, and the lens layer and the light-transmitting layer do not include the diffusion agent.

8. The diffusion plate of claim 7, wherein refractive indices of the resin material and the diffusion agent are different from each other.

9. The diffusion plate of claim 7, wherein the diffusion agent is in particle form, and an average particle diameter of the diffusion agent is at least 1 μm and less than or equal to 10 μm.

10. The diffusion plate of claim 6, wherein the diffusion layer has a stacked structure including a plurality of diffusion layers.

11. The diffusion plate of claim 10, wherein the plurality of the diffusion layers each include a diffusion agent and a resin material, and the lens layer and the light-transmitting layer do not include the diffusion agent.

12. The diffusion plate of claim 11, wherein amounts of the diffusion agent are different between the diffusion layers, and the amounts of the diffusion agent of each diffusion layer sequentially increase from a light incident surface side of the diffusion plate to a light emitting surface side of the diffusion plate.

13. A backlight unit comprising:
a light source; and
a diffusion plate through which light passes from the light source, the diffusion plate including a base body and including a plurality of convex portions formed on a principal surface of the base body,
wherein an angle of inclination of the convex portions at a base of the convex portions ranges from 38° to 42°, and
wherein a ratio R/Cp between a curvature R of a summit of the convex portions and a pitch Cp between adjacent convex portions is 0.0014<R/Cp<0.43.

14. The backlight unit of claim 13, further comprising:
a casing at least partially containing the diffusion plate; and
a plurality of stud pins disposed on an inner surface of the casing,
wherein at least the diffusion plate is supported by the stud pins.

15. A liquid crystal display device comprising:
a backlight unit including
a light source, and
a diffusion plate through which light passes from the light source, the diffusion plate including a base body and including a plurality of convex portions formed on a principal surface of the base body; and
a liquid crystal panel for displaying an image by modulating light emitted from the backlight unit,
wherein an angle of inclination of the convex portions at a base of the convex portions ranges from 38° to 42°, and
wherein a ratio R/Cp between a curvature R of a summit of the convex portions and a pitch Cp between adjacent convex portions is 0.0014<R/Cp<0.43.

16. A diffusion plate having a laminated structure and comprising:
a lens layer including a plurality of lens portions; and
a diffusion layer including a diffusion agent dispersed therein,
wherein a percentage R_{D} of a thickness of the diffusion layer with respect to a thickness of the entire diffusion plate is at least 60%.

17. The diffusion plate of claim 16, wherein the lens layer includes a light-transmitting layer, the lens portions being formed on the light-transmitting layer.

18. The diffusion plate of claim 17, wherein the lens layer and the light-transmitting layer do not include the diffusion agent.

19. The diffusion plate of claim 16, wherein the diffusion layer has a stacked structure including a plurality of diffusion layers.

20. The diffusion plate of claim 19, wherein amounts of the diffusion agent are different between the diffusion layers, and the amounts of the diffusion agent of each diffusion layer sequentially increase from a light incident surface side of the diffusion plate to a light emitting surface side of the diffusion plate.

21. The diffusion plate according to claim 16, wherein the plurality of lens portions have a lenticular shape.

22. The diffusion plate according to claim 16, wherein the diffusion layer includes a resin material, and a refractive index of the resin material is different from a refractive index of the diffusion agent.

23. The diffusion plate according to claim 16, wherein the percentage R_{D} of the thickness of the diffusion layer with respect to the thickness of the entire diffusion plate is at least 70% and less than or equal to 90%.

24. The diffusion plate according to claim 16, wherein the diffusion agent is in particle form, and an average particle diameter of the diffusion agent ranges from 1 μm to 10 μm.

25. A backlight unit comprising:
a light source; and
a diffusion plate through which light passes from the light source, the diffusion plate having a laminated structure and including
a lens layer including a plurality of lens portions, and
a diffusion layer including a diffusion agent dispersed therein,
wherein a percentage R_{D} of a thickness of the diffusion layer with respect to a thickness of the entire diffusion plate is at least 60%.

26. A liquid crystal display device comprising:
a backlight unit including
a light source, and
a diffusion plate through which light passes from the light source, the diffusion plate having a laminated structure and including a lens layer including a plurality of lens portions, and a diffusion layer including a diffusion agent dispersed therein; and
a liquid crystal panel for displaying an image by modulating light emitted from the backlight unit,
wherein a percentage R_{D} of a thickness of the diffusion layer with respect to a thickness of the entire diffusion plate is at least 60%.
